(19) United States
(12) Patent Application Publication
(10) Pub. No.: US 2026/0347624 A1
(43) Pub. Date: Nov. 5, 2026

(54) COMPOUND, COMPOSITION, SURFACE TREATMENT AGENT, ARTICLE, AND METHOD OF PRODUCING ARTICLE

(71) Applicant: AGC Inc., Tokyo (JP)

(72) Inventors: Hironobu SAKAGUCHI, Tokyo (JP); Motoshi AOYAMA, Tokyo (JP); Yasuhiro HIRATA, Tokyo (JP)

(73) Assignee: AGC Inc., Tokyo (JP)

(21) Appl. No.: 19/685,299

(22) Filed: May 22, 2026

Related U.S. Application Data
(63) Continuation of application No. PCT/JP2024/041139, filed on Nov. 20, 2024.

(30) Foreign Application Priority Data
Nov. 24, 2023 (JP) 2023-199197

(51) Int. Cl. C09D 5/16; C08G 77/48; C08G 77/50; C08G 77/54; C09D 183/14

(52) U.S. Cl. CPC C09D 5/1675; C08G 77/485; C08G 77/50; C08G 77/54; C09D 183/14

(57) ABSTRACT

A compound having a chain group and a reactive silyl group, in which the compound has a number average molecular weight of from 1,600 to 10,000, and a proportion of a component having a molecular weight of 1,500 or less is 5 mass % or less, a composition and a surface treatment agent including the compound, an article having a surface treatment layer formed by a surface treatment using the surface treatment agent, and a method of producing the same are provided.

### CROSS-REFERENCE TO RELATED APPLICATIONS

This application is a Continuation Application of International Application No. PCT/JP2024/041139, filed Nov. 20, 2024, the disclosure of which is incorporated herein by reference in its entirety. Further, this application claims priority from Japanese Patent Application No. 2023-199197, filed Nov. 24, 2023, the disclosure of which is incorporated herein by reference in its entirety.

### TECHNICAL FIELD

The present disclosure relates to a compound, a composition, a surface treatment agent, an article, and a method of producing an article.

### BACKGROUND ART

In recent years, in order to improve performance such as appearance and visibility, there has been a demand for a technique that makes fingerprints less likely to adhere to the surface of an article and a technique that facilitates removal of stains. As a specific method, a method of subjecting a surface of an article to a surface treatment using a surface treatment agent is known.

For example, WO 2023/017830 A describes a surface treatment agent containing a silane compound having a divalent linear organosiloxane group and having a group containing a Si atom to which a hydroxy group or a hydrolyzable group is bonded.

### CITATION LIST

### Patent Literature

Patent Literature 1: WO 2023/017830 A

### SUMMARY OF INVENTION

### Technical Problem

However, a composition used for a surface treatment agent or the like is required to be further improved from the viewpoint of wear resistance.

The disclosure has been made in view of such circumstances, and an embodiment of the disclosure relates to provision of a compound, a composition, and a surface treatment agent capable of forming, on a substrate, a surface treatment layer having excellent wear resistance.

Further, an embodiment of the disclosure relates to provision of an article having a surface treatment layer having excellent wear resistance, and a method of producing the article.

The disclosure includes the following aspects.

<1>

A compound, having a chain group and a reactive silyl group, in which the compound has a number average molecular weight of from 1,600 to 10,000, and has a proportion of a component having a molecular weight of 1,500 or less of 5 mass % or less.

<2>

The compound according to <1>, in which the compound has a chain organo(poly)siloxane residue and a reactive silyl group.

<3>

The compound according to <1> or <2>, in which the reactive silyl group is represented by the following Formula (S1):

—Si(R²)ₙL₃₋ₙ (S1)
in which, in Formula (S1):
each R² is independently a hydrocarbon group,
each L is independently a hydrolyzable group, a group having a hydrolyzable group, or a hydroxy group, and
n is an integer from 0 to 2.

<4>

The compound according to <2> or <3> referring to <2>, in which the chain organo(poly)siloxane residue is represented by the following Formula (B1) or (B2):

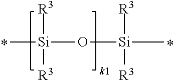

in which, in Formula (B1):
each R³ is independently a hydrocarbon group,
k1 is a number of 1 or more, and
* is a bonding site to an adjacent atom:

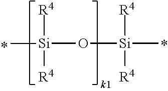

in which, in Formula (B2):
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more, and
* is a bonding site to an adjacent atom.

<5>

The compound according to <4>, in which k1 in Formulae (B1) and (B2) is a number from 1 to 500.

<6>

The compound according to any one of <1> to <5>, represented by the following Formula (C), (C2), (D), (D2), (E), or (E2):

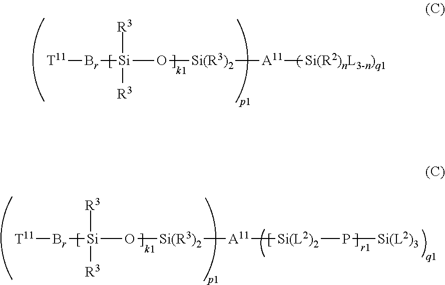

in which, in Formula (C):
T¹¹ is a monovalent group that does not contain a reactive silyl group,
each B is independently —O— or —C(═O)—,
each r is independently 0 or 1,
each R³ is independently a hydrocarbon group,
each k1 is independently a number of 1 or more,
p1 is an integer of 1 or more,
A¹¹ is a (p1+q1)-valent linking group,
q1 is an integer of 1 or more,
each R² is independently a hydrocarbon group,
each L is independently a hydrolyzable group, a group having a hydrolyzable group, or a hydroxy group, and
each n is independently an integer from 0 to 2,
in which, in Formula (C2):
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
r1 is an integer from 1 to 3, and
the definitions of T¹¹, B, r, R³, k1, p1, A¹¹, and q1 are the same as the definitions for Formula (C):

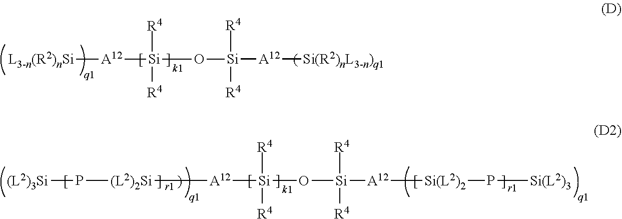

in which, in Formula (D):
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more,
each A¹² is independently a (q1+1)-valent linking group,
each q1 is independently an integer of 1 or more,
each R² is independently a hydrocarbon group,
each L is independently a hydrolyzable group, a group having a hydrolyzable group, or a hydroxy group, and
each n is independently an integer from 0 to 2,
in which, in Formula (D2):
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
each r1 is independently an integer from 1 to 3, and
the definitions of R⁴, k1, A¹², and q1 are the same as the definitions for Formula (D):

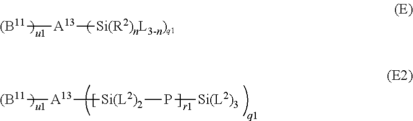

in which, in Formula (E):
B¹¹ is a monovalent group containing at least one selected from the group consisting of Si, Ge, and Sn, to each of which a hydroxy group or a hydrolyzable group is not directly bonded, or a monovalent group containing a branched alkyl group,
u1 is an integer of 1 or more,
A¹³ is a (q1+u1)-valent linking group,
q1 is an integer of 1 or more,
each R² is independently a hydrocarbon group,
each L is independently a hydrolyzable group, a group having a hydrolyzable group, or a hydroxy group, and
each n is independently an integer from 0 to 2,
in which, in Formula (E2):
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
each r1 is independently an integer from 1 to 3, and
the definitions of B¹¹, u1, A¹³, and q1 are the same as the definitions for Formula (E).

<7>

The compound according to <6>, in which each k1 in Formulae (C), (C2), (D), and (D2) is independently a number from 1 to 500.

<8>

The compound according to <6> or <7>, in which in Formulae (C), (C2), (E), and (E2), q1 is an integer from 1 to 4, and in Formulae (D) and (D2), each q1 is independently an integer from 1 to 4.

<9>

A composition, containing the compound according to any one of <1> to <8> and a liquid medium.

<10>

A composition, containing a first compound which is the compound according to any one of <2> and <3> to <8> referring to <2>, and a second compound which has an organopolysiloxane residue but does not have a reactive silyl group.

<11>

The composition according to <10>, further containing a liquid medium.

<12>

The composition according to <10> or <11>, in which the second compound is represented by the following Formula (F):

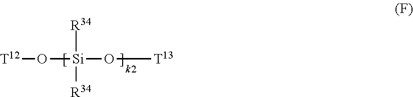

in which, in Formula (F),
each of T¹² and T¹³ is independently a monovalent group,
each R³⁴ is independently a hydrocarbon group, and
k2 is a number of 1 or more.

<13>

A surface treatment agent, containing the compound according to any one of <1> to <8>.

<14>

A surface treatment agent, containing the compound according to any one of <1> to <8> and a liquid medium.

<15>

A method of producing an article, the method including subjecting a substrate to a surface treatment using the surface treatment agent according to <13> or <14> to produce an article having a surface treatment layer formed on the substrate.

<16>

An article including a substrate and a surface treatment layer disposed on the substrate and formed by a surface treatment using the surface treatment agent according to <13> or <14>.

<17>

The article according to <16>, which is an optical member.

<18>

The article according to <16>, which is a display or a touch panel.

### Advantageous Effects of Invention

According to an embodiment of the disclosure, a compound, a composition, and a surface treatment agent capable of forming, on a substrate, a surface treatment layer having excellent wear resistance are provided.

Further, according to an embodiment of the disclosure, an article having a surface treatment layer having excellent wear resistance and a method of producing the article are provided.

### DESCRIPTION OF EMBODIMENTS

Hereinafter, modes for carrying out the embodiments of the disclosure will be described in detail. However, the embodiments of the disclosure are not limited to the following embodiments. In the following embodiments, the components (also including element steps and the like) are not essential unless otherwise specified. The same applies to numerical values and ranges thereof, and do not limit the embodiments of the disclosure.

In the disclosure, a numerical range indicated using “to” includes numerical values described before and after “to” as a minimum value and a maximum value, respectively.

In the numerical ranges described in stages in the disclosure, the upper limit value or the lower limit value described in one numerical range may be replaced with the upper limit value or the lower limit value of a numerical range described in another stage. In addition, in a numerical range described herein, the upper limit or the lower limit of the numerical range may be replaced with a value shown in an example.

In the disclosure, each component may contain a plurality of kinds of corresponding substances. When a plurality of kinds of substances corresponding to each component are present in the composition, the content percentage or content amount of each component means the total content percentage or content amount of the plurality of kinds of substances present in the composition unless otherwise specified.

In the disclosure, the “surface treatment layer” refers to a layer formed on a surface of a substrate by a surface treatment.

In the disclosure, when a compound or a group is represented by specific Formula (X), the compound or the group represented by Formula (X) may be referred to as a compound (X) or a compound X, and a group (X) or a group X, respectively.

In the disclosure, the organo(poly)siloxane residue refers to an organosiloxane residue or an organopolysiloxane residue.

In the disclosure, “Me” may refer to a methyl group, and “Et” may refer to an ethyl group.

### [Compound]

A compound of the disclosure is a compound having a chain group and a reactive silyl group, and has a number average molecular weight of from 1,600 to 10,000, and has a proportion of a component having a molecular weight of 1,500 or less of 5 mass % or less.

In one aspect, it is preferable that the compound of the disclosure is a compound having a chain organo(poly)siloxane residue and a reactive silyl group, and has a number average molecular weight of from 1,600 to 10,000, and has a proportion of a component having a molecular weight of 1,500 or less of 5 mass % or less.

Hereinafter, the component having a molecular weight of 1,500 or less is also referred to as a “low molecular weight component”, and the proportion of the low molecular weight component is also referred to as a “low molecular weight component proportion”.

When the compound of the disclosure is used as a surface treatment agent, a surface treatment layer having excellent wear resistance is formed. In addition, when the compound of the disclosure is used as a surface treatment agent, a surface treatment layer having excellent light resistance is formed. The reason is not clear.

Hereinafter, the compound of the disclosure will be described in detail.

The compound of the disclosure has a chain group and a reactive silyl group, and may contain another structure other than the chain group and the reactive silyl group. The compound of the disclosure preferably has a chain organo(poly)siloxane residue and a reactive silyl group, and may contain another structure other than the chain organo(poly)siloxane residue and the reactive silyl group.

Hereinafter, a compound having a chain group and a reactive silyl group is also referred to as a “specific silane compound”, and a compound having a chain organo(poly)siloxane residue and a reactive silyl group is also referred to as a “specific silane compound A”. In the disclosure, the description of the specific silane compound also applies to a case where “specific silane compound” is replaced with “specific silane compound A” unless there is a contradiction.

### (Chain Group)

The specific silane compound contains a chain group. The chain group may be linear without branches or may include a branch. The specific silane compound may have or need not have another structure such as a cyclic structure as long as it contains a chain group.

The chain group is not particularly limited as long as it has a chain structure in which two or more atoms are linked, and examples thereof include a chain hydrocarbon group; a chain organo(poly)siloxane residue; a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of a chain hydrocarbon group or between carbon atoms; and any combination thereof. R^{d} is a hydrogen atom or an alkyl group (preferably having from 1 to 10 carbon atoms).

Examples of the chain hydrocarbon group include a linear or branched chain hydrocarbon group having from 2 to 100, preferably from 5 to 90, and more preferably from 10 to 80 carbon atoms. The chain hydrocarbon group is preferably an alkylene group, and more preferably an alkylene group having the above-mentioned number of carbon atoms. From the viewpoint of forming a surface treatment layer having excellent acid resistance, hot water resistance, friction resistance, and the like, the chain hydrocarbon group is preferably an alkylene group having 13 or more carbon atoms.

The number of carbon atoms in a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of a chain hydrocarbon group or between carbon atoms is also the same as that described above. R^{d} is a hydrogen atom or an alkyl group (preferably having from 1 to 10 carbon atoms).

In one aspect, the chain group is preferably a chain organo(poly)siloxane residue. Hereinafter, the chain organo(poly)siloxane residue will be described in detail.

### (Chain Organo(Poly)Siloxane Residue)

The specific silane compound may contain one or two or more chain organo(poly)siloxane residues. When the specific silane compound contains two or more chain organo(poly)siloxane residues, the two or more chain organo(poly)siloxane residues may be the same or different.

Examples of the chain organo(poly)siloxane residue include a chain organo(poly)siloxane residue represented by Formula (B1) or (B2).

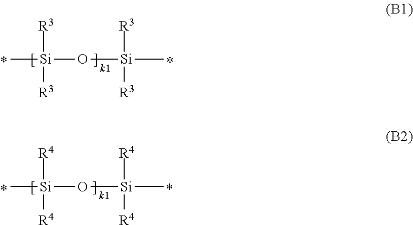

In Formula (B1),
each R³ is independently a hydrocarbon group,
k1 is a number of 1 or more, and
* is a bonding site to an adjacent atom.

In Formula (B2),
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more, and
* is a bonding site to an adjacent atom.

Examples of the hydrocarbon group represented by R³ in Formulae (B1) and (B2) include an aliphatic hydrocarbon group and an aromatic hydrocarbon group. Above all, the hydrocarbon group is preferably an aliphatic hydrocarbon group, and more preferably an alkyl group. The alkyl group may be any of a linear alkyl group, a branched alkyl group, and a cyclic alkyl group, but is preferably a linear alkyl group, more preferably a methyl group, an ethyl group, a n-propyl group, or a n-butyl group, and still more preferably a methyl group. The aromatic hydrocarbon group is preferably a phenyl group.

In Formulae (B1) and (B2), k1 is a number of 1 or more, preferably from 1 to 600, more preferably from 1 to 500, still more preferably from 3 to 500, particularly preferably from 9 to 50, extremely preferably from 11 to 30, and most preferably from 11 to 25.

In Formula (B2), each R⁴ is independently a hydrocarbon group or T¹¹-Bᵣ—(SiR³₂—O)ₖ₁—, and preferably a hydrocarbon group. Details of the hydrocarbon group are the same as those of the hydrocarbon group represented by R³.

Each T¹¹ is independently a monovalent group, and a specific aspect is the same as that of T¹¹ in Formula (C) described later.

Specific aspects of B and r are the same as those of B and r in Formula (C) described later.

### (Reactive Silyl Group)

The number of reactive silyl groups contained in the specific silane compound is 1 or more, and is preferably from 1 to 18, more preferably from 1 to 12, still more preferably from 1 to 8, particularly preferably from 1 to 6, and extremely preferably from 1 to 4 from the viewpoint of further improving the wear resistance of the surface treatment layer. In one aspect, the number of reactive silyl groups contained in the specific silane compound is preferably from 2 to 18, more preferably from 2 to 12, still more preferably from 2 to 8, and particularly preferably from 2 to 6. The number of reactive silyl groups may be one.

The reactive silyl group refers to a group in which a reactive group is bonded to a Si atom. The reactive group is preferably a hydrolyzable group, a group having a hydrolyzable group, or a hydroxy group.

The hydrolyzable group is a group that becomes a hydroxy group by a hydrolysis reaction. That is, a hydrolyzable silyl group represented by Si-L¹ (L¹ is a hydrolyzable group) becomes a silanol group represented by Si—OH by a hydrolysis reaction. Silanol groups further react between the silanol groups to form a Si—O—Si bond. The silanol group can form a Si—O—Si bond by a dehydration condensation reaction with a silanol group derived from an oxide present on the surface of the substrate.

Examples of the hydrolyzable group include an alkoxy group, an aryloxy group, a halogen atom, an acyl group, an acyloxy group, an amino group, —O—N═CR^{r}₂, and an isocyanato group (—NCO). The alkoxy group is preferably an alkoxy group having from 1 to 4 carbon atoms. The aryloxy group is preferably an aryloxy group having from 3 to 10 carbon atoms. However, the aryl group of the aryloxy group includes a heteroaryl group. The halogen atom is preferably a chlorine atom. The acyl group is preferably an acyl group having from 1 to 6 carbon atoms. The acyloxy group is preferably an acyloxy group having from 1 to 6 carbon atoms. Each R^{r} is independently an alkyl group having from 1 to 10 carbon atoms.

Examples of the group having a hydrolyzable group include a group having a hydrolyzable group exemplified above. The group having a hydrolyzable group is preferably —O-L^{A}-L^{B}. L^{A} is an alkylene group, and L^{B} is a hydrolyzable group. The number of carbon atoms in the alkylene group is preferably from 1 to 10. The hydrolyzable group represented by L^{B} has the same meaning as the hydrolyzable group described above, and the preferred aspect is also the same.

The reactive silyl group is preferably a group represented by Formula (S1).

—Si(R²)ₙL₃₋ₙ (S1)

In Formula (S1),
each R² is independently a monovalent hydrocarbon group,
each L is independently a hydrolyzable group, a group having a hydrolyzable group, or a hydroxy group, and
n is an integer from 0 to 2.

When there is a plurality of reactive silyl groups in one molecule, the plurality of reactive silyl groups may be the same or different from each other. From the viewpoint of ease of availability of the raw material and ease of production of the compound, the plurality of reactive silyl groups are preferably the same.

Each R² is independently a monovalent hydrocarbon group, and is preferably a monovalent saturated hydrocarbon group. The number of carbon atoms in R² is preferably from 1 to 6, more preferably from 1 to 3, and still more preferably from 1 to 2.

Each L is independently a hydrolyzable group, a group having a hydrolyzable group, or a hydroxy group. Details of the hydrolyzable group and the group having a hydrolyzable group are as described above.

Above all, L is preferably an alkoxy group having from 1 to 4 carbon atoms or a halogen atom from the viewpoint of ease of production of the compound. L is preferably an alkoxy group having from 1 to 4 carbon atoms, and more preferably an ethoxy group or a methoxy group from the viewpoint that there is less outgas generation during coating and the compound has more excellent storage stability.

n is an integer from 0 to 2, preferably 0 or 1, and more preferably 0. The presence of a plurality of Ls makes the adhesion of the surface treatment layer to the substrate stronger.

When n is 1 or less, a plurality of Ls present in one molecule may be the same or different from each other. From the viewpoint of ease of availability of the raw material and ease of production of the compound, the plurality of Ls are preferably the same. When n is 2, a plurality of R²s present in one molecule may be the same or different from each other. From the viewpoint of ease of availability of the raw material and ease of production of the compound, the plurality of R²s are preferably the same.

From the viewpoint that the surface treatment layer has excellent uniformity and durability, the reactive silyl group is preferably an alkoxysilyl group or a trichlorosilyl group. The reactive silyl group is more preferably an alkoxysilyl group from the viewpoint of ease of handling of a by-product generated in a reaction with the substrate. The alkoxysilyl group is preferably a dialkoxysilyl group or a trialkoxysilyl group, and more preferably a trialkoxysilyl group.

The reactive silyl group may be a group represented by Formula (S2).

>SiL₂ (S2)
L is the same as L in Formula (S1).

The reactive silyl group is also preferably a group represented by Formula (S3).

—[Si(L²)₂-P]ᵣ₁—Si(L²)₃ (S3)

In Formula (S3),
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms, and
r1 is an integer from 1 to 3.

When there is a plurality of groups (S3) in one molecule, the plurality of groups (S3) may be the same or different from each other. From the viewpoint of ease of availability of the raw material and ease of production of the compound, the plurality of groups (S3) are preferably the same.

Each L² is independently a hydrolyzable group, a group having a hydrolyzable group, a hydroxy group, or a hydrocarbon group.

Details of the hydrolyzable group and the group having a hydrolyzable group are as described above.

Above all, the hydrolyzable group or the group having a hydrolyzable group in L² is preferably an alkoxy group having from 1 to 4 carbon atoms, an alkylene oxide-modified alkoxy group, or a halogen atom from the viewpoint of ease of production of the compound. L² is preferably an alkoxy group having from 1 to 4 carbon atoms, and more preferably an ethoxy group or a methoxy group from the viewpoint that there is less outgas generation during coating and the compound has more excellent storage stability.

Examples of the hydrocarbon group represented by L² include an alkyl group, a cycloalkyl group, an alkenyl group, and an allyl group, and from the viewpoint of ease of synthesis and the like, a saturated hydrocarbon group is preferable, and an alkyl group is more preferable. The number of carbon atoms in the hydrocarbon group is preferably from 1 to 6, more preferably from 1 to 3, and still more preferably from 1 to 2.

r1 is an integer from 1 to 3, and is preferably from 1 to 2 and more preferably 1 from the viewpoint of ease of synthesis.

Each of at least four L2s among the plurality L²s included in one group (S3) is a hydrolyzable group, a group having a hydrolyzable group, or a hydroxy group. As a result, group (S3) and the substrate are more strongly bonded, and a surface treatment layer having excellent durability can be obtained. From such a viewpoint, the number of hydrolyzable groups, groups having a hydrolyzable group, and hydroxy groups in group (S3) is preferably from 4 to 9, more preferably from 4 to 7, and still more preferably 4 or 5.

The plurality of L²s present in one molecule may be the same or different from each other. For example, a plurality of L²s may be the same hydrolyzable group.

Each P is independently an oxygen atom or an organic group having one carbon atom bonded to adjacent Si atoms. Here, the “organic group having one carbon atom bonded to adjacent Si atoms” refers to that Si atoms are linked to each other via one carbon atom. Examples of P include a hydrocarbon group, and P may be, for example, —CH₂—, —C(CH₃)₂—, or the like. From the viewpoint of durability of the surface treatment layer, P is preferably an oxygen atom, —CH₂—, or —C(CH₃)₂—, more preferably an oxygen atom or —CH₂—, and still more preferably an oxygen atom.

From the viewpoint that the surface treatment layer has excellent durability, group (S3) is preferably —[Si(OR¹²)₂—O]ᵣ₁—Si(OR¹²)₃, and particularly preferably —Si(OR¹²)₂—O—Si(OR¹²)₃ in which r1=1. Here, each R¹² is independently a hydrocarbon group. Examples of the hydrocarbon group include an alkyl group, a cycloalkyl group, an alkenyl group, and an allyl group, and from the viewpoint of ease of synthesis, a saturated hydrocarbon group is preferable, and an alkyl group is more preferable. The number of carbon atoms in R¹² is preferably from 1 to 6, more preferably from 1 to 3, and still more preferably 1 or 2.

Specific examples of group (S3) include —Si(OCH₃)₂—O—Si(OCH₃)₃, —Si(OCH₃)₂—CH₂—Si(OCH₃)₃, —Si(OCH₃)₂—C(CH₃)₂—Si(OCH₃)₃, —Si(OCH₂CH₃)₂—O—Si(OCH₃)₃, —Si(OCH₃)₂—O—Si(OCH₂CH₃)₃, —Si(OCH₂CH₃)₂—O—Si(OCH₂CH₃)₃, —Si(OCH₂CH₃)₂—CH₂—Si(OCH₃)₃, —Si(OCH₃)₂—CH₂—Si(OCH₂CH₃)₃, —Si(OCH₂CH₃)₂—CH₂—Si(OCH₂CH₃)₃, —Si(OCH₂CH₃)₂—C(CH₃)₂—Si(OCH₃)₃, —Si(OCH₃)₂—C(CH₃)₂—Si(OCH₂CH₃)₃, —Si(OCH₂CH₃)₂—C(CH₃)₂—Si(OCH₂CH₃)₃, —Si(OH)₂—O—Si(OH)₃, —Si(OH)₂—O—Si(OCH₃)₃, —Si(OCH₃)₂—O—Si(OH)₃, —Si(OH)₂—CH₂—Si(OH)₃, —Si(OH)₂—CH₂—Si(OCH₃)₃, —Si(OCH₃)₂—CH₂—Si(OH)₃, —Si(OH)₂—C(CH₃)₂—Si(OH)₃, —Si(OH)₂—C(CH₃)₂—Si(OCH₃)₃, and —Si(OCH₃)₂—C(CH₃)₂—Si(OH)₃.

### (Molecular Weight)

The number average molecular weight of the specific silane compound is from 1,600 to 10,000, preferably from 1,600 to 8,000, and more preferably from 1,600 to 6,500.

When the number average molecular weight is the lower limit value or more, the surface treatment layer has more excellent wear resistance. When the number average molecular weight is the upper limit value or less, the viscosity is easily adjusted within an appropriate range, and the solubility is improved, so that handleability at the time of film formation is excellent.

The low molecular weight component proportion in the specific silane compound, that is, the proportion of the component having a molecular weight of 1,500 or less is 5 mass % or less, preferably 4 mass % or less, and more preferably 3 mass % or less.

The low molecular weight component proportion in the specific silane compound is preferably 1 mass % or more, more preferably 2 mass % or more, still more preferably 3 mass % or more from the viewpoint of ease of quality control, production, and the like.

The method of controlling the low molecular weight component proportion within the above range is not particularly limited, and examples thereof include a method of controlling by performing purification after producing the compound and adjusting the purification method and purification conditions, and a method of controlling by adjusting the production conditions of the compound (for example, the dropping order of monomers, the dropping rate, the polymerization temperature, and the like).

The number average molecular weight and the low molecular weight component proportion in the compound are determined by polystyrene conversion using the following calibration samples based on GPC (gel permeation chromatography) measurement. Examples of the measurement conditions include the following.

### Calibration Samples

Monodisperse polystyrene number average molecular weight: 29,150
Monodisperse polystyrene number average molecular weight: 19,540
Monodisperse polystyrene number average molecular weight: 6,770
Monodisperse polystyrene number average molecular weight: 4,430
Monodisperse polystyrene number average molecular weight: 1,930
Monodisperse polystyrene number average molecular weight: 1,020

### Column

TSKgel (registered trademark) SuperMultiporeHZ-N (4.6 mm I.D.×15 cm, manufactured by Tosoh Corporation)

### Apparatus

HLC-8320GPC system (manufactured by Tosoh Corporation)

### Eluent

Tetrahydrofuran

### Sample Concentration

15 mg/mL

Examples of the specific silane compound include a compound having a chain organo(poly)siloxane residue and a reactive silyl group linked only to one terminal of the chain organo(poly)siloxane residue (hereinafter also referred to as “one-terminal compound”), and a compound having a chain organo(poly)siloxane residue and reactive silyl groups linked to both terminals of the chain organo(poly)siloxane residue, respectively (hereinafter also referred to as “both-terminal compound”).

As the specific silane compound, a one-terminal compound may be used singly, a both-terminal compound may be used singly, or a one-terminal compound and a both-terminal compound may be used in combination. In any case, one kind may be used singly or two or more kinds may be used in combination as the one-terminal compound, and one kind may be used singly or two or more kinds may be used in combination as the both-terminal compound. When two or more kinds of compounds are used in combination as the specific silane compound, the number average molecular weight and the low molecular weight component proportion mean the number average molecular weight and the low molecular weight component proportion in the entirety of the two or more kinds of compounds, respectively.

### [One-Terminal Compound]

The one-terminal compound has a chain organo(poly)siloxane residue and a reactive silyl group linked only to one terminal of the chain organo(poly)siloxane residue. In the disclosure, the “reactive silyl group linked only to one terminal of a chain organo(poly)siloxane residue” refers to a reactive silyl group linked only to one terminal of a chain organo(poly)siloxane residue directly or indirectly via another chemical structure.

### (Chain Organo(Poly)Siloxane Residue)

The one-terminal compound contains a chain organo(poly)siloxane residue. The one-terminal compound may contain one or two or more chain organo(poly)siloxane residues. When the one-terminal compound contains two or more chain organo(poly)siloxane residues, the two or more chain organo(poly)siloxane residues may be the same or different. When the one-terminal compound contains two or more chain organo(poly)siloxane residues, it is sufficient that there is no chain organo(poly)siloxane residue having reactive silyl groups linked to both terminal sides, and a reactive silyl group is linked to one terminal side in at least one chain organo(poly)siloxane residue.

Details of the chain organo(poly)siloxane residue are as described above in the section of the chain organo(poly)siloxane residue contained in the specific silane compound. In particular, the chain organo(poly)siloxane residue is preferably represented by Formula (B1) or (B2), and more preferably represented by Formula (B1).

### (Reactive Silyl Group)

Details of the reactive silyl group are as described above in the section of the reactive silyl group contained in the specific silane compound.

The number of reactive silyl groups contained in the one-terminal compound is 1 or more per one terminal of the chain organo(poly)siloxane residue, and is preferably from 1 to 18, more preferably from 1 to 12, still more preferably from 1 to 8, particularly preferably from 1 to 6, and extremely preferably from 1 to 4 per one terminal of the chain organo(poly)siloxane residue from the viewpoint of further improving the wear resistance of the surface treatment layer. In one aspect, the number of reactive silyl groups contained in the one-terminal compound is preferably from 2 to 18, more preferably from 2 to 12, still more preferably from 2 to 8, and particularly preferably from 2 to 6 per one terminal of the chain organo(poly)siloxane residue. The number of reactive silyl groups may be 1 per one terminal of the chain organo(poly)siloxane residue.

### (Compound (C))

In one aspect, the one-terminal compound is preferably represented by Formula (C).

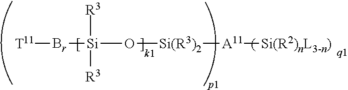

In Formula (C),
T¹¹ is a monovalent group that does not contain a reactive silyl group,
each B is independently —O— or —C(═O)—,
each r is independently 0 or 1,
each R³ is independently a hydrocarbon group,
each k1 is independently a number of 1 or more,
p1 is an integer of 1 or more,
A¹¹ is a (p1+q1)-valent linking group,
q1 is an integer of 1 or more,
each R² is independently a hydrocarbon group,
each L is independently a hydrolyzable group, a group having a hydrolyzable group, or a hydroxy group, and
each n is independently an integer from 0 to 2.

In Formula (C), R³ and k1 are the same as R³ and k1 in Formula (B1).

R², L, and n are the same as R², L, and n in Formula (S1).

In Formula (C), T¹¹ is a monovalent group.

Examples of T¹¹ include an alkyl group, T¹₃M¹- (here, M¹ is Si, Sn, or Ge, and each T¹ is independently a hydrocarbon group or a trialkylsilyloxy group), T¹₃-M¹-R¹— (here M¹ is Si, Sn, or Ge, each T¹ is independently a hydrocarbon group or a trialkylsilyloxy group, and R¹ is an alkylene group), a monovalent cyclic polysiloxane residue or a monovalent cage-like polysiloxane residue, and a combination of a monovalent cyclic polysiloxane residue or a monovalent cage-like polysiloxane residue and a divalent hydrocarbon group.

The alkyl group represented by T¹¹ may be any of a linear alkyl group, a branched alkyl group, and a cyclic alkyl group, and is preferably a linear alkyl group or a branched alkyl group. The number of carbon atoms in the alkyl group may be 1 or 2 or more. When the number of carbon atoms in the alkyl group is 2 or more, the number of carbon atoms is preferably from 2 to 30, more preferably from 3 to 28, and still more preferably from 4 to 22.

M¹ in T¹₃M¹- and T¹₃M¹-R¹— is preferably Si.

T¹ in T¹₃M¹- and T¹₃M¹-R¹— is preferably an alkyl group or a trialkylsilyloxy group, and more preferably a methyl group, a butyldimethylsilyloxy group, a trimethylsilyloxy group, or a triethylsilyloxy group.

R¹ is preferably an alkylene group having from 1 to 20 carbon atoms, more preferably an alkylene group having from 1 to 10 carbon atoms, still more preferably an alkylene group having from 1 to 5 carbon atoms, and particularly preferably an ethylene group.

In one aspect, T¹¹ is preferably an alkyl group, a trialkylsilyl group, or a tris(trialkylsilyloxy)silyl group, more preferably a methyl group, a trimethylsilyl group, or a tris(trimethylsilyloxy)silyl group, and still more preferably a trimethylsilyl group and a tris(trimethylsilyloxy)silyl group.

The monovalent cyclic polysiloxane residue is preferably a group represented by Formula (T1).

In Formula (T1),
each R^{T} is independently a hydrocarbon group, a hydrocarbon group having a substituent, and
s is an integer from 1 to 4.

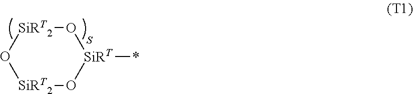

Examples of the hydrocarbon group represented by R^{T} include an aliphatic hydrocarbon group and an aromatic hydrocarbon group. Above all, the hydrocarbon group is preferably an aliphatic hydrocarbon group, and more preferably an alkyl group.

Among the hydrocarbon groups represented by R^{T}, the alkyl group may be any of a linear alkyl group, a branched alkyl group, and a cyclic alkyl group, but is preferably a linear alkyl group. The number of carbon atoms in the alkyl group is preferably from 1 to 10, more preferably from 1 to 8, and still more preferably from 1 to 4. Specifically, the alkyl group is preferably a methyl group, an ethyl group, a n-propyl group, or a n-butyl group, and more preferably a methyl group.

Examples of the hydrocarbon group contained in the hydrocarbon group having a substituent represented by R^{T} include an aliphatic hydrocarbon group and an aromatic hydrocarbon group. Above all, the hydrocarbon group is preferably an aliphatic hydrocarbon group, and more preferably an alkyl group. The alkyl group may be any of a linear alkyl group, a branched alkyl group, and a cyclic alkyl group, but is preferably a linear alkyl group. The number of carbon atoms in the alkyl group contained in the substituted alkyl group is preferably from 1 to 10, more preferably from 1 to 8, and still more preferably from 2 to 4.

Examples of the substituent in the hydrocarbon group having a substituent represented by R^{T} include a halogen atom, a hydroxy group, an alkoxy group, a trialkylsilyl ether group, a trialkylsilyl group, an amino group, a nitro group, a cyano group, a sulfonyl group, and a trifluoromethyl group.

A plurality of RJs may be identical or different from each other, but are preferably identical from the viewpoint of ease of production.

Examples of the monovalent cyclic polysiloxane residue include the following groups.

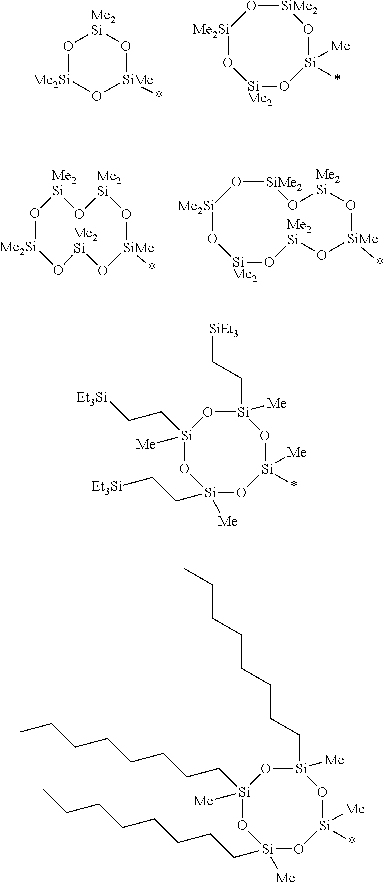

The monovalent cage-like polysiloxane residue is preferably a group represented by Formula (T2).

In Formula (T2),
each R⁵ is independently a hydrocarbon group or a trialkylsilyloxy group.

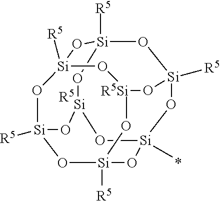

Examples of the hydrocarbon group represented by R⁵ include an aliphatic hydrocarbon group and an aromatic hydrocarbon group. Above all, the hydrocarbon group is preferably an aliphatic hydrocarbon group, and more preferably an alkyl group. The alkyl group may be any of a linear alkyl group, a branched alkyl group, and a cyclic alkyl group, but is preferably a linear alkyl group or a branched alkyl group, more preferably a methyl group, an ethyl group, a n-propyl group, a n-butyl group, or an isobutyl group, and still more preferably an isobutyl group.

The alkyl group contained in the trialkylsilyloxy group represented by R⁵ may be any of a linear alkyl group, a branched alkyl group, and a cyclic alkyl group, but is preferably a linear alkyl group, more preferably a methyl group, an ethyl group, a n-propyl group, or a n-butyl group, and still more preferably a methyl group. When R⁵ is a trialkylsilyloxy group, the three alkylsilyloxy groups may be identical or different from each other, but are preferably identical from the viewpoint of ease of production.

Examples of the monovalent cage-like polysiloxane residue include the following groups.

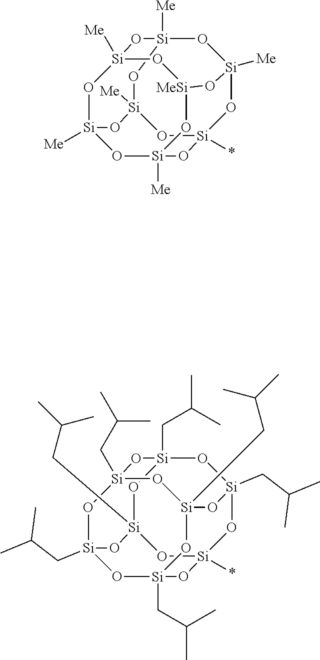

Examples of the divalent hydrocarbon group in the combination of the monovalent cyclic polysiloxane residue or the monovalent cage-like polysiloxane residue and the divalent hydrocarbon group include an alkylene group. The number of carbon atoms in the alkylene group is preferably from 1 to 20, more preferably from 1 to 10, and still more preferably from 1 to 5.

In Formula (C), each B is independently —O— or —C(═O)—, and is preferably —O—.

In Formula (C), p1 is an integer of 1 or more, preferably an integer from 1 to 3, more preferably 1 or 2, and still more preferably 1.

When p1 is 2 or more, a plurality of {T¹¹-Bᵣ—[Si(R³)₂—O]ₖ₁—Si(R³)₂-}s may be identical or different from each other.

In Formula (C), A¹¹ is a (p1+q1)-valent linking group. Examples of A¹¹ include an alkylene group, an organo(poly)siloxane residue, a polyalkylene oxide group, and any combination thereof; and any combination of these with a (p1+1)-valent group and/or a (q1+1)-valent group.

Examples of the alkylene group include an alkylene group having from 1 to 30 carbon atoms, preferably an alkylene group having from 1 to 20 carbon atoms, which may have or need not have at least one selected from the group consisting of an ether oxygen atom, a sulfur atom. —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group.

Examples of the organo(poly)siloxane residue include a group represented by Formula (B1).

Examples of the polyalkylene oxide group include a group represented by Formula (XO)ₘ. Here, each X is independently an alkylene group having from 1 to 5 carbon atoms, and m is an integer of 1 or more. The number of carbon atoms in X is preferably from 1 to 4, and more preferably 2 or 3. m is preferably from 1 to 200, more preferably from 1 to 20, and still more preferably from 1 to 10.

Examples of A¹¹ include A in Formula A(Si(R²)ₙL₃₋ₙ)_{q1} described later.

In Formula (C), q1 is an integer of 1 or more, preferably from 1 to 18, more preferably from 1 to 12, still more preferably from 1 to 8, particularly preferably from 1 to 6, and extremely preferably from 1 to 4. In one aspect, q1 is preferably from 2 to 18, more preferably from 2 to 12, still more preferably from 2 to 8, particularly preferably from 2 to 6, and extremely preferably from 2 to 4. q1 may be 1.

When q1 is an integer of 2 or more, a plurality of [Si(R²)ₙL₃₋ₙ]s may be identical or different from each other.

In one aspect, T¹¹ in Formula (C) is preferably a trialkylsilyl group or an alkyl group, and more preferably a trimethylsilyl group or a methyl group.

B is preferably 0, and r is 0 or 1.

R³ is preferably a methyl group.

k1 is preferably from 1 to 500, and more preferably from 1 to 100. It may be from 3 to 500 or from 3 to 100.

p1 is preferably 1.

A¹¹ is preferably an alkylene group having from 1 to 30 carbon atoms or a group obtained by removing Si(R²)ₙL₃₋ₙ, from the below-mentioned group (3-1A), and more preferably an alkylene group having from 1 to 30 carbon atoms or a group obtained by removing Si(R²)ₙL₃₋ₙ from the below-mentioned group (3-1A-4).

q1 is preferably an integer from 1 to 4.

### (Compound (C2))

In a further aspect, the one-terminal compound is preferably represented by Formula (C2).

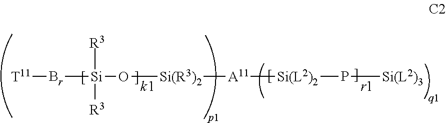

In Formula (C2),
each L² is independently a hydrolyzable group, a group having a hydrolyzable group, a hydroxy group, or a hydrocarbon group,
each of at least four L²s among L²s is a hydrolyzable group, a group having a hydrolyzable group, or a hydroxy group,
each P is independently an oxygen atom or an organic group having one carbon atom bonded to adjacent Si atoms,
r1 is an integer from 1 to 3, and
the definitions of T¹¹, B, r, R³, k1, p1, A¹¹, and q1 are the same as the definitions in Formula (C),

Specific aspects of T¹¹, B, r, R³, k1, p1, A¹¹, and q1 in Formula (C2) are the same as the specific aspects of those in Formula (C).

Specific aspects of L², P, and r1 in Formula (C2) are the same as specific aspects of L², P, and r1 in Formula (S3).

### [Both-Terminal Compound]

The both-terminal compound has a chain organo(poly)siloxane residue and reactive silyl groups linked to both terminals of the chain organo(poly)siloxane residue, respectively. In the disclosure, the term “reactive silyl groups linked to both terminals of a chain organo(poly)siloxane residue, respectively” refers to reactive silyl groups linked to both terminals of a chain organo(poly)siloxane residue directly or indirectly via another chemical structure.

### (Chain Organo(Poly)Siloxane Residue)

The both-terminal compound contains a chain organo(poly)siloxane residue. The both-terminal compound may contain one or two or more chain organo(poly)siloxane residues. When the both-terminal compound contains two or more chain organo(poly)siloxane residues, the two or more chain organo(poly)siloxane residues may be the same or different. When the both-terminal compound contains two or more chain organo(poly)siloxane residues, it is sufficient that reactive silyl groups are linked to both terminal sides in at least one chain organo(poly)siloxane residue.

Details of the chain organo(poly)siloxane residue areas described above in the section of the chain organo(poly)siloxane residue contained in the specific silane compound. In particular, the chain organo(poly)siloxane residue is preferably represented by Formula (B1) or (B2), and more preferably represented by Formula (B1).

### (Reactive Silyl Group)

Details of the reactive silyl group are as described above in the section of the reactive silyl group contained in the specific silane compound.

The number of reactive silyl groups contained in the both-terminal compound is 1 or more per one terminal of the chain organo(poly)siloxane residue, and is preferably from 1 to 18, more preferably from 1 to 12, still more preferably from 1 to 8, particularly preferably from 1 to 6, and extremely preferably from 1 to 4 per one terminal of the chain organo(poly)siloxane residue from the viewpoint of further improving the wear resistance of the surface treatment layer. In one aspect, the number of reactive silyl groups contained in the both-terminal compound is preferably from 2 to 18, more preferably from 2 to 12, still more preferably from 2 to 8, and particularly preferably from 2 to 6 per one terminal of the chain organo(poly)siloxane residue. The number of reactive silyl groups may be 1 per one terminal of the chain organo(poly)siloxane residue.

### (Compound (D))

In one aspect, the both-terminal compound is preferably represented by Formula (D).

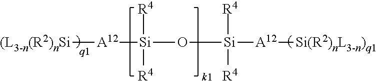

In Formula (D),
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more,
each A¹² is independently a (q1+1)-valent linking group,
each q1 is independently an integer of 1 or more,
each R² is independently a hydrocarbon group,
each L is independently a hydrolyzable group, a group having a hydrolyzable group, or a hydroxy group, and
each n is independently an integer from 0 to 2.

In Formula (D), R⁴ and k1 are the same as R⁴ and k1 in Formula (B2).

R², L, and n are the same as R², L, and n in Formula (S1).

Examples of A¹² include an alkylene group, an organo(poly)siloxane residue, a polyalkylene oxide group, and any combination thereof; and any combination of these with a (q1+1)-valent group.

Examples of the alkylene group include an alkylene group having from 1 to 30 carbon atoms, preferably an alkylene group having from 1 to 20 carbon atoms, which may have or need not have at least one selected from the group consisting of an ether oxygen atom, a sulfur atom. —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group.

Examples of the organo(poly)siloxane residue include a group represented by Formula (B1) or (B2).

Examples of the polyalkylene oxide group include a group represented by Formula (XO)ₘ. Here, each X is independently an alkylene group having from 1 to 5 carbon atoms, and m is an integer of 1 or more. The number of carbon atoms in X is preferably from 1 to 4, and more preferably 2 or 3. m is preferably from 1 to 100, more preferably from 1 to 10, and still more preferably from 1 to 5.

Examples of A¹² include a (q1+1)-valent group in A in Formula A(Si(R²)ₙL₃₋ₙ)_{q1} described later.

Each q1 is independently an integer of 1 or more, and is independently preferably from 1 to 18, more preferably from 1 to 12, still more preferably from 1 to 8, particularly preferably from 1 to 6, and extremely preferably from 1 to 4. In one aspect, q1 is preferably from 2 to 18, more preferably from 2 to 12, still more preferably from 2 to 8, particularly preferably from 2 to 6, and extremely preferably from 2 to 4. q1 may be 1.

When q1 is an integer of 2 or more, a plurality of [Si(R²)ₙL₃₋ₙ]s may be identical or different from each other.

In one aspect, R⁴ is preferably a methyl group.

k1 is preferably a number from 1 to 500, and more preferably a number from 1 to 100. It may be from 3 to 500 or from 3 to 100.

A¹² is preferably an alkylene group having from 1 to 30 carbon atoms or a group obtained by removing Si(R²)ₙL₃₋ₙ, from the below-mentioned group (3-1A), and more preferably an alkylene group having from 1 to 30 carbon atoms or a group obtained by removing Si(R²)ₙL₃₋ₙ from the below-mentioned group (3-1A-4).

q1 is preferably an integer from 1 to 4.

### (Compound (D2))

In a further aspect, the both-terminal compound is preferably represented by Formula (D2).

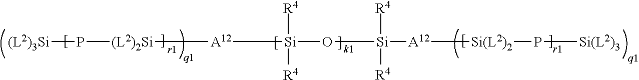

In Formula (D2),
each L² is independently a hydrolyzable group, a group having a hydrolyzable group, a hydroxy group, or a hydrocarbon group,
each of at least four L²s among L²s is a hydrolyzable group, a group having a hydrolyzable group, or a hydroxy group,
each P is independently an oxygen atom or an organic group having one carbon atom bonded to adjacent Si atoms,
each r1 is independently an integer from 1 to 3, and
the definitions of R⁴, k1, A¹², and q1 are the same as the definitions in Formula (D).

Specific aspects of R⁴, k1, A¹², and q1 in Formula (D2) are the same as the specific aspects of those in Formula (D).

Specific aspects of L², P, and r1 in Formula (D2) are the same as specific aspects of L², P, and r1 in Formula (S3).

### [Compound (E) or (E2)]

In one aspect, the specific silane compound may be a compound represented by Formula (E).

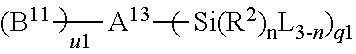

In Formula (E),
B¹¹ is a monovalent group containing at least one selected from the group consisting of Si, Ge, and Sn to which a hydroxy group or a hydrolyzable group is not directly bonded, or a monovalent group containing a branched alkyl group,
u1 is an integer of 1 or more,
A¹³ is a (q1+u1)-valent linking group,
q1 is an integer of 1 or more,
each R² is independently a hydrocarbon group,
each L is independently a hydrolyzable group, a group having a hydrolyzable group, or a hydroxy group, and
each n is independently an integer from 0 to 2.

In Formula (E), R², L, and n are the same as R², L, and n in Formula (S1).

q1 is the same as q1 in Formula (C).

B¹¹ is a monovalent group containing at least one selected from the group consisting of Si, Ge, and Sn to which a hydroxy group or a hydrolyzable group is not directly bonded; or a monovalent group containing a branched alkyl group. The monovalent group containing at least one selected from the group consisting of Si, Ge, and Sn to which a hydroxy group or a hydrolyzable group is not directly bonded may contain or need not contain Si, Ge, or Sn to which a hydroxy group or a hydrolyzable group is directly bonded.

In one aspect, B¹¹ may be a group having a group (a) or a group (b).

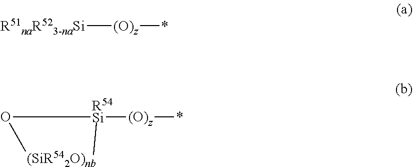

In Formula (a),
R⁵¹ is a group represented by —(R⁶¹—SiR⁵³₂)ₘₐ—R⁵³, in which each R⁶¹ is independently an oxygen atom or an alkylene group having from 1 to 6 carbon atoms, each R⁵³ is independently a hydrocarbon group or R⁵¹′, R⁵¹′ has the same meaning as R⁵¹, and ma is an integer from 1 to 5, provided that the number of R⁵¹s in R⁵¹ is 20 or less,
R⁵² is a hydrocarbon group,
na is an integer from 1 to 3,
z is 0 or 1, and
* represents a bonding site to an adjacent atom.

In Formula (b),
each R¹⁴ is independently a hydrocarbon group,
nb is an integer from 1 to 5,
z is 0 or 1, and
* represents a bonding site to an adjacent atom.

The alkylene group having from 1 to 6 carbon atoms in R may be linear or branched. The alkylene group having from 1 to 6 carbon atoms is preferably an alkylene group having from 1 to 4 carbon atoms, and more preferably an alkylene group having from 2 to 4 carbon atoms.

The hydrocarbon group represented by R⁵³ is preferably an alkyl group or an aryl group. The alkyl group may be linear or branched. The alkyl group is preferably an alkyl group having from 1 to 6 carbon atoms, more preferably an alkyl group having from 1 to 4 carbon atoms, and still more preferably a methyl group, an ethyl group, a n-propyl group, an isopropyl group, or a tert-butyl group.

The hydrocarbon group represented by R⁵² is preferably an alkyl group or an aryl group. The alkyl group may be linear or branched. The alkyl group is preferably an alkyl group having from 1 to 6 carbon atoms, more preferably an alkyl group having from 1 to 4 carbon atoms, and still more preferably a methyl group, an ethyl group, a n-propyl group, an isopropyl group, or a tert-butyl group.

The hydrocarbon group represented by R⁵⁴ is preferably an alkyl group or an aryl group. The alkyl group may be linear or branched. The alkyl group is preferably an alkyl group having from 1 to 6 carbon atoms, more preferably an alkyl group having from 1 to 4 carbon atoms, and still more preferably a methyl group, an ethyl group, a n-propyl group, an isopropyl group, or a tert-butyl group.

nb is an integer from 1 to 5, and is preferably 2 or 3.

Examples of the group having a group (a) or a group (b) include a group (a) or a group (b) singly and a group in which a chain group is linked to a group (a) or a group (b).

Examples of the chain group include a chain hydrocarbon group; a chain organo(poly)siloxane residue; a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of a chain hydrocarbon group or between carbon atoms; and any combination thereof. R^{d} is a hydrogen atom or an alkyl group (preferably having from 1 to 10 carbon atoms).

Examples of the chain hydrocarbon group include a linear or branched chain hydrocarbon group having from 2 to 100, preferably from 5 to 90, and more preferably from 10 to 80 carbon atoms. The chain hydrocarbon group is preferably an alkylene group, and from the viewpoint of forming a surface treatment layer having excellent acid resistance, hot water resistance, friction resistance, and the like, the chain hydrocarbon group is preferably an alkylene group having 13 or more carbon atoms.

The number of carbon atoms in a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of a chain hydrocarbon group or between carbon atoms is also the same as that described above. R^{d} is a hydrogen atom or an alkyl group (preferably having from 1 to 10 carbon atoms).

Examples of the chain organo(poly)siloxane residue include the examples described above as the chain organo(poly)siloxane residue in the specific silane compound.

In one aspect, B¹¹ may be a group having a group (c).

-M³¹(R³¹)₂— (c)

In Formula (c),
M³ is Sn or Ge, and
each R³¹ is independently a hydrocarbon group or a trialkylsilyloxy group.

M³¹ is Sn or Ge. M³¹ is preferably Ge from the viewpoint that Ge has a larger atomic size than Sn, can further reduce surface free energy, and can form a surface treatment layer having excellent fingerprint removability.

R³¹ is a hydrocarbon group or a trialkylsilyloxy group.

Examples of the hydrocarbon group include an alkyl group, a cycloalkyl group, an alkenyl group, and an allyl group, and from the viewpoint of ease of synthesis and the like, a saturated hydrocarbon group is preferable, and an alkyl group is more preferable. The number of carbon atoms in R¹ is preferably from 1 to 6, more preferably from 1 to 3, and particularly preferably —CH₃ or —CH₂CH₃.

The trialkylsilyloxy group is preferably a group represented by —O—SiR⁴⁰₃. Each R⁴⁰ is independently a hydrocarbon group. The hydrocarbon group of R⁴⁰ is preferably an alkyl group or an aryl group, and more preferably an alkyl group. The number of carbon atoms in R⁴⁰ is preferably from 1 to 6, more preferably from 1 to 4, and still more preferably from 1 to 2. Specific examples of the hydrocarbon group in R⁴⁰ include —CH₃, —CH₂CH₃, and —C(CH₃)₃.

Examples of the group having a group (c) include a group (c) singly, and a group in which an organic group is linked to one side or both sides of M³¹ in a group (c). Examples of the organic group include a monovalent organic group, a divalent organic group, and any combination thereof. However, a monovalent organic group is not linked to both sides.

Examples of the monovalent organic group include a hydrocarbon group, a trialkylsilyloxy group, and an organopolysiloxane group. The group (c) may be M³¹(R³¹)₃—.

Examples of the divalent organic group include a chain hydrocarbon group; a chain organo(poly)siloxane residue; a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of a chain hydrocarbon group or between carbon atoms; and any combination thereof. R^{d} is a hydrogen atom or an alkyl group (preferably having from 1 to 10 carbon atoms).

Examples of the chain hydrocarbon group include a linear or branched chain hydrocarbon group having from 2 to 100, preferably from 5 to 90, and more preferably from 10 to 80 carbon atoms. Examples of the chain hydrocarbon group include an alkyl group and an alkylene group. From the viewpoint of forming a surface treatment layer having excellent acid resistance, hot water resistance, friction resistance, and the like, the chain hydrocarbon group is preferably an alkylene group having 13 or more carbon atoms.

The number of carbon atoms in a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of a chain hydrocarbon group or between carbon atoms is also the same as that described above. R^{d} is a hydrogen atom or an alkyl group (preferably having from 1 to 10 carbon atoms).

Examples of the chain organo(poly)siloxane residue include the examples described above as the chain organo(poly)siloxane residue in the specific silane compound.

In one aspect, B¹¹ may be a monovalent group containing a branched alkyl group. The branched alkyl group is preferably unsubstituted. It is preferable that the branched alkyl group is a tert-butyl group or contains a tert-butyl group. The branched alkyl group may include one branch or a plurality of branches. The number of branches in the branched alkyl group may be from 1 to 30, from 1 to 20, from 1 to 10, or from 1 to 5.

Examples of the branched alkyl group include a group represented by the following formula.

[(CH₃)₃C—R²²-]ₘ₂₂C(CH₃)₃₋ₘ₂₂—

In the formula,
each R² is independently an alkylene group having from 1 to 6 carbon atoms, and
m22 is an integer from 0 to 3.

Examples of the monovalent group containing a branched alkyl group include a group in which a chain group is linked to a carbon atom serving as a branch point of the branched alkyl group.

Examples of the chain group include a chain hydrocarbon group; a chain organo(poly)siloxane residue; a group having at least one selected from the group consisting of —O—, —S—. —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and a phenylene group at a terminal of a chain hydrocarbon group or between carbon atoms; and any combination thereof.

Examples of the chain hydrocarbon group include a linear or branched chain hydrocarbon group having from 2 to 100, preferably from 5 to 90, and more preferably from 10 to 80 carbon atoms. The chain hydrocarbon group is preferably an alkylene group, and from the viewpoint of forming a surface treatment layer having excellent acid resistance, hot water resistance, friction resistance, and the like, the chain hydrocarbon group is preferably an alkylene group having 13 or more carbon atoms.

The number of carbon atoms in a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of a chain hydrocarbon group or between carbon atoms is also the same as that described above. R^{d} is a hydrogen atom or an alkyl group (preferably having from 1 to 10 carbon atoms).

Examples of the chain organo(poly)siloxane residue include the examples described above as the chain organo(poly)siloxane residue in the specific silane compound.

In Formula (E), u1 is an integer of 1 or more. From the viewpoint of ease of production and the like, u1 is preferably from 1 to 6, and more preferably from 1 to 4.

In Formula (E), A¹³ is a (q1+u1)-valent linking group. Specific examples of A¹³ are the same as the specific examples of A¹¹ in Formula (C).

The compound (E) may be a compound in which B¹¹ is a group (a) or M³¹(R³¹)₃—, u1 is 1, A¹³ is an alkylene group having from 1 to 30 carbon atoms, which may have or need not have at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—. —S(═O)₂—, —S(═O)₂O—, —OS(═O)₂—, and a phenylene group between carbon atoms, and q1 is 1. The compound (E) may be a compound in which B¹¹ is a group (a) or M³¹(R³¹)₃—, u1 is 1, A¹³ is a chain hydrocarbon group having from 1 to 30 carbon atoms, which may have or need not have at least one selected from the group consisting of —O—, —S—, —C(═O)NH—, —NHC(═O)—, —N(R^{d})—, —C(═O)O—, —OC(═O)—, —C(═O)S—. —SC(═O)—, —S(═O)₂NH—, —NHS(═O)₂—, —S(═O)₂—, —S(═O)₂O—, —OS(═O)₂—, and a phenylene group between carbon atoms, and q1 is 2 or 3.

R^{d} is a hydrogen atom or an alkyl group (preferably having from 1 to 10 carbon atoms).

Specific examples of the compound (E) include the following compounds. In the following formulae, sa is preferably from 1 to 30, more preferably from 4 to 20, and still more preferably from 5 to 15.

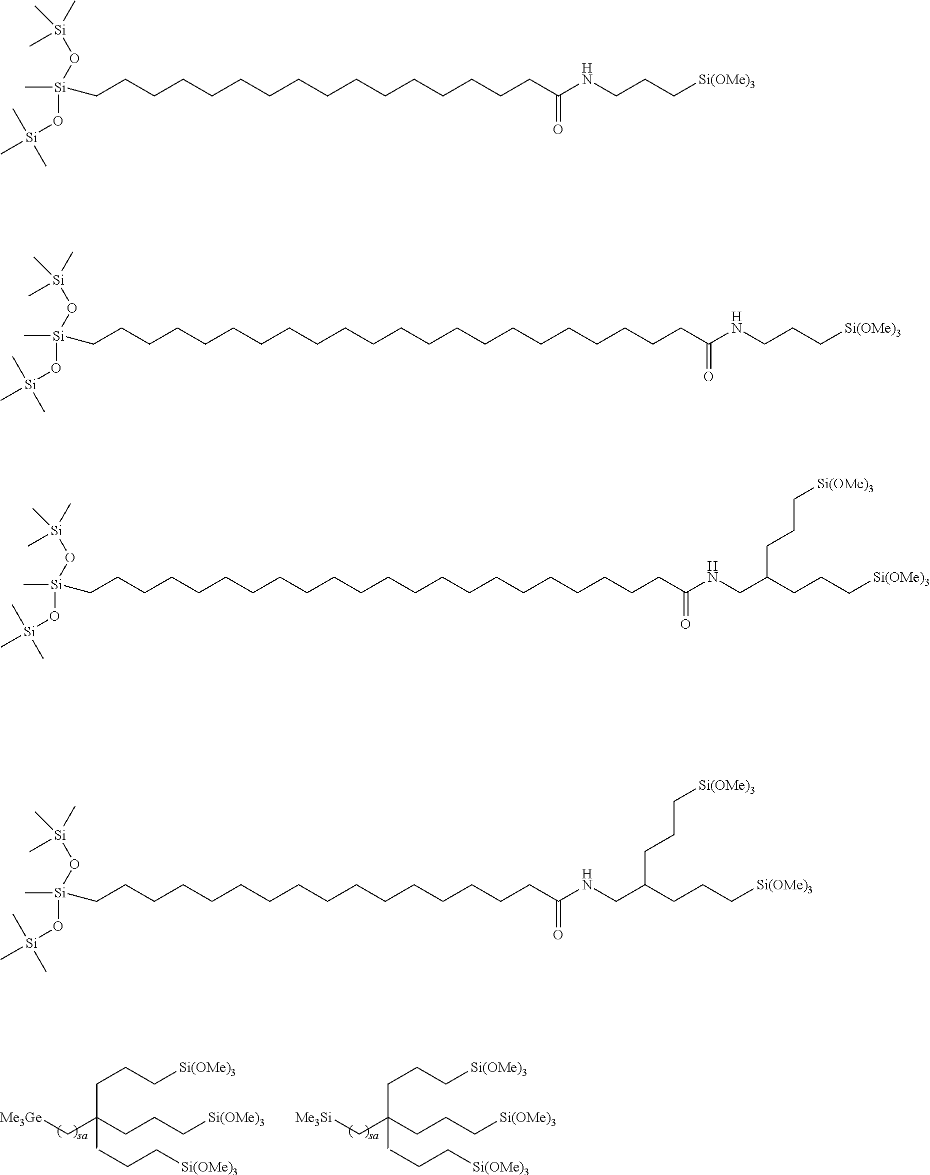

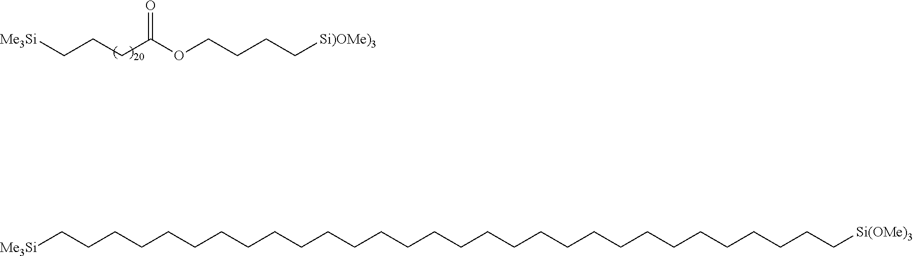

In one aspect, the specific silane compound may be a compound represented by Formula (E2).

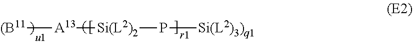

In Formula (E2),
each L² is independently a hydrolyzable group, a group having a hydrolyzable group, a hydroxy group, or a hydrocarbon group,
each of at least four L²s among L²s is a hydrolyzable group, a group having a hydrolyzable group, or a hydroxy group,
each P is independently an oxygen atom or an organic group having one carbon atom bonded to adjacent Si atoms,
each r1 is independently an integer from 1 to 3, and
the definitions of B¹¹, u1, A¹³, and q1 are the same as the definitions in Formula (E).

Specific aspects of B¹¹, u1, A¹³, and q1 are the same as the specific aspects of those in Formula (E).

Specific aspects of L², P, and r1 are the same as the specific aspects of those in Formula (S3).

### [Partial Structures of One-Terminal Compound, Both-Terminal Compound, and Compound (E)]

Hereinafter, preferred aspects of A¹(Si(R²)ₙL₃₋ₙ)_{q1} in Formula (C) and A¹²(Si(R²)ₙL₃₋ₙ)_{q1} in Formula (D) will be described in detail. Hereinafter, A¹²(Si(R²)ₙL₃₋ₙ)_{q1} in Formula (C) and A¹²(Si(R²)ₙL₃₋ₙ)_{q1} in Formula (D) are collectively referred to as A(Si(R²)ₙL₃₋ₙ)_{q1}.

In Formula (C), A is a (p1+q1)-valent group, in Formula (D), A is a (q1+1)-valent group, and in Formula (E), A is a (q1+u1)-valent group.

The group represented by A(Si(R²)ₙL₃₋ₙ)_{q1} is preferably a group (3-1A) or a group (3-1B), and more preferably a group (3-1A).

-Q^{a}-X³¹(-Q-Si(R²)ₙL₃₋ₙ)ₕ(—R³¹)ᵢ (3-1A)

-Q^{c}-CH₂C(R³²)(-Q^{d}-Si(R²)ₙL₃₋ₙ)_{y}-R³³ (3-1B)

In Formula (3-4A) and Formula (3-1B), the definitions of R², L, and n are as described above.

In Formula (3-A), Q^{a} is a single bond or a divalent linking group.

Examples of the divalent linking group include a divalent hydrocarbon group, a divalent heterocyclic group, —O—, —S—, —SO₂—, —N(R^{d})—, —C(O)—, —Si(R^{a})₂—, and a group obtained by combining two or more thereof.

The divalent hydrocarbon group may be a divalent saturated hydrocarbon group, a divalent aromatic hydrocarbon group, an alkenylene group, or an alkynylene group. The divalent saturated hydrocarbon group may be linear, branched, or cyclic, and examples thereof include an alkylene group. The number of carbon atoms in the alkylene group is preferably from 1 to 30, more preferably from 1 to 20, still more preferably from 4 to 20, and particularly preferably from 5 to 15. The divalent aromatic hydrocarbon group is preferably one having from 5 to 20 carbon atoms, and examples thereof include a phenylene group. In addition, the divalent aromatic hydrocarbon group may be an alkenylene group having from 2 to 20 carbon atoms or an alkynylene group having from 2 to 20 carbon atoms.

R^{a} is an alkyl group (preferably having from 1 to 10 carbon atoms) or a phenyl group. R^{d} is a hydrogen atom or an alkyl group (preferably having from 1 to 10 carbon atoms).

Examples of the group obtained by combining two or more thereof include —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an ether oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, and an alkylene group-Si(R^{a})₂-phenylene group-Si(R^{a})₂.

In Formula (3-4A), X³¹ is a single bond, an alkylene group, a carbon atom, a nitrogen atom, a silicon atom, a divalent to octavalent organo(poly)siloxane residue, or a group having a (h+i+1)-valent ring.

The alkylene group may have —O—, a silphenylene backbone group, a divalent organo(poly)siloxane residue, or a dialkylsilylene group. The alkylene group may have a plurality of groups selected from the group consisting of —O—, a silphenylene backbone group, a divalent organo(poly)siloxane residue, and a dialkylsilylene group.

The number of carbon atoms in the alkylene group represented by X is preferably from 1 to 20, and more preferably from 1 to 10.

Examples of the divalent to octavalent organo(poly)siloxane residue include a divalent organo(poly)siloxane residue and a (w2+1)-valent organo(poly)siloxane residue described later.

In Formula (3-4A), when X³¹ is a group having a (h+i+1)-valent ring, Q^{a}, (-Q^{b}-Si(R²)ₙL₃₋ₙ), and R³¹ are directly bonded to atoms included in the ring. However, the ring is a ring other than an organopolysiloxane ring.

The ring in X may be any of a monocyclic ring, a fused polycyclic ring, a bridged ring, a spiro ring, and an assembled polycyclic ring. The atoms included in the ring may be a carbocyclic ring formed only of carbon atoms, or may be a heterocyclic ring formed of a heteroatom having a valence of 2 or more and a carbon atom. The bond between atoms included in the ring may be a single bond or a multiple bond. The ring may be an aromatic ring or a non-aromatic ring.

The monocyclic ring is preferably a 4- to 8-membered ring, and more preferably a 5- or 6-membered ring. The fused polycyclic ring is preferably a fused polycyclic ring in which two or more 4- to 8-membered rings are fused, and more preferably a fused polycyclic ring in which two or three rings selected from 5- and 6-membered rings are bonded, and a fused polycyclic ring in which one or two rings selected from 5- and 6-membered rings and one 4-membered ring are bonded. The bridged ring is preferably a bridged ring having a 5- or 6-membered ring as the largest ring, and the spiro ring is preferably a spiro ring formed of two 4- to 6-membered rings. The assembled polycyclic ring is preferably an assembled polycyclic ring in which two or three rings selected from 5- and 6-membered rings are bonded via a single bond, one to three carbon atoms, or one heteroatom having a valence of 2 or 3. In the assembled polycyclic ring, any of Q^{a}, (-Q^{b}-Si(R²)ₙL₃₋ₙ), and R³¹ (when i=1 or more) is preferably bonded to each ring.

As the heteroatom included in the ring, a nitrogen atom, an oxygen atom, and a sulfur atom are preferable, and a nitrogen atom and an oxygen atom are more preferable. The number of heteroatoms included in the ring is preferably 3 or less. When the number of heteroatoms included in the ring is 2 or more, those heteroatoms may be different.

The ring in X³¹ is preferably one selected from the group consisting of a 3- to 8-membered aliphatic ring, a benzene ring, a 3- to 8-membered heterocyclic ring, a fused ring in which 2 or 3 of these rings are fused, a bridged ring having a 5- or 6-membered ring as the largest ring, and an assembled polycyclic ring, which has two or more of these rings, and in which a linking group is a single bond, an alkylene group having 3 or less carbon atoms, an oxygen atom, or a sulfur atom, from the viewpoint that the compound is easily produced and the surface treatment layer has more excellent wear resistance.

Preferred rings are a benzene ring, a 5- or 6-membered aliphatic ring, a 5- or 6-membered heterocyclic ring having a nitrogen atom or an oxygen atom, and a fused ring of a 5- or 6-membered carbocyclic ring and a 4- to 6-membered heterocyclic ring.

Specific examples of the ring include the following rings, a 1,3-cyclohexadiene ring, a 1,4-cyclohexadiene ring, an anthracene ring, a cyclopropane ring, a decahydronaphthalene ring, a norborene ring, a norbornadiene ring, a furan ring, a pyrrole ring, a thiophene ring, a pyrazine ring, a morpholine ring, an aziridine ring, an isoquinoline ring, an oxazole ring, an isoxazole ring, a thiazole ring, an imidazole ring, a pyrazole ring, a pyran ring, a pyridazine ring, a pyrimidine ring, and an indene ring. Rings having an oxo group (═O) are also shown below.

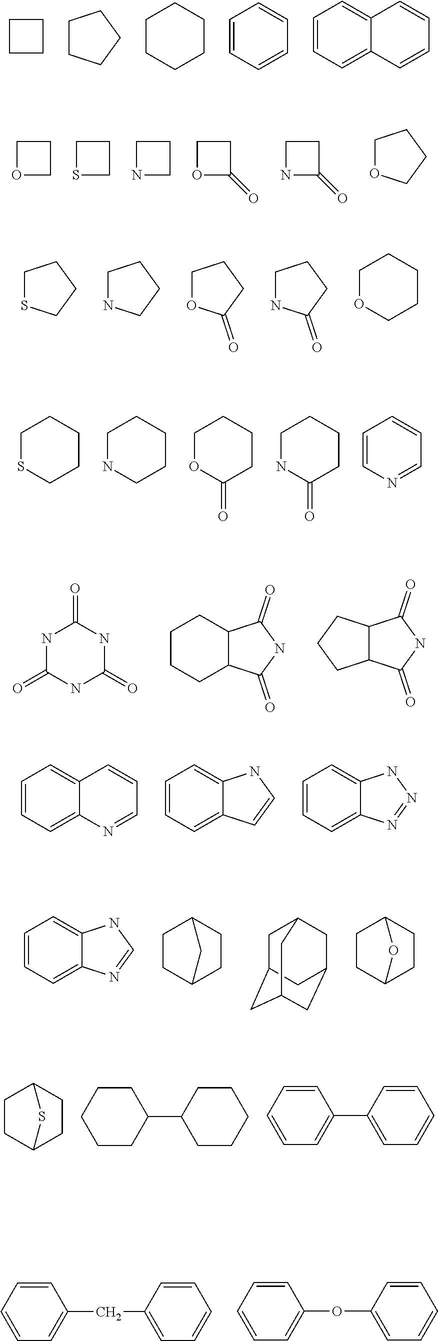

A non-ring-forming bond of an atom included in the ring in X³¹ is a bond bonded to Q^{a}, (-Q^{b}-Si(R²)ₙL₃₋ₙ), or R³¹. When there is a remaining bond, the remaining bond is bonded to a hydrogen atom or a substituent. Examples of the substituent include a halogen atom, an alkyl group (an ether oxygen atom may be contained between carbon atoms), a cycloalkyl group, an alkenyl group, an allyl group, an alkoxy group, or an oxo group (═O).

When one of the carbon atoms included in the ring has two bonds bonded to Q^{a}, (-Q^{b}-Si(R²)ₙL₃₋ₙ), or R³¹, Q^{a} and (-Q^{b}-Si(R²)ₙL₃₋ₙ) may be bonded to the one carbon atom, or two (-Q^{b}-Si(R²)ₙL₃₋ₙ)s may be bonded thereto. Q^{a} and (-Q^{b}-Si(R²)ₙL₃₋ₙ) or R³¹ are preferably bonded to different ring-forming atoms. Each of the h number of (-Q^{b}-Si(R²)ₙL₃₋ₙ)s may be bonded to a different ring-forming atom, or two of them may be bonded to one ring-forming carbon atom. Further, there may be two or more ring-forming carbon atoms to which two (-Q^{b}-Si(R²)ₙL₃₋ₙ)s are bonded. Each of i number of R³¹s may be bonded to a different ring-forming atom, or two of them may be bonded to one ring-forming carbon atom. Further, there may be two or more ring-forming carbon atoms to which two R³¹s are bonded.

Above all, from the viewpoint of improving the wear resistance of the surface treatment layer, X³¹ is preferably a carbon atom, a nitrogen atom, a silicon atom, a tetravalent to octavalent organo(poly)siloxane residue, or a group having a (h+i+1)-valent ring, and more preferably a carbon atom.

In Formula (3-1A), Q^{b} is a single bond or a divalent linking group.

The definition of the divalent linking group is the same as the definition described above with respect to Q^{a}.

Above all, Q^{b} is preferably an alkylene group which may have an ether oxygen atom. The number of carbon atoms in the alkylene group is preferably from 1 to 30, more preferably from 1 to 20, still more preferably from 2 to 20, and may be from 2 to 10, from 2 to 6, or from 2 to 5. Examples thereof include 2, 3, 8, 9, and 11. The number of carbon atoms may be from 1 to 10.

In Formula (3-1A), R³¹ is a hydrogen atom, a hydroxy group, or an alkyl group.

The number of carbon atoms in the alkyl group is preferably from 1 to 5, more preferably from 1 to 3, and still more preferably 1.

When X³¹ is a single bond or an alkylene group, h is 1, and i is 0,
when X³¹ is a nitrogen atom, h is an integer from 1 to 2, i is an integer from 0 to 1, and h+i=2 is satisfied,
when X³¹ is a carbon atom or a silicon atom, h is an integer from 1 to 3, i is an integer from 0 to 2, and h+i=3 is satisfied,
When X³¹ is a divalent to octavalent organo(poly)siloxane residue, h is an integer from 1 to 7, i is an integer from 0 to 6, and h+i=1 to 7 is satisfied.

When X³¹ is a group having a (h+i+1)-valent ring, h is an integer from 1 to 7, i is an integer from 0 to 6, and h+i=1 to 7 is satisfied.

When there are two or more (-Q^{b}-Si(R)ₙL₃₋ₙ)s, the two or more (-Q^{b}-Si(R)ₙL₃₋ₙ)s may be identical or different. When there are two or more R³¹s, the two or more (—R³¹)s may be identical or different.

Above all, i is preferably 0 from the viewpoint of improving the wear resistance of the surface treatment layer.

In Formula (3-1B), Q^{c} is a single bond or a divalent linking group.

The definition of the divalent linking group is the same as the definition described above with respect to Q^{a}.

In Formula (3-1B), R³² is a hydrogen atom or an alkyl group having from 1 to 10 carbon atoms, and is preferably a hydrogen atom from the viewpoint that the compound is easily produced.

The alkyl group is preferably a methyl group.

In Formula (3-1B), Q^{d} is a single bond or an alkylene group. The number of carbon atoms in the alkylene group is preferably from 1 to 10, and more preferably from 1 to 6. Q^{d} is preferably a single bond or CH₂— from the viewpoint that the compound is easily produced.

In Formula (3-1B), R³³ is a hydrogen atom or a halogen atom, and is preferably a hydrogen atom from the viewpoint that the compound is easily produced.

y is an integer from 1 to 10, preferably an integer from 1 to 6.

Two or more [CH₂C(R³²)(-Q^{d}-Si(R²)ₙL₃₋ₙ)]s may be identical or different.

The group (3-1A) is preferably groups (3-1A-1) to (3-1A-7).

—(X³²)ₛ₁-Q^{b}-Si(R²)ₙL₃₋ₙ (3-1A-1)

—(X³³)ₛ₂-Q^{a2}-N[-Q^{b2}-Si(R²)ₙL₃₋ₙ]₂ (3-1 A-2)

-Q^{a3}-Si(R^{g})[-Q^{b3}-Si(R²)ₙL₃₋ₙ]₂ (3-1A-3)

-[Q^{c}]ₛ₄-Q^{a4}-(O)ₜ₄—C[—(O)ᵤ₄-Q^{b4}-Si(R²)ₙL₃₋ₙ]_{3-w1}(—R³¹)_{w1} (3-1 A-4)

-Q^{a5}-Si[-Q^{b5}-Si(R²)ₙL₃₋ₙ]₃ (3-1A-5)

-[Q^{c}]ᵥ-Q^{a6}-Z^{a}[-Q^{b6}-Si(R²)ₙL₃₋ₙ]_{w2} (3-1A-6)

-[Q^{c}]ₛ₄-Q^{a4}-(O)ₜ₄—Z^{c}[—(O-Q^{b4})ᵤ₄-Si(R²)ₙL₃₋ₙ]_{w3}(—OH)_{w4} (3-1A-7)

In Formula (3-1A-1) to Formula (3-1A-7), the definitions of R², L, and n are as described above.

Above all, group (3-1A) is preferably a group (3-1A-4).

In group (3-1A-1), X³² is —O—, —S—, —N(R^{d})—, —C(O)—, —C(O)O—, —C(O)S—, —SO₂N(R^{d}), —N(R^{d})SO₂—, —N(R^{d})C(O)—, —N(R^{d})C(O)N(R^{d})—, —OC(O)N(R^{d})—, or —C(O)N(R^{d})—; or any combination of these with a divalent linking group (provided that N in the formula is bonded to QW).

The definition of R^{d} is as described above.

s1 is 0 or 1.

When X³² is a combination of —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})— with a divalent linking group, the divalent linking group is bonded to Si(R³)₂ or Si(R⁴)₂ in Formula (C) or (D) or B¹¹ in Formula (E).

Examples of the divalent linking group include an alkylene group, an organo(poly)siloxane residue, a polyalkylene oxide group, and any combination thereof.

Q^{b1} is a single bond or an alkylene group. The alkylene group may have —O—, a silphenylene backbone group, or a dialkylsilylene group. The alkylene group may have a plurality of groups selected from the group consisting of —O—, a silphenylene backbone group, a divalent organo(poly)siloxane residue, and a dialkylsilylene group.

When the alkylene group has —O—, a silphenylene backbone group, a divalent organo(poly)siloxane residue, or a dialkylsilylene group, it is preferable to have such a group between carbon atoms.

The number of carbon atoms in the alkylene group represented by Q^{b1} is preferably from 1 to 30, more preferably from 1 to 20, still more preferably from 2 to 20, and particularly preferably from 2 to 6. The number of carbon atoms may be from 1 to 10.

In group (3-1A-2), X³³ is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, or any combination of these with a divalent linking group.

The definition of R^{d} is as described above.

s2 is 0 or 1. s2 is preferably 0 from the viewpoint that the compound is easily produced.

When X³³ is a combination of —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})— with a divalent linking group, the divalent linking group is bonded to Si(R3)₂ or Si(R^{a})₂ in Formula (C) or (D) or B¹¹ in Formula (E).

Examples of the divalent linking group include an alkylene group, an organo(poly)siloxane residue, a polyalkylene oxide group, and any combination thereof.

Q^{a2} is a single bond, an alkylene group, —C(O)—, or a group having an ether oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon atoms in an alkylene group having 2 or more carbon atoms.

The number of carbon atoms in the alkylene group represented by Q^{a2} is preferably from 1 to 20, more preferably from 1 to 10, still more preferably from 1 to 6, and particularly preferably from 1 to 3.

The number of carbon atoms in the group having an ether oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon atoms in an alkylene group having 2 or more carbon atoms represented by Q^{a2} is preferably from 2 to 10, more preferably from 2 to 6.

Q^{a2} is preferably a single bond from the viewpoint that the compound is easily produced.

Q^{b2} is an alkylene group or a group having a divalent organo(poly)siloxane residue, an ether oxygen atom, or —NH— between carbon atoms in an alkylene group having 2 or more carbon atoms.

The number of carbon atoms in the alkylene group represented by Q^{b2} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

The number of carbon atoms in the group having a divalent organo(poly)siloxane residue, an ether oxygen atom, or —NH— between carbon atoms in an alkylene group having 2 or more carbon atoms represented by Q^{b2} is preferably from 2 to 10, more preferably from 2 to 6.

From the viewpoint that the compound is easily produced, Q^{b2} is preferably —CH₂CH₂CH₂— or —CH₂CH₂OCH₂CH₂CH₂— (provided that the right side is bonded to Si).

Two [-Q^{b2}-Si(R²)ₙL₃₋ₙ]s may be identical or different.

In group (3-1A-3), Q^{a3} is a single bond or an alkylene group which may have an ether oxygen atom. Q^{a3} is preferably a single bond from the viewpoint that the compound is easily produced.

The number of carbon atoms in the alkylene group which may have an ether oxygen atom is preferably from 1 to 10, and particularly preferably from 2 to 6.

R^{g} is a hydrogen atom, a hydroxy group, or an alkyl group.

R^{g} is preferably a hydrogen atom or an alkyl group from the viewpoint that the compound is easily produced. The number of carbon atoms in the alkyl group is preferably from 1 to 10, more preferably from 1 to 4, and a methyl group is still more preferable.

Q^{b3} is an alkylene group or a group having an ether oxygen atom or a divalent organo(poly)siloxane residue between carbon atoms in an alkylene group having 2 or more carbon atoms.

The number of carbon atoms in the alkylene group represented by Q^{b3} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

The number of carbon atoms in the group having an ether oxygen atom or a divalent organo(poly)siloxane residue between carbon atoms in an alkylene group having 2 or more carbon atoms represented by Q^{b3} is preferably from 2 to 20, more preferably from 2 to 10, still more preferably from 2 to 6.

Q^{b3} is preferably —CH₂CH₂—, —CH₂CH₂CH₂—, or —CH₂CH₂CH₂CH₂CH₂CH₂CH₂CH₂— from the viewpoint that the compound is easily produced.

Two [-Q^{b3}-Si(R²)ₙL₃₋ₙ]s may be identical or different.

In group (3-1A-4), Q^{c} is —C(O)O—, —SO₂N(R^{d})—, —N(R^{d})SO₂—, —N(R^{d})C(O)—, or —C(O)N(R^{d})—; or any combination of these with a divalent linking group.

When Q^{c} is a combination of —C(O)O—, —SO₂N(R^{d})—, —N(R^{d})SO₂—, —N(R^{d})C(O)—, or —C(O)N(R^{d})— with a divalent linking group, the divalent linking group is bonded to Si(R³)₂ or Si(R⁴)₂ in Formula (C) or (D) or B¹¹ in Formula (E).

Examples of the divalent linking group include an alkylene group, an organo(poly)siloxane residue, a polyalkylene oxide group, and any combination thereof.

The definition of R³¹ is as described above. When w1 is 1 or 2, R³¹ is preferably a hydrogen atom.

s4 is 0 or 1.

Q⁴ is a single bond or an alkylene group which may have an ether oxygen atom.

The number of carbon atoms in the alkylene group which may have an ether oxygen atom is preferably from 1 to 20, more preferably from 1 to 10, still more preferably from 1 to 6, and particularly preferably from 1 to 3.

t4 is 0 or 1 (0 when Q^{a4} is a single bond).

From the viewpoint that the compound is easily produced, -Q^{a4}-(O)ₜ₄— is preferably a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂— when s4 is 0, and a single bond, —CH₂—, or —CH₂CH₂— when s4 is 1.

Q^{b4} is an alkylene group, and the alkylene group may have —O—, —C(O)N(R^{d})— (the definition of R^{d} is as described above), a silphenylene backbone group, a divalent organo(poly)siloxane residue, or a dialkylsilylene group.

When the alkylene group has —O— or a silphenylene backbone group, it is preferable to have —O— or a silphenylene backbone group between carbon atoms. When the alkylene group has —C(O)N(R^{d})—, a dialkylsilylene group, or a divalent organo(poly)siloxane residue, it is preferable to have such a group between carbon atoms or at a terminal on the side bonded to (O)ᵤ₄.

The number of carbon atoms in the alkylene group represented by Q¹ is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

u4 is 0 or 1.

From the viewpoint that the compound is easily produced, —(O)ᵤ₄-Q^{b4}- is preferably —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, —CH₂CH₂CH₂Si(CH₃)₂PhSi(CH₃)₂CH₂CH₂— (provided that the right side is bonded to Si).

w1 is an integer from 0 to 2, preferably 0 or 1, and more preferably 0.

When there are two or more [—(O)ᵤ₄-Q^{b4}-Si(R²)ₙL₃₋ₙ]s, the two or more [—(O)ᵤ₄-Q^{b4}-Si(R²)ₙL₃₋ₙ.]s may be identical or different.

When there are two or more R³¹s, the two or more (—R³¹)s may be identical or different.

In group (3-1A-5), Q^{a5} is an alkylene group which may have an ether oxygen atom.

The number of carbon atoms in the alkylene group which may have an ether oxygen atom is preferably from 1 to 10, and particularly preferably from 2 to 6.

From the viewpoint that the compound is easily produced, Q is preferably —OCH₂CH₂CH₂—, —OCH₂CH₂OCH₂CH₂CH₂—, —CH₂CH₂—, or —CH₂CH₂CH₂— (provided that the right side is bonded to Si).

Q^{b5} is an alkylene group or a group having an ether oxygen atom or a divalent organo(poly)siloxane residue between carbon atoms in an alkylene group having 2 or more carbon atoms.

The number of carbon atoms in the alkylene group represented by Q^{b5} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

The number of carbon atoms in the group having an ether oxygen atom or a divalent organo(poly)siloxane residue between carbon atoms in an alkylene group having 2 or more carbon atoms represented by Q^{b5} is preferably from 2 to 20, more preferably from 2 to 10, still more preferably from 2 to 6.

From the viewpoint that the compound is easily produced, Q^{b5} is preferably —CH₂CH₂CH₂— or —CH₂CH₂OCH₂CH₂CH₂— (provided that the right side is bonded to Si(R²)ₙL₃₋ₙ).

Three [-Q^{b5}-Si(R²)ₙL₃₋ₙ]s may be identical or different.

The definition of Q^{c} in group (3-1A-6) is as defined with respect to group (3-1A-4) above.

v is 0 or 1.

Q^{a6} is an alkylene group which may have an ether oxygen atom.

The number of carbon atoms in the alkylene group which may have an ether oxygen atom is preferably from 1 to 10, and particularly preferably from 2 to 6.

From the viewpoint that the compound is easily produced, Q^{a6} is preferably —CH₂OCH₂CH₂CH₂—, —CH₂OCH₂CH₂OCH₂CH₂CH₂—, —CH₂CH₂—, or —CH₂CH₂CH₂— (provided that the right side is bonded to Z^{a}).

Z^{a} is a (w2+1)-valent organo(poly)siloxane residue or a group having a valence of (w2+1) and having an alkylene group between an organo(poly)siloxane residue and an organo(poly)siloxane residue.

w2 is an integer from 2 to 7.

Examples of the (w2+1)-valent organo(poly)siloxane residue and the group having a valence of (w2+1) and having an alkylene group between an organo(poly)siloxane residue and an organo(poly)siloxane residue include the following groups. However, R^{a} in the following formulae is as described above. * indicates a bonding site.

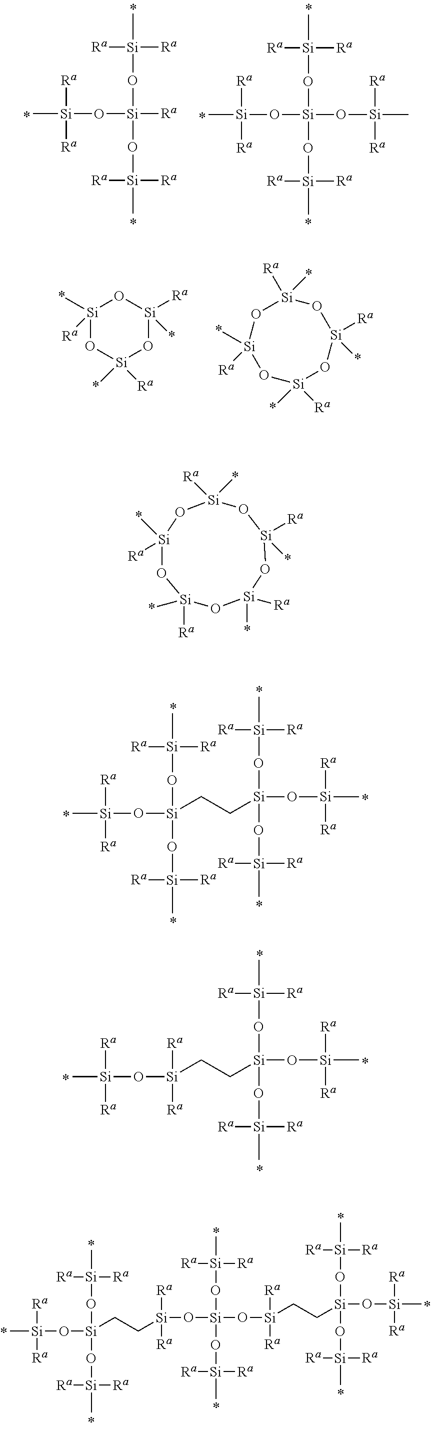

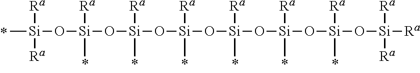

Q^{b6} is an alkylene group or a group having an ether oxygen atom or a divalent organo(poly)siloxane residue between carbon atoms in an alkylene group having 2 or more carbon atoms.

The number of carbon atoms in the alkylene group represented by Q^{b6} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

The number of carbon atoms in the group having an ether oxygen atom or a divalent organo(poly)siloxane residue between carbon atoms in an alkylene group having 2 or more carbon atoms represented by Q^{b6} is preferably from 2 to 20, more preferably from 2 to 10, still more preferably from 2 to 6.

Q^{b6} is preferably —CH₂CH₂— or —CH₂CH₂CH₂— from the viewpoint that the compound is easily produced.

The w2 number of [-Q^{b6}-Si(R²)ₙL₃₋ₙ]s may be identical or different.

In group (3-1A-7), Z^{c} is a (w3+w4+1)-valent hydrocarbon group.

w3 is an integer of 4 or more.

w4 is an integer of 0 or more.

The definitions and preferred ranges of Q^{c}, s4, Q^{a4}, t4, Q^{b4}, and u4 are the same as the definitions of the respective symbols in group (3-1 A-4).

Z^{c} may be formed of a hydrocarbon chain, may have an ether oxygen atom between carbon atoms in a hydrocarbon chain, and is preferably formed of a hydrocarbon chain.

The valence of Z^{c} is preferably from 5 to 20, more preferably from 5 to 10, still more preferably from 5 to 8, and particularly preferably from 5 to 6.

The number of carbon atoms in Z^{c} is preferably from 3 to 50, more preferably from 4 to 40, and still more preferably from 5 to 30.

w3 is preferably from 4 to 20, more preferably from 4 to 16, still more preferably from 4 to 8, and particularly preferably from 4 to 5.

w4 is preferably from 0 to 10, more preferably 0 to 8, still more preferably from 0 to 6, particularly preferably from 0 to 3, and most preferably from 0 to 1.

When there are two or more [—(O-Q^{b4})ᵤ₄-Si(R²)ₙL₃₋ₙ]s, the two or more [—(O-Q^{b4})ᵤ₄-Si(R²)ₙL₃₋ₙ]s may be identical or different.

A in Formula A(Si(R²)ₙL₃₋ₙ)_{q1} may be groups (g2-1) to (g2-7).

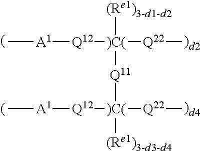

(-A¹-Q¹²-)ₑ₁C(R^{e2})₄₋ₑ₁₋ₑ₂(-Q²²-)ₑ₂ (g2-2)

-A¹-Q¹³-N(-Q²³-)₂ (g2-3)

(-A¹-Q¹⁴-)ₕ₁Z⁴(-Q²⁴-)ₕ₂ (g2-4)

(-A¹-Q¹⁵-)ᵢ₁Si(R^{e3})₄₋ᵢ₁₋ᵢ₂(-Q²⁵-)ᵢ₂ (g2-5)

-A¹-Q²⁶- (g2-6)

-A¹-Q¹²-CH(-Q²²-)—Si(R^{e3})₃₋ᵢ₃(-Q²⁵-)ᵢ₃ (g2-7)

However, in Formulae (g2-1) to (g2-7), the A¹ side is bonded to Si(R³)₂ or Si(R⁴)₂, and the Q²², Q²³, Q²⁴, Q²⁵, or Q²⁶ side is bonded to [—Si(R²)ₙL₃₋ₙ].

A¹ is a single bond, —C(O)NR⁶—, —C(O)—, —OC(O)O—, —NHC(O)O—, —NHC(O)NR⁶—, —O—, or SO₂NR⁶—.

Q¹¹ is a single bond, —O—, an alkylene group, or a group having —C(O)NR⁶—, —C(O)—, —NR⁶—, or O— between carbon atoms in an alkylene group having 2 or more carbon atoms.

Q¹² is a single bond, an alkylene group, or a group having —C(O)NR⁶—, —C(O)—, —NR⁶—, or O— between carbon atoms in an alkylene group having 2 or more carbon atoms, and when A has 2 or more Q¹²s, the 2 or more Q¹²s may be identical or different.

Q¹³ is a single bond (provided that A¹ is —C(O)—), an alkylene group, a group having —C(O)NR⁶—, —C(O)—, —NR⁶—, or O— between carbon atoms in an alkylene group having 2 or more carbon atoms, or a group having —C(O)— at the N-side terminal of an alkylene group.

Q¹⁴ is Q¹² when the atom in Z⁴ to which Q¹⁴ is bonded is a carbon atom, is Q¹³ when the atom in Z⁴ to which Q¹⁴ is bonded is a nitrogen atom, and when A has 2 or more of Q¹⁴s, the 2 or more Q¹⁴s may be identical or different.

Q¹⁵ is an alkylene group, or a group having —C(O)NR⁶—, —C(O)—, —NR⁶—, or O— between carbon atoms in an alkylene group having 2 or more carbon atoms, and when A has 2 or more Q¹⁵s, the 2 or more Q¹⁵s may be identical or different.

Q² is an alkylene group, a group having —C(O)NR⁶—, —C(O)—, —NR⁶—, or O— between carbon atoms in an alkylene group having 2 or more carbon atoms, a group having —C(O)NR⁶—, —C(O)—, —NR⁶—, or O— at a terminal of the alkylene group on the side not connected to Si, or a group having —C(O)NR⁶—, —C(O)—, —NR⁶—, or O— between carbon atoms in an alkylene group having 2 or more carbon atoms and having —C(O)NR⁶—, —C(O)—, —NR⁶—, or O— at a terminal on the side not connected to Si, and when A has 2 or more Q⁴s, the 2 or more Q²²s may be identical or different.

Q²³ is an alkylene group, or a group having —C(O)NR⁶—, —C(O)—, —NR⁶—, or O— between carbon atoms in an alkylene group having 2 or more carbon atoms, and two Q²'s may be identical or different.

Q²⁴ is Q²² when the atom in Z⁴ to which Q²⁴ is bonded is a carbon atom, is Q²³ when the atom in Z⁴ to which Q²⁴ is bonded is a nitrogen atom, and when A has 2 or more of Q²⁴s, the 2 or more of Q²⁴s may be identical or different.

Q²⁵ is an alkylene group, or a group having —C(O)NR⁶—, —C(O)—, —NR⁶—, or O— between carbon atoms in an alkylene group having 2 or more carbon atoms, and when A has 2 or more Q²⁵s, the 2 or more Q²⁵s may be identical or different.

Q²⁶ is an alkylene group, or a group having —C(O)NR⁶—, —C(O)—, —NR⁶—, or O— between carbon atoms in an alkylene group having 2 or more carbon atoms.

When Q²², Q²³, Q²⁴, Q²⁵, or Q²⁶ is an alkylene group, the number of carbon atoms is preferably from 1 to 20, more preferably from 1 to 10, and still more preferably from 1 to 6.

Z⁴ is a group having a (h1+h2)-valent ring structure having a carbon atom or a nitrogen atom to which Q¹⁴ is directly bonded and having a carbon atom or a nitrogen atom to which Q²⁴ is directly bonded.

R^{c1} is a hydrogen atom or an alkyl group, and when A has 2 or more R^{e1}s, the 2 or more R^{c1}s may be identical or different.

R^{c2} is a hydrogen atom, a hydroxy group, an alkyl group, or an acyloxy group.

R^{c3} is an alkyl group. R⁶ is a hydrogen atom, an alkyl group having from 1 to 6 carbon atoms, or a phenyl group.

d1 is an integer from 0 to 3, and is preferably 1 or 2.

d2 is an integer from 0 to 3, and is preferably 1 or 2.

d1+d2 is an integer from 1 to 3.

d3 is an integer from 0 to 3, and is preferably 0 or 1.

d4 is an integer from 0 to 3, and is preferably 2 or 3.

d3+d4 is an integer from 1 to 3.

d1+d3 is an integer from 1 to 5, and is preferably 1 or 2.

d2+d4 is an integer from 1 to 5, and is preferably 4 or 5.

e1+e2 is 3 or 4.

e1 is an integer from 1 to 3, and is preferably 1 or 2.

e2 is an integer from 1 to 3, and is preferably 2 or 3.

h1 is an integer of 1 or more, and is preferably 1 or 2.

h2 is an integer of 1 or more, and is preferably 2 or 3.

i1+i2 is 3 or 4.

i1 is an integer from 1 to 3, and is preferably 1 or 2.

i2 is an integer from 1 to 3, and is preferably 2 or 3.

i3 is 2 or 3.

The number of carbon atoms in the alkylene group of Q¹¹, Q¹², Q¹³, Q¹⁴, Q¹⁵, Q²², Q²³, Q²⁴, Q²⁵, and Q²⁶ is preferably from 1 to 30, more preferably from 1 to 20, still more preferably from 2 to 20, and may be from 2 to 10, or from 2 to 6 from the viewpoint that the compound is easily produced and the surface treatment layer has more excellent wear resistance. Examples thereof include 2, 3, 8, 9, and 11. The number of carbon atoms may be from 1 to 10, or from 1 to 6, or from 1 to 4. However, the lower limit value of the number of carbon atoms in the alkylene group in the case of having a specific bond between carbon atoms is 2.

Examples of the ring structure in Z⁴ include the ring structures described above, and preferred forms are also the same. Since Q¹⁴ and Q²⁴ are directly bonded to the ring structure in Z⁴, it does not occur, for example, that an alkylene group is linked to the ring structure and Q¹⁴ and Q²⁴ are linked to the alkylene group.

The number of carbon atoms in the alkyl group of R^{e1}, R^{e2}, or R^{e3} is preferably from 1 to 6, more preferably from 1 to 3, and particularly preferably from 1 to 2 from the viewpoint that the compound is easily produced.

The number of carbon atoms in the alkyl group moiety of the acyloxy group of R^{e2} is preferably from 1 to 6, more preferably from 1 to 3, and particularly preferably from 1 to 2 from the viewpoint that the compound is easily produced.

h1 is preferably from 1 to 6, more preferably from 1 to 4, still more preferably 1 or 2, and particularly preferably 1 from the viewpoint that the compound is easily produced and the surface treatment layer has more excellent wear resistance.

h2 is preferably from 2 to 6, more preferably from 2 to 4, and particularly preferably 2 or 3 from the viewpoint that the compound is easily produced and the surface treatment layer has more excellent wear resistance.

Other forms of A in Formula A(Si(R²)ₙL₃₋ₙ)_{q1} include groups (g2-8) to (g2-14).

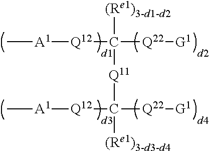

(-A¹-Q¹²-)ₑ₁C(R^{e2})₄₋ₑ₁₋ₑ₂(-Q²²-G¹)ₑ₂ (g2-9)

-A¹-Q¹³-N(-Q²³-G¹)₂ (g2-10)

(-A¹-Q¹⁴-)ₕ₁Z⁴(-Q²⁴-G¹)ₕ₂ (g2-11)

(-A¹-Q¹⁵-)ᵢ₁Si(R^{e3})₄₋ᵢ₁₋ᵢ₂(-Q²⁵-G¹)ᵢ₂ (g2-12)

-A¹-Q²⁶-G¹ (g2-13)

-A¹-Q¹²-CH(-Q²²-G¹)-Si(R^{e3})₃₋ᵢ₃(-Q²⁵-G¹)ᵢ₃ (g2-14)

However, in Formulae (g2-8) to (g2-14), the A¹ side is bonded to Si(R³)₂ or Si(R⁴)₂, and the G¹ side is bonded to [—Si(R²)ₙL₃₋ₙ].

G¹ is the following group (g3), and 2 or more G's included in A may be identical or different. The symbols other than G¹ are the same as the symbols in Formulae (g2-1) to (g2-7).

—Si(R¹³)₃₋ₖ₃(-Q³-)ₖ₃ (g3)

However, in group (g3), the S1 side is connected to Q²², Q²³, Q²⁴, Q²⁵, and Q²⁶, and the Q³ side is connected to [—Si(R²)ₙL₃₋ₙ]. R¹³ is an alkyl group. Q³ is an alkylene group, a group having —C(O)NR⁶—, —C(O)—, —NR⁶—, or —O— between carbon atoms in an alkylene group having 2 or more carbon atoms, or (OSi(R⁹)₂)ₚ—O—, and 2 or more Q³s may be identical or different. k3 is 2 or 3. R⁶ is a hydrogen atom, an alkyl group having from 1 to 6 carbon atoms, or a phenyl group. R⁹ is an alkyl group, a phenyl group, or an alkoxy group, and two R⁹s may be identical or different. p is an integer from 0 to 5, and when p is 2 or more, the 2 or more (OSi(R⁹)₂)s may be identical or different.

The number of carbon atoms in the alkylene group of Q³ is preferably from 1 to 30, more preferably from 1 to 20, still more preferably from 2 to 20, and may be from 2 to 10, or from 2 to 6 from the viewpoint that the compound is easily produced and the surface treatment layer has more excellent wear resistance. Examples thereof include 2, 3, 8, 9, and 11. The number of carbon atoms may be from 1 to 10, or from 1 to 6, or from 1 to 4. However, the lower limit value of the number of carbon atoms in the alkylene group in the case of having a specific bond between carbon atoms is 2.

The number of carbon atoms in the alkyl group of R¹³ is preferably from 1 to 6, more preferably from 1 to 3, and still more preferably from 1 to 2 from the viewpoint that the compound is easily produced.

The number of carbon atoms in the alkyl group of R⁹ is preferably from 1 to 6, more preferably from 1 to 3, and still more preferably from 1 to 2 from the viewpoint that the compound is easily produced.

The number of carbon atoms in the alkoxy group of R⁹ is preferably from 1 to 6, more preferably from 1 to 3, and particularly preferably from 1 to 2 from the viewpoint that the compound has excellent storage stability.

p is preferably 0 or 1.

### [Examples of One-Terminal Compound and Both-Terminal Compound]

Hereinafter, specific examples of the one-terminal compound and the both-terminal compound will be described in detail.

Specific examples of the one-terminal compound include the following compounds (1) to (3), (4A), and (5).

Specific examples of the both-terminal compound include the following compound (4B).

### Compound (1)

A compound containing the following group 1a, a chain organo(poly)siloxane residue, a partial structure that is an alkylene chain or a polyalkylene oxide chain having 3 or more carbon atoms, and the following group 1b.
Group 1a: -M¹T¹₃
Group 1b: —Si(R²)ₙL₃₋ₙ
M¹ is Si, Sn, or Ge,
each T is independently a hydrocarbon group or a trialkylsilyloxy group,
each R² is independently a monovalent hydrocarbon group,
each L is independently a hydrolyzable group, a group having a hydrolyzable group, or a hydroxy group, and
each n is independently an integer from 0 to 2.
R², L, and n are the same as R², L, and n in Formula (S1).

Details of the group 1a are the same as the details of T¹₃M¹- in the description of T¹¹ in Formula (C).

### Compound (2)

A compound containing an alkyl group having 2 or more carbon atoms, a chain organo(poly)siloxane residue, and a reactive silyl group.

### Compound (3)

A compound containing the following group 3a, a partial structure containing a divalent chain organo(poly)siloxane residue, and the following group 3b, in which the partial structure is a divalent chain organo(poly)siloxane residue, or is a combination of a divalent chain organo(poly)siloxane residue and at least one of an alkylene chain or a polyalkylene oxide chain.
Group 3a: a monovalent cyclic polysiloxane residue or a monovalent cage-like polysiloxane residue
Group 3b: —Si(R²)ₙL₃₋ₙ
Each R² is independently a monovalent hydrocarbon group,
each L is independently a hydrolyzable group, a group having a hydrolyzable group, or a hydroxy group, and
each n is independently an integer from 0 to 2.

R², L, and n are the same as R², L, and n in Formula (S1).

### Compounds (4A) and (4B)

Compound represented by Formula (4A) or (4B)

(R^{T1}—R^{S}—(—SiR^{T2}₂-)_{q4})_{α}—X^{A}—R^{H}_{β} (4A)

R^{H}_{γ}—X^{A}—Oₚ₄—R^{S}—(—SiR^{T2}₂—)_{q4}—X^{A}—R^{H}_{γ} (4B3)

In Formulae (4A) and (4B),
each R^{S} is independently a divalent linear organosiloxane group,
each R^{T1} is independently a hydrocarbon group,
each R^{T2} is independently a hydrocarbon group,
p4 is 0 or 1,
each q4 is independently 0 or 1,
R^{H} is a group represented by any of Formulae (W1) to (W4),
in the R^{H}, there are two or more Si atoms to which a hydroxy group or a hydrolyzable group is bonded.
each X^{A} is independently a single bond or a group represented by Formula (W5),
α is an integer from 1 to 9,
β is an integer from 1 to 9,
each γ is independently an integer from 1 to 9.

—(CH₂CR¹⁰(R¹⁵)X¹¹—Si(R²)ₙ₈₁L₃₋ₙ₈₁)ₜ-R¹⁴ (W1)

-SiR^{a1}ₖ₈₁Lₗ₈₁R^{c1}ₘ₈₁ (W2)

—CR^{d1}ₖ₈₂R^{e1}ₗ₈₂R^{f1}ₘ₈₂ (W3)

—NR^{g1}R^{h1} (W4)

In Formulae (W1) to (W4),
each L is independently a hydrolyzable group, a group having a hydrolyzable group, or a hydroxy group,
each R² is independently a monovalent hydrocarbon group,
each n⁸¹ is independently an integer from 0 to 3 for each (SiR²ₙ₈₁L₃₋ₙ₈₁) unit,
each X¹¹ is independently a single bond or a divalent organic group,
each R¹⁰ is independently a hydrogen atom or a monovalent organic group,
each t is independently an integer of 2 or more,
each R¹⁴ is independently a hydrogen atom, a halogen atom, or —X¹¹—Si(R²)ₙ₈₁L₃₋ₙ₈₁,
each R¹⁵ is independently a single bond, an oxygen atom, an alkylene group having from 1 to 6 carbon atoms, or an alkyleneoxy group having from 1 to 6 carbon atoms,
each R^{a1} is independently —Z⁸¹—SiR²¹ₚ₈₁L_{q81}R²³ᵣ₈₁,
each Z⁸¹ is independently a divalent organic group,
each R²¹ is independently —Z^{1′}—SiR^{21′}_{p1′}L_{q1′}R^{23′}_{r1′},
each R²³ is independently a monovalent organic group,
each p81 is independently an integer from 0 to 3,
each q81 is independently an integer from 0 to 3,
each r81 is independently an integer from 0 to 3,
p81+q81+r81 is 3,
each (Z^{1′}) is independently a divalent organic group,
each (R^{21′}) is independently —Z^{1″}-SiL_{q1″}R^{23″}_{r1″},
each (R^{23′}) is independently a monovalent organic group,
each (p1′) is independently an integer from 0 to 3,
each (q1′) is independently an integer from 0 to 3,
each (r1′) is independently an integer from 0 to 3,
p1′+q1′+r1′ is 3,
each (Z^{1″}) is independently a divalent organic group,
each (R^{23″}) is independently a monovalent organic group,
each (q1″) is independently an integer from 0 to 3,
each (r1″) is independently an integer from 0 to 3,
q1″+r1″ is 3,
each R^{c1} is independently a monovalent organic group,
each k81 is independently an integer from 0 to 3,
each l81 is independently an integer from 0 to 3,
each m81 is independently an integer from 0 to 3,
k81+l81+m81 is 3,
each R^{d1} is independently —Z⁸²—CR⁷¹ₚ₈₂R⁷²_{q82}R⁷³ᵣ₈₂,
each Z⁸² is independently a single bond, an oxygen atom, or a divalent organic group,
each R⁷¹ is independently —Z^{2′}—CR^{32′}_{q2′}R^{33′}_{r2′},
each R⁷² is independently —Z⁸³—SiLₙ₈₂R³⁵₃₋ₙ₈₂,
each R⁷³ is independently a hydrogen atom, a hydroxy group, or a monovalent organic group,
each p82 is independently an integer from 0 to 3,
each q82 is independently an integer from 0 to 3,
each r82 is independently an integer from 0 to 3,
p82+q82+r82 is 3,
each (Z^{2′}) is independently a single bond, an oxygen atom, or a divalent organic group,
each (R^{32′}) is independently —Z⁸³—SiLₙ₈₂R³⁵₃₋ₙ₈₂,
each (R^{33′}) is independently a hydrogen atom, a hydroxy group, or a monovalent organic group,
each (q2′) is independently an integer from 0 to 3,
each (r2′) is independently an integer from 0 to 3,
q2′+r2′ is 3,
each Z⁸³ is independently a single bond, an oxygen atom, or a divalent organic group,
each R³⁵ is independently a monovalent organic group,
each n82 is independently an integer from 0 to 3,
each R^{e1} is independently —Z⁸³—SiLₙ₈₂R³⁵₃₋ₙ₈₂,
each R^{f1} is independently a hydrogen atom, a hydroxy group, or a monovalent organic group,
each k82 is independently an integer from 0 to 3,
each 182 is independently an integer from 0 to 3, and
each m82 is independently an integer from 0 to 3,
k82+l82+m82 is 3,
each of R^{g1} and R^{h1} is independently —Z⁸⁴—SiLₙ₈₁R²₃₋ₙ₈₁, —Z⁸⁴—SiR^{a1}ₖ₈₁Lₗ₈₁R^{c1}ₘ₈₁, or —Z⁸⁴—CR^{d1}ₖ₈₂R^{c1}ₗ₈₂R^{f1}ₘ₈₂, and
each Z⁸⁴ is independently a single bond, an oxygen atom, or a divalent organic group,
provided that in Formulae (W1), (W2), (W3), and (W4), there are at least two Si atoms to which a hydrolyzable group, a group having a hydrolyzable group, or a hydroxy group is bonded.
R² and L are the same as R² and L in Formula (S1).

—(R⁵⁰)ₚ₅—(X⁵¹)_{q5}— (W5)

In Formula (W5),
R⁵⁰ is a single bond, —(CH₂)ₗ₅—, or an o-, m-, or p-phenylene group,
s5 is an integer from 1 to 20.
X⁵¹ is —(X⁵²)ₗ₅—.
each X⁵² is, at each occurrence, independently a group selected from the group consisting of —O—, —S—, an o-, m-, or p-phenylene group, —CO—, —C(O)O—, —CONR¹⁴—, —O—CONR³⁴—. —NR⁵⁴—, and —(CH₂)ₙ₅—,
each R⁵⁴ is, at each occurrence, independently a hydrogen atom or a monovalent organic group,
each n5 is, at each occurrence, independently an integer from 1 to 20,
15 is an integer from 1 to 10,
p5 is 0 or 1,
q5 is 0 or 1, and
at least one of p5 or q5 is 1, and the order of occurrence of (R⁵⁰)ₚ₅ and (X⁵¹)_{q5} is arbitrary.

It is preferable that each X^{A} is independently a single bond, an alkylene group having from 1 to 20 carbon atoms, —(CH₂)ₛ₅—X⁵³—, —X⁵³—(CH₂)ₜ₅—, or —(CH₂)ₛ₅—X⁵³—(CH₂)ₜ₅—.

It is preferable that X⁵³ is a single bond, —O—, —CO—, —CONR⁵⁴—, —O—CONR⁵⁴—, —O—(CH₂)ᵤ₅—CONR⁵⁴—, or —O—(CH₂)ᵤ₅—CO—,
each R⁵⁴ is, at each occurrence, independently a hydrogen atom, a phenyl group, an alkyl group having from 1 to 6 carbon atoms, or an oxyalkylene-containing group having from 1 to 10 carbon atoms,
s5 is an integer from 1 to 20,
t5 is an integer from 1 to 20, and
u5 is an integer from 1 to 20.

### Compound (5)

A compound represented by Formula (5).

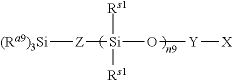

In Formula (5),
Y represents a single bond or *—Si(R^{s2})₂-L^{s1}-. * represents a bond to an oxygen atom.

Z represents an oxygen atom or a divalent hydrocarbon group having from 1 to 10 carbon atoms.

Each R^{a9} independently represents a hydrocarbon group or a trialkylsilyloxy group. However, when all of R^{a9}s are hydrocarbon groups, the hydrocarbon group represented by R^{a9} is an alkyl group.

Each of R^{s1} and R^{s2} independently represents an alkyl group having from 1 to 10 carbon atoms.

L^{s1} represents a divalent hydrocarbon group having from 1 to 10 carbon atoms.

X represents a group represented by any of Formulae (X-1) to (X-3).

n9 represents a number from 1 to 150.

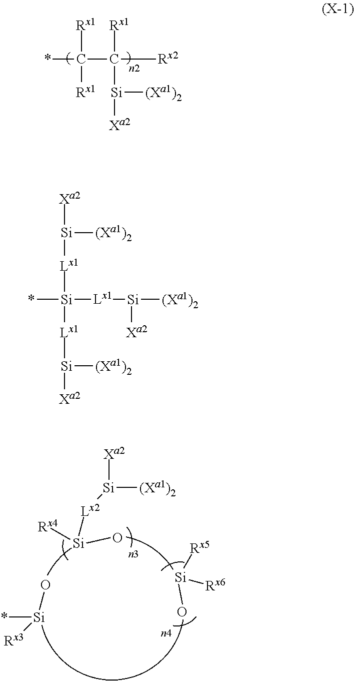

In Formulae (X-1) to (X-3),
each of L^{x1} and L^{x2} independently represents a divalent hydrocarbon group having from 1 to 20 carbon atoms, and the methylene group (—CH₂—) contained in the divalent hydrocarbon group may be replaced with —O— or —O—Si(R^{x7})₂—.

Each of R^{x1} to R^{x7} independently represents a hydrogen atom or a hydrocarbon group having from 1 to 10 carbon atoms.

Each X^{a1} is independently a hydrolyzable group, a group having a hydrolyzable group, or a trialkoxysilyloxy group.

Each X^{a2} independently represents a trialkylsilyl-containing group, a hydrocarbon chain-containing group, a siloxane backbone-containing group, a hydrolyzable group, a group having a hydrolyzable group, or a trialkoxysilyloxy group, and when X^{a2} is a hydrolyzable group, X^{a2} and X^{a1} may be identical or different.

n2 represents an integer from 1 to 50.

n3 represents a number from 2 to 5.

n4 represents a number from 0 to 5.

In Formula (X-3), the order of units represented by (Si(R^{x4})(-L^{x2}-Si(X^{a2})(X^{a1})₂)—O—) and (Si(R^{x5})(R^{x6})—O—) is arbitrary.

Hereinafter, the compounds (1) to (5) will be described.

### (Compound (1))

The compound (1) is preferably a compound represented by Formula (1A).

[T¹₃M¹-(O)ᵣ—Z¹]ₚ₁A(Si(R²)ₙL₃₋ₙ)_{q1} (1A)

In Formula (1A),
M¹ is Si, Sn, or Ge,
each T¹ is independently a hydrocarbon group or a trialkylsilyloxy group,
r is 0 or 1,
each Z¹ is independently an alkylene chain or a polyalkylene oxide chain, or a combination of an alkylene chain and a divalent chain organo(poly)siloxane residue, and A is a single bond or a (p1+q1)-valent linking group,
each R² is independently a monovalent hydrocarbon group,
each L is independently a hydrolyzable group, a group having a hydrolyzable group, or a hydroxy group,
each n is independently an integer from 0 to 2, and
each of p1 and q1 is independently an integer of 1 or more.

However, when each Z¹ is independently an alkylene chain or a polyalkylene oxide chain, A is a (p1+q1)-valent linking group containing a chain organo(poly)siloxane residue.

T¹ and M¹ are the same as T¹ and M¹ in the group 1a, and thus description thereof is omitted.

M¹ is preferably Si.

T¹ is preferably a trialkylsilyloxy group, and more preferably a butyldimethylsilyloxy group, a trimethylsilyloxy group, or a triethylsilyloxy group.

R², L, and n are the same as R², L, and n in Formula (S1).

The combination of an alkylene chain and a divalent chain organo(poly)siloxane residue represented by Z¹ is preferably represented by Formula (D3), (D4), or (D5).

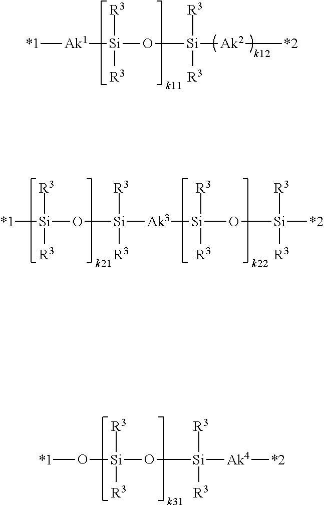

In Formula (D3), each of Ak and Ak² independently means an alkylene chain. R³ is the same as R³ in Formula (B1). k1 is a number of 1 or more. k12 is 0 or 1.

In Formula (D4), Ak³ means an alkylene chain. R³ is the same as R³ in Formula (B1). Each of k21 and k22 is independently a number of 1 or more.

In Formula (D5), Ak⁴ means an alkylene chain. R³ is the same as R³ in Formula (B1). k31 is a number of 1 or more.

In Formula (D3), (D4), or (D5), *1 is linked to group 1a side, and *2 is linked to group 1b side.

A need only be a group that does not impair the effects of the disclosure, and examples thereof include an alkylene group which may have an ether oxygen atom or a divalent chain organo (poly) siloxane residue, a carbon atom, a nitrogen atom, a silicon atom, a divalent to octavalent organopolysiloxane residue, and groups obtained by removing Si(R²)ₙL₃₋ₙ from Formula (3-1A), Formula (3-1B), and Formulae (3-1A-1) to (3-1A-7).

A may include a triptycene structure. The triptycene structure refers to a partial structure obtained by removing two or more hydrogen atoms from triptycene.

A may be group (g2-1) to group (g2-14).

p1 is an integer of 1 or more. From the viewpoint that the surface treatment layer has more excellent water repellency, p1 is preferably from 1 to 6, and more preferably from 2 to 4. p1 may be 1.

When p1 is 2 or more, a plurality of [T¹₃M¹-(O)ᵣ—Z¹]s may be identical or different from each other.

q1 is an integer of 1 or more. From the viewpoint that the surface treatment layer has more excellent wear resistance, q1 is preferably from 1 to 15, more preferably from 1 to 6, still more preferably from 2 to 6, particularly preferably from 2 to 4, and extremely preferably 2 or 3. q1 may be 1.

When q1 is 2 or more, a plurality of [Si(R²)ₙL₃₋ₙ]s may be identical or different from each other.

A preferred aspect of group A(Si(R²)ₙL₃₋ₙ)_{q1} in Formula (1A) is the same as the preferred aspect of group A(Si(R²)ₙL₃₋ₙ)_{q1} in the section “Partial Structures of One-Terminal Compound, Both-Terminal Compound, and Compound (E)” described above. However, A in group A(Si(R²)ₙL₃₋ₙ)_{q1} is linked to [T¹₃M¹⁻(O)ᵣ—Z¹]ₚ₁ in Formula (1A). When the terminal of Z¹ on the side bonded to A is an alkylene chain, the terminal of A on the side bonded to Z¹ is not an alkylene chain. When the terminal of Z¹ on the side bonded to A is a polyalkylene oxide chain, the terminal of A on the side bonded to Z¹ is not a polyalkylene oxide chain.

The compound (1) is preferably a compound represented by Formula (1B).

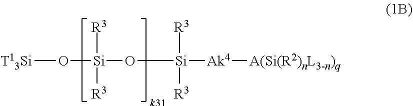

In Formula (1B), T¹ is the same as T¹ in group 1a.

R³ is the same as R³ in Formula (B1). k31 is the same as k31 in Formula (D5). Group represented by A(Si(R²)ₙL₃₋ₙ)_{q1} is the same as the group represented by A(Si(R²)ₙL₃₋ₙ)_{q1} in Formula (1A).

Ak⁴ is the same as Ak⁴ in Formula (D5).

The compound (1) is preferably a compound represented by Formula (1C), Formula (1D), or Formula (1E).

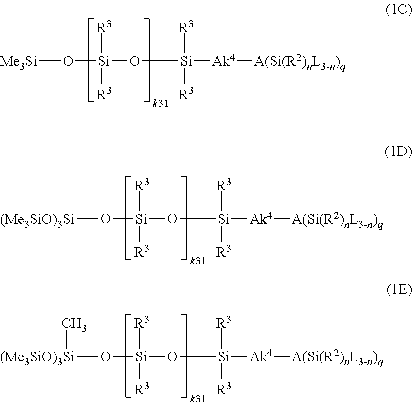

In Formula (1C), Formula (1D), and Formula (1E), R³ is the same as R³ in Formula (B1). k31 is the same as k31 in Formula (D5).

The group represented by A(Si(R²)ₙL₃₋ₙ)_{q1} is the same as the group represented by A(Si(R²)ₙL₃₋ₙ)_{q1} in Formula (1A).

Ak⁴ is the same as Ak⁴ in Formula (D5).

Specific examples of the compound (1) include the following compounds.

In the following formulae, n10 is a number of 1 or more, n10 is preferably a number from 1 to 60, and may be a number from 3 to 50, a number from 5 to 30, or a number from 7 to 25.

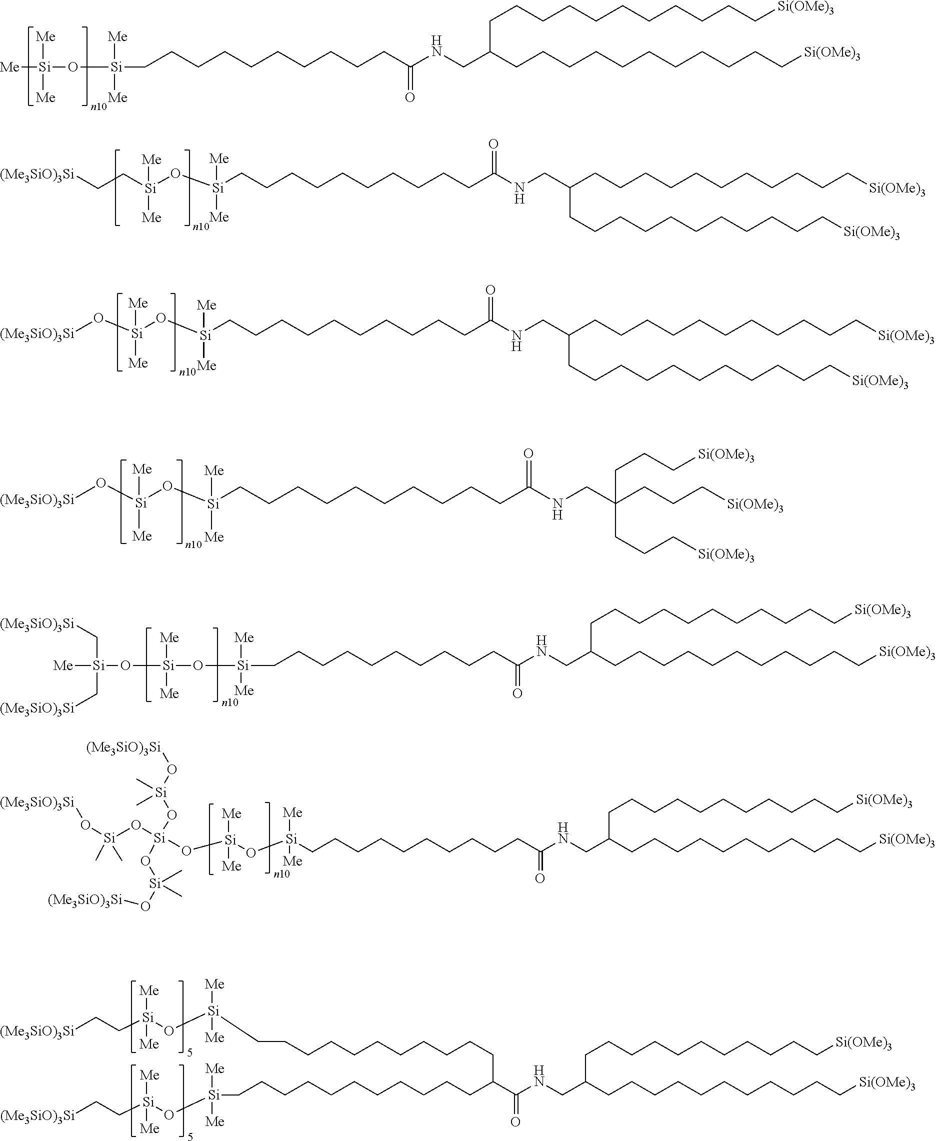

In the following formulae, k is preferably from 1 to 80, more preferably from 3 to 50, and still more preferably from 3 to 30. m is preferably from 1 to 30, more preferably from 3 to 20, and still more preferably from 3 to 10. t is preferably from 1 to 30, more preferably from 3 to 20, and still more preferably from 3 to 10.

In the following formulae, n10 is a number of 1 or more, n10 is preferably a number from 1 to 60, and may be a number from 3 to 50, a number from 5 to 30, or a number from 7 to 25.

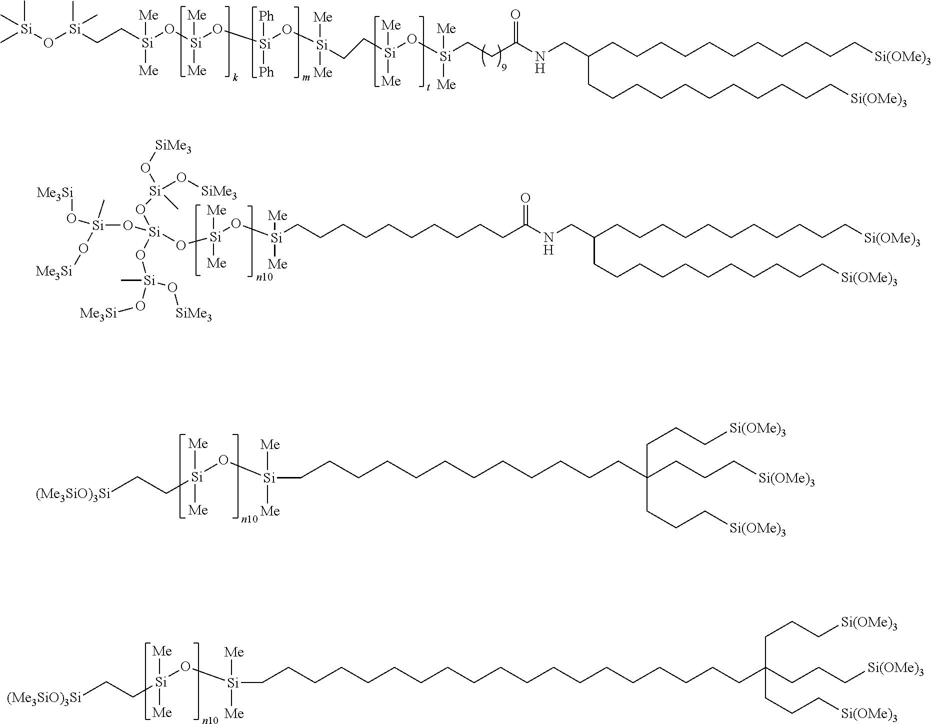

In the following formulae, n1 is a number of 1 or more, num is preferably a number from 1 to 60, and may be a number from 3 to 50, a number from 5 to 30, or a number from 7 to 25.

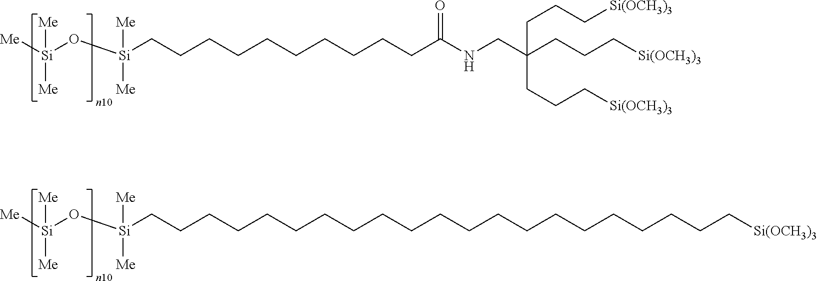

### (Compound (2))

In the compound (2), the alkyl group means an unsubstituted alkyl group. The alkyl group may, be any of a linear alkyl group, a branched alkyl group, and a cyclic alkyl group, but is preferably a linear alkyl group or a branched alkyl group. The number of carbon atoms in the alkyl group is preferably from 2 to 30, more preferably from 3 to 28, and still more preferably from 4 to 22.

The compound may contain only one alkyl group or may contain two or more alkyl groups.

The alkyl group is a monovalent group, and therefore is located at the terminal of the compound.

The compound (2) is preferably a compound represented by Formula (2A).

(T²-Z²)ₚ₁A(Si(R²)ₙL₃₋ₙ)_{q1} (2A)

In Formula (2A),
T² is an alkyl group having 2 or more carbon atoms.
Z² is a divalent chain organo(poly)siloxane residue,
A is a single bond or a (p1+q1)-valent linking group,
each R² is independently a monovalent hydrocarbon group,
each L is independently a hydrolyzable group, a group having a hydrolyzable group, or a hydroxy group,
n is an integer from 0 to 2, and
each of p1 and q1 is independently an integer of 1 or more.

A preferred aspect of the alkyl group having 2 or more carbon atoms represented by T² is as described above.

The divalent chain organo(poly)siloxane residue represented by Z² is preferably a group represented by Formula (B1).

R², L, and n are the same as R², L, and n in Formula (S1).

The group represented by A(Si(R²)ₙL₃₋ₙ)_{q1} is the same as the group represented by A(Si(R²)ₙL₃₋ₙ)_{q1} in Formula (1A) except for the following contents.

p1 and q1 are the same as p1 and q1 in Formula (1A).

The group represented by A(Si(R²)ₙL₃₋ₙ)_{q1} is preferably a group (3-1A) or a group (3-1B), and more preferably a group (3-1A).

In Formula (3-1A), Q^{a} is a single bond or a divalent linking group.

However, the terminal of Q^{a} on the side bonded to Z² is not an oxysilyl group.

In Formula (3-4A), X³¹ is a single bond, an alkylene group, a carbon atom, a nitrogen atom, a silicon atom, a divalent to octavalent organopolysiloxane residue, or a group having a (h+i+1)-valent ring.

However, when Q^{a} is a single bond, the terminal of X³¹ on the side bonded to Z² is not an oxysilyl group. In cases other than the above, the terminal of X³¹ may be an oxysilyl group.

In Formula (3-A), Q^{b} is a single bond or a divalent linking group.

However, when Q^{a} and X³¹ are each a single bond, the terminal of Q^{b} on the side bonded to Z² is not an oxysilyl group. In cases other than the above, the terminal of Q^{b} may be an oxysilyl group.

When h is 1 and Q^{b} is an alkylene group, the Q^{b}-side terminal of Q^{a}-X³¹ is not an alkylene group.

In Formula (3-1B), Q^{c} is a single bond or a divalent linking group.

However, the terminal of QC on the side bonded to Z² is not an oxysilyl group.

Group (3-1A) is preferably groups (3-1A-1) to (3-1A-7).

However, the terminal of each of groups (3-1A-1) to (3-1A-7) on the side bonded to Z² is not an oxysilyl group.

In group (3-1A-1), X³² is preferably —O—, —S—, —N(R^{d})—, —C(O)O—, —C(O)S—, —N(R^{d})C(O)N(R^{d})—, —OC(O)N(R^{d})—, or —C(O)N(R^{d})—, and more preferably —C(O)O— or —C(O)N(R^{d})—.

s1 is preferably 0, and Q^{b1} is preferably an alkylene group having from 2 to 6 carbon atoms.

In group (3-1A-2), X³³ is preferably —O—, —C(O)O—, or —C(O)N(R^{d})—.

A in Formula (2A) may be groups (g2-1) to (g2-7).

However, in Formulae (g2-1) to (g2-7), the A¹ side is bonded to Z², and the Q²², Q²³, Q²⁴, Q²⁵, or Q²⁶ side is bonded to [—Si(R²)ₙL₃₋ₙ].

Other forms of A include groups (g2-8) to (g2-14).

However, in Formulae (g2-8) to (g2-14), the A¹ side is bonded to Z², and the G¹ side is bonded to [—Si(R²)ₙL₃₋ₙ].

The compound (2) is preferably a compound represented by Formula (2B).

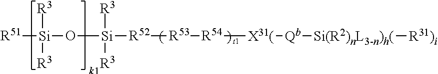

In Formula (2B), R⁵¹ is an alkyl group having 2 or more carbon atoms.

Each of R⁵² and R⁵⁴ is independently an alkylene group.

R⁵³ is —C(O)O—, —SO₂N(R^{d})—, —N(R^{d})SO₂—, —N(R^{d})C(O)—, or —C(O)N(R^{d})—.

R³ is the same as R³ in Formula (B1). k1 is the same as k1 in Formula (B1).

The group represented by X³¹(-Q^{b}-Si(R²)ₙL₃₋ₙ)ₕ(—R³¹)ᵢ is the same as the group represented by X³¹(-Q^{b}-Si(R³)ₙL₃₋ₙ)ₕ(—R³¹)ᵢ in Formula (3-1A).

t1 is 0 or 1.

A preferred aspect of the alkyl group represented by R⁵¹ is as described in the section of the alkyl group.

The alkylene group represented by R¹ may be linear, branched, or cyclic. The number of carbon atoms in the alkylene group is preferably from 1 to 30, more preferably from 1 to 20, still more preferably from 4 to 20, and particularly preferably from 5 to 15.

The alkylene group represented by R⁴ may be linear, branched, or cyclic. The number of carbon atoms in the alkylene group is preferably from 1 to 20, more preferably from 1 to 10, still more preferably from 1 to 6, and particularly preferably from 1 to 3.

Examples of the compound (2) include the following compounds. In the following formulae, n10 is a number of 1 or more, n10 is preferably a number from 1 to 60, and may be a number from 3 to 50, a number from 5 to 30, or a number from 7 to 25.

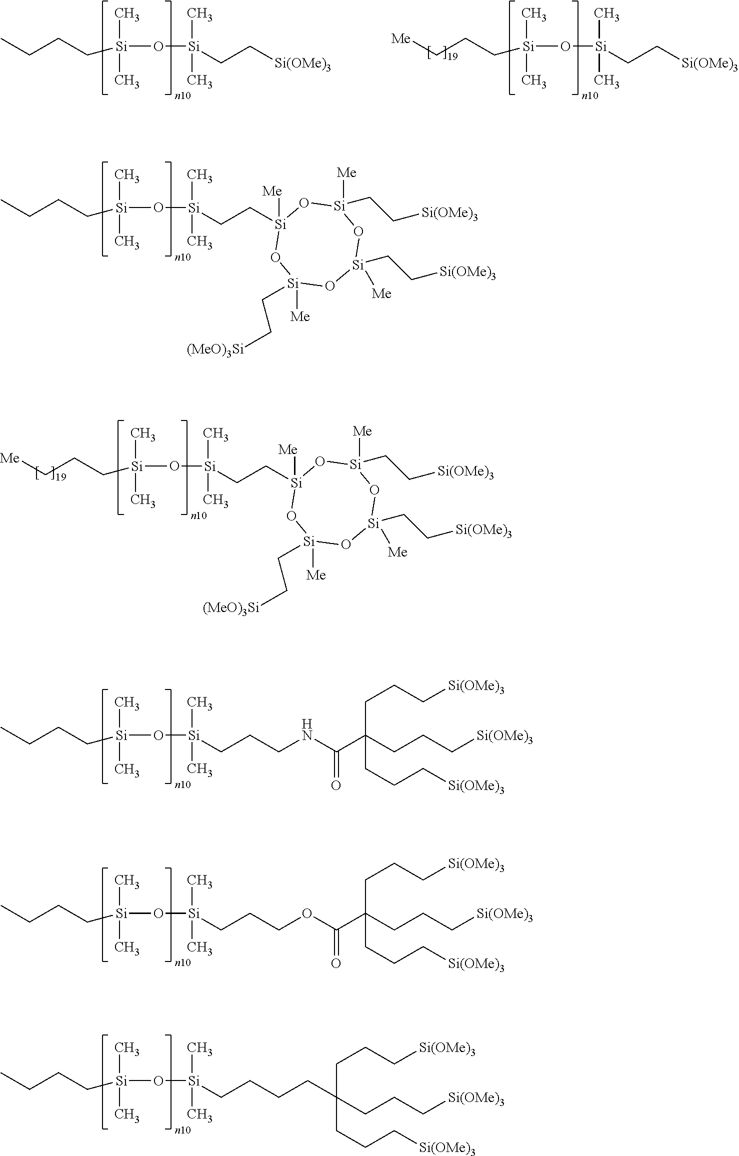

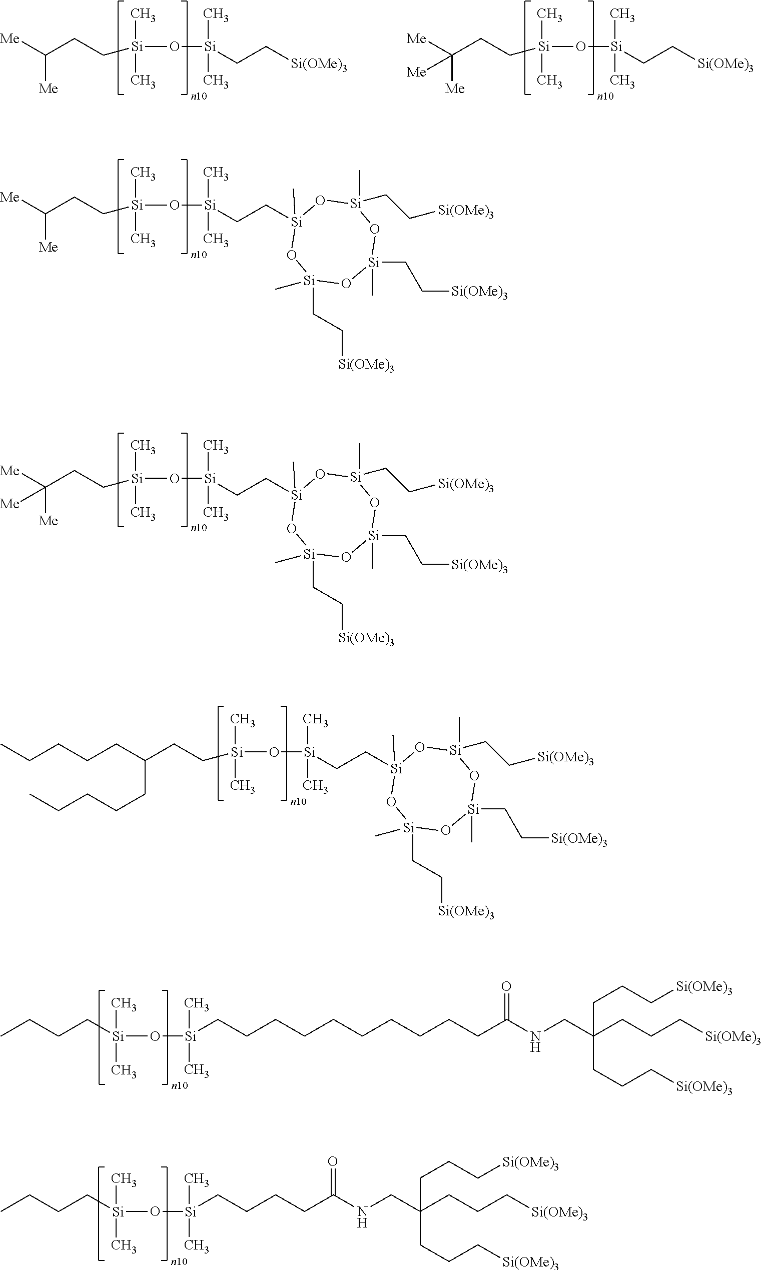

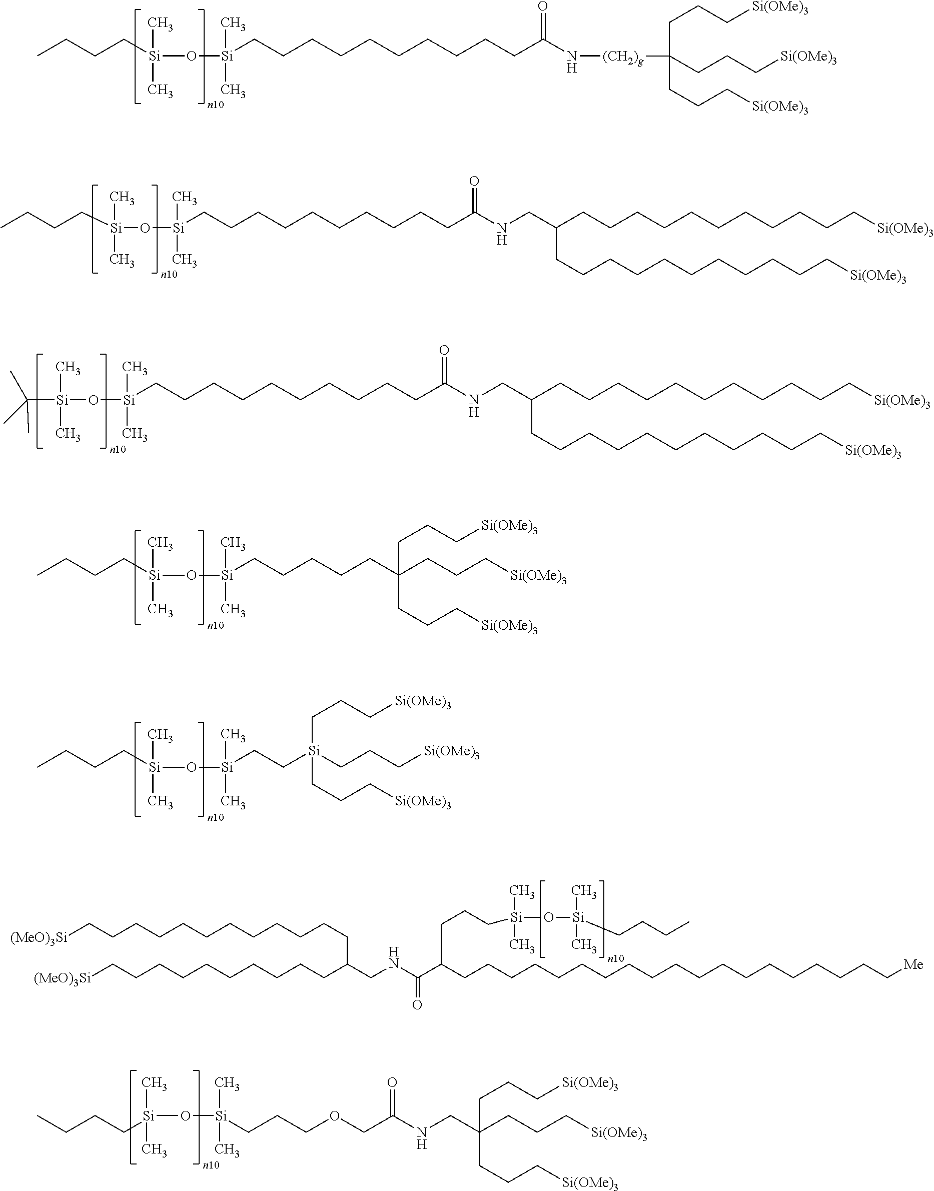

### (Compound (3))

The compound (3) is preferably a compound represented by Formula (3A).

[T³-(O)ᵣ—Z³]ₚ₁A(Si(R²)ₙL₃₋ₙ)_{q1} (3A)

In Formula (3A),
T³ is a monovalent cyclic polysiloxane residue or a monovalent cage-like polysiloxane residue,
r is 0 or 1,
Z³ is a divalent chain organo(poly)siloxane residue or a combination of a divalent chain organo(poly)siloxane residue and at least one of an alkylene chain or a polyalkylene oxide chain,
A is a single bond or a (p1+q1)-valent linking group,
each R² is independently a monovalent hydrocarbon group,
each L is independently a hydrolyzable group, a group having a hydrolyzable group, or a hydroxy group,
n is an integer from 0 to 2, and
each of p1 and q1 is independently an integer of 1 or more.

R², L, and n are the same as R², L, and n in Formula (S1).

The group represented by A(Si(R²)ₙL₃₋ₙ)_{q1} is the same as the group represented by A(Si(R²)ₙL₃₋ₙ)_{q1} in Formula (1A) except for the following contents.

p1 and q1 are the same as p1 and q1 in Formula (1A).

Details of the monovalent cyclic polysiloxane residue or the monovalent cage-like polysiloxane residue are as described above in the description of T¹¹ in Formula (C).

The group represented by A(Si(R²)ₙL₃₋ₙ)_{q1} is preferably a group (3-1A) or a group (3-1B), and more preferably a group (3-1A).

In Formula (3-A), Q^{a} is a single bond or a divalent linking group.

However, the terminal of Q^{a} on the side bonded to Z³ is not any of an alkylene group, a polyalkylene oxide chain, and a divalent organopolysiloxane residue.

When the A-side terminal of Z³ is an alkylene chain, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an ether oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—, more preferably —OC(O)—, an alkylene group having —C(O)N(R^{d})—, an alkylene group having —OC(O)N(R^{d})—, an alkylene group having an ether oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d})—, and still more preferably an alkylene group having —C(O)O— or an alkylene group having —C(O)N(R^{d}).

When the A-side terminal of Z³ is a polyalkylene oxide chain, Q^{a} is preferably a divalent hydrocarbon group other than an alkylene group, a divalent heterocyclic group, —SO₂—, —C(O)—, —Si(R^{a})₂—, —C(O)O—, —C(O)S—, —C(O)N(R^{d})—, —SO₂N(R^{d})—, an alkylene group having —C(O)N(R^{d})—, an alkylene group having —C(O)O—, or an alkylene group having —SO₂N(R^{d})—, and more preferably —C(O)—.

When the A-side terminal of Z³ is a divalent chain organo(poly)siloxane residue, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d}), —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an ether oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—.

In Formula (3-4A), X³¹ is a single bond, an alkylene group, a carbon atom, a nitrogen atom, a silicon atom, a divalent to octavalent organopolysiloxane residue, or a group having a (h+i+1)-valent ring.

However, when Q^{a} is a single bond, the terminal of X³¹ on the side bonded to Z³ is not any of an alkylene group, a polyalkylene oxide chain, and a divalent organopolysiloxane residue. In cases other than the above, the terminal of X³¹ may be any of an alkylene group, a polyalkylene oxide chain, and a divalent organopolysiloxane residue.

In Formula (3-4A), Q^{b} is a single bond or a divalent linking group.

However, when Q^{a} and X³¹ are each a single bond, the terminal of Q^{b} on the side bonded to Z³ is not any of an alkylene group, a polyalkylene oxide chain, and a divalent organopolysiloxane residue. In cases other than the above, the terminal of Q^{b} may be any of an alkylene group, a polyalkylene oxide chain, and a divalent organopolysiloxane residue.

In Formula (3-1A), when Q^{a}, X³¹, and Q^{b} are each a single bond, [Si(R²)ₙL₃₋ₙ] is directly bonded to Z³, and Z³ is an alkylene chain.

In Formula (3-1B), Q^{c} is a single bond or a divalent linking group.

However, the terminal of Q on the side bonded to Z³ is not any of an alkylene group, a polyalkylene oxide chain, and a divalent organopolysiloxane residue.

Group (3-1A) is preferably groups (3-1A-1) to (3-1A-7).

However, the terminal of each of groups (3-1A-1) to (3-1A-7) on the side bonded to Z³ is not any of an alkylene group, a polyalkylene oxide chain, and a divalent organopolysiloxane residue.

In group (3-1A-1), when the A-side terminal of Z³ is an alkylene chain, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, more preferably —O—, —S—, —N(R^{d})—, —C(O)O—, —C(O)S—, —N(R^{d})C(O)—, —N(R^{d})C(O)N(R^{d})—, —OC(O)N(R^{d})—, or —C(O)N(R^{d})—, and still more preferably —C(O)O— or —N(R^{d})C(O)—.

When the A-side terminal of Z³ is a polyalkylene oxide chain, X² is preferably —C(O)—, —C(O)O—, —C(O)S—, —SO₂N(R^{d})—, or —C(O)N(R^{d})—, and more preferably —C(O)—.

When the A-side terminal of Z³ is a divalent chain organo(poly)siloxane residue, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, and is more preferably —O—.

When the A-side terminal of Z³ is an alkylene chain, it is preferable that s1 is 0 and Q^{b1} is a single bond, or s1 is 1 and Q^{b1} is an alkylene group having from 2 to 6 carbon atoms.

When the A-side terminal of Z³ is a polyalkylene oxide chain, it is preferable that s1 is 1 and Q^{b1} is an alkylene group having from 2 to 6 carbon atoms.

When the A-side terminal of Z³ is a divalent chain organo(poly)siloxane residue, it is preferable that s1 is 1 and Q^{b1} is a single bond.

In group (3-1A-2), when the A-side terminal of Z³ is an alkylene chain or a divalent chain organo(poly)siloxane residue, X³³ is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

When the A-side terminal of Z³ is a polyalkylene oxide chain, X³³ is preferably —C(O)O—, —C(O)S—, —SO₂N(R^{d})—, or —C(O)N(R^{d})—.

A in Formula (3A) may be groups (g2-1) to (g2-7).

However, in Formulae (g2-1) to (g2-7), the A¹ side is bonded to Z³, and the Q²², Q²³, Q²⁴, Q²⁵, or Q²⁶ side is bonded to [—Si(R²)ₙL₃₋ₙ].

Other forms of A include groups (g2-8) to (g2-14).

However, in Formulae (g2-8) to (g2-14), the A¹ side is bonded to Z³, and the G¹ side is bonded to [—Si(R²)ₙL₃₋ₙ].

Specific examples of the compound (3) include the following compounds. In the following formula, n10 is a number of 1 or more, n10 is preferably a number from 1 to 60, and may be a number from 3 to 50, a number from 5 to 30, or a number from 7 to 25.

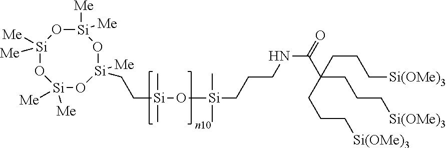

### (Compounds (4A) and (4B)) PGP-54C1

In compounds (4A) and (4B),
it is more preferable that each X^{A} is independently
—(CH₂)ₛ₇—O—(CH₂)ₜ₇—,
—(CH₁₂)ₛ₇—CONR⁵⁴—(CH₂)ₜ₇—,
—(CH₂)ₛ₇—O—(CH₂)ᵤ₇—CO—, or
—(CH₂)ₛ₇—O—(CH₂)ᵤ₇—CONR⁵⁴—(CH₂)ₜ₇—.

Each R³⁴ is independently a hydrogen atom, a phenyl group, an alkyl group having from 1 to 6 carbon atoms, or an oxyalkylene-containing group having from 1 to 10 carbon atoms,
s7 is an integer from 1 to 20,
t7 is an integer from 1 to 20, and
u7 is an integer from 1 to 20.

It is preferable that each X^{A} is independently a group represented by Formula (W6).

In Formula (W6), each X^{a} is independently a single bond or a divalent organic group.

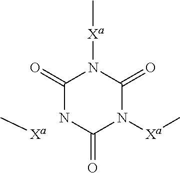

Specific examples of the compound (4A) include the following compound. (CH₃)₃Si—(OSi(CH₃)₂)₁₉—(CH₂)₁₀—CONH—CH₂C{CH₂CH₂CH₂Si(OCH₃)₃}₃

### (Compound (5))

Specific examples of the compound (5) include the following compounds. In the following formulae, n10 is a number of 1 or more, n10 is preferably a number from 1 to 60, and may be a number from 3 to 50, a number from 5 to 30, or a number from 7 to 25.

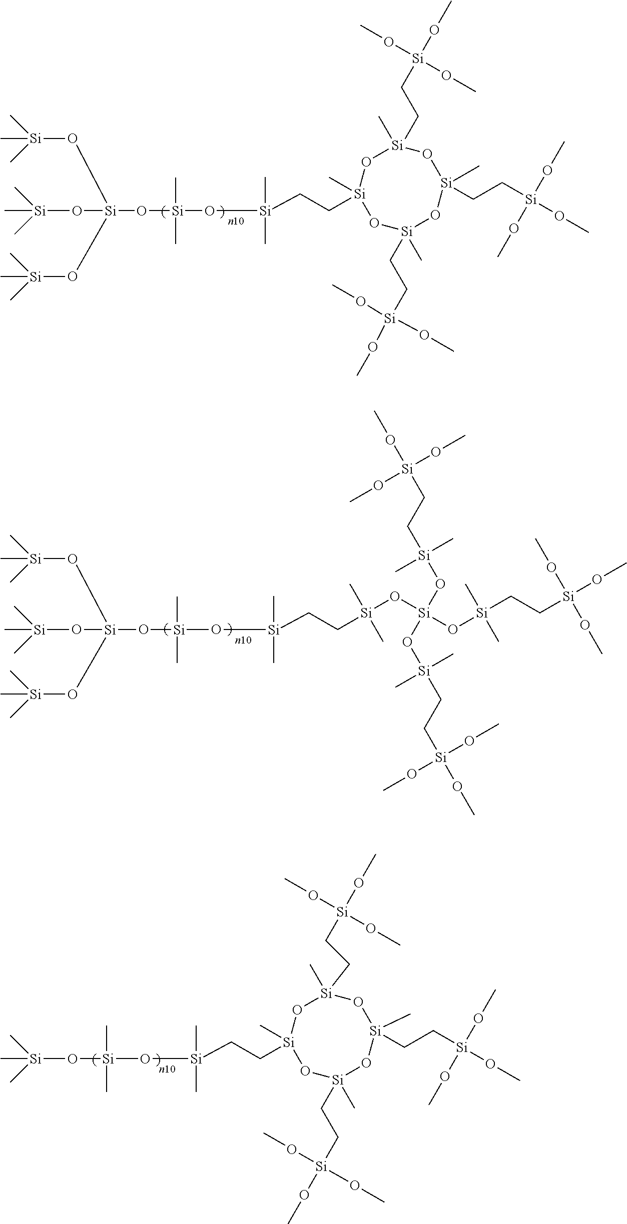

### [Composition]

The composition of the disclosure need only contain the compound of the disclosure, and components other than the compound of the disclosure are not particularly limited. The composition of the disclosure preferably contains the compound of the disclosure and a liquid medium. When containing a liquid medium, the composition of the disclosure need only be a liquid, and may be a solution, or may be a dispersion.

The composition of the disclosure need only contain the compound of the disclosure, and may contain impurities such as by-products generated in the production step of the compound of the disclosure.

The content of the compound of the disclosure is preferably from 0.001 to 50 mass %, more preferably from 0.01 to 20 mass %, and still more preferably from 0.1 to 10 mass % with respect to the total amount of the composition of the disclosure. In the case of the composition of the disclosure used in a wet coating method, the content of the compound of the disclosure may be from 0.01 to 10 mass %, from 0.02 to 5 mass %, from 0.03 to 3 mass %, or from 0.05 to 2 mass % with respect to the total amount of the composition of the disclosure.

### <Liquid Medium>

The composition of the disclosure may contain a liquid medium.

The liquid medium may be only one kind, or may be two or more kinds.

The liquid medium is preferably an organic solvent.

Examples of the organic solvent include a compound formed only of a hydrogen atom and a carbon atom, and a compound formed only of a hydrogen atom, a carbon atom, and an oxygen atom, and specific examples thereof include a hydrocarbon-based organic solvent, a ketone-based organic solvent, an ether-based organic solvent, an ester-based organic solvent, a glycol-based organic solvent, and an alcohol-based organic solvent.

Specific examples of the hydrocarbon-based organic solvent include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of the ketone-based organic solvent include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of the ether-based organic solvent include diethyl ether, cyclopentyl methyl ether, tetrahydrofuran, and 1,4-dioxane.

Specific examples of the ester-based organic solvent include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol methyl ether acetate, 1,3-butylene glycol diacetate, 1,4-butanediol diacetate, 1,6-hexanediol diacetate, γ-butyrolactone, triacetin, and 2,2,4-trimethyl-1,3-pentanediol monoisobutyrate.

Specific examples of the glycol-based organic solvent include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono-tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dibutyl ether, tetraethylene glycol dimethyl ether, triethylene glycol dimethyl ether, and polyethylene glycol dimethyl ether.

Specific examples of the alcohol-based organic solvent include methanol, ethanol, I-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Examples of the organic solvent include a halogen-based organic solvent, a nitrogen-containing compound, a sulfur-containing compound, a siloxane compound, and a fluorine-containing organic solvent.

Specific examples of the halogen-based organic solvent include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of the nitrogen-containing compound include nitrobenzene, acetonitrile, benzonitrile, N,N-dimethylformamide, N,N-dimethylacetamide, N-methylpyrrolidone, and 1,3-dimethyl-2-imidazolidinone.

Examples of the sulfur-containing compound include carbon disulfide and dimethyl sulfoxide.

Examples of the siloxane compound include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of the fluorine-containing organic solvent include a polyfluoroaromatic hydrocarbon (for example, 1,3-bis(trifluoromethyl)benzene); a polyfluoroaliphatic hydrocarbon (for example, C₆F₁₃CH₂CH₃ (for example, ASAHIKLIN (registered trademark) AC-6000 manufactured by AGC Inc.), 1,1,2,2,3,3,4-heptafluorocyclopentane (for example, ZEORORA (registered trademark) H manufactured by Zeon Corporation)); a hydrofluoroether (HFE) (for example, an alkyl perfluoroalkyl ether (a perfluoroalkyl group and an alkyl group may be linear or branched) such as perfluoropropyl methyl ether (C₃F₇OCH₃) (for example, Novec (trademark) 7000 manufactured by Sumitomo 3M Limited), perfluorobutyl methyl ether (C₄F₉OCH₃) (for example, Novec (trademark) 7100 manufactured by Sumitomo 3M Limited), perfluorobutyl ethyl ether (C₄F₉OC₂H₅) (for example, Novec (trademark) 7200 manufactured by Sumitomo 3M Limited), or perfluorohexyl methyl ether (C₂FSCF(OCH₃)C₃F₇)(for example, Novec (trademark) 7300 manufactured by Sumitomo 3M Limited), or CF₃CH₂OCF₂CHF₂ (for example, ASAHIKLIN (registered trademark) AE-3000 manufactured by AGC Inc.)); and a hydrofluoroolefin (HFO) (for example, 1-chloro-2,3,3-trifluoro-1-propene (HCFO-1233yd) (for example, AMOREA (registered trademark) AS-300 manufactured by AGC Inc.), and Opteon (registered trademark) SF01, SF05, SF10, SF30, SF33, SF70, SF79, and SF80 manufactured by Chemours Company).

The content amount of the liquid medium is preferably from 50 to 99.999 mass %, more preferably from 80 to 99.99 mass %, and still more preferably from 90 to 99.9 mass % with respect to the total amount of the composition of the disclosure. In the case of the composition of the disclosure used in a wet coating method, the content amount of the liquid medium may be from 90 to 99.99 mass %, from 95 to 99.98 mass %, from 97 to 99.97 mass %, or from 98 to 99.95 mass % with respect to the total amount of the composition of the disclosure.

### <Second Compound>

The composition of the disclosure contains the compound of the disclosure as a first compound, and may further contain a compound which has an organopolysiloxane residue but does not have a reactive silyl group as a second compound. Hereinafter, the compound of the disclosure contained in the composition of the disclosure is also referred to as “first compound”, and the compound which has an organopolysiloxane residue but does not have a reactive silyl group contained in the composition of the disclosure is also referred to as “second compound”.

The composition of the disclosure may be one containing the first compound, the second compound, and a liquid medium.

The second compound need only be a compound which has an organopolysiloxane residue but does not have a reactive silyl group, and may have another structure other than the organopolysiloxane residue and the reactive silyl group.

Examples of the organopolysiloxane residue contained in the second compound include those the same as the organopolysiloxane residue contained in the first compound.

The organopolysiloxane residue of the first compound and the organopolysiloxane residue of the second compound contained in the composition of the disclosure may be the same or different.

The second compound is preferably represented by Formula (F). In particular, when the composition of the disclosure contains the compound represented by Formula (C) or Formula (D) as the first compound, the composition of the disclosure preferably contains the compound represented by Formula (F) as the second compound.

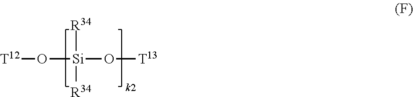

In Formula (F),
each of T¹² and T¹³ is independently a monovalent group,
each R³⁴ is independently a hydrocarbon group, and
k2 is a number of 1 or more.

Examples of T¹² and T¹³ include a group the same as T¹¹ in Formula (C), a group in which at least one of the hydrocarbon groups included in T¹¹ in Formula (C) is substituted with a hydroxy group.

Specific examples of T¹² and T¹³ include an alkyl group, a hydroxyalkyl group, T¹₃M¹- (here, M¹ is Si, Sn, or Ge, and each T¹ is independently a hydrocarbon group or a trialkylsilyloxy group), a group in which at least one of the three T¹s in T¹₃M¹- is substituted with a hydroxy group, T¹₃M¹-R¹— (here M¹ is Si, Sn, or Ge, each T¹ is independently a hydrocarbon group or a trialkylsilyloxy group, and R¹ is an alkylene group), a group in which at least one of the three T¹s in T¹₃M¹-R¹— is substituted with a hydroxy group, a monovalent cyclic polysiloxane residue or a monovalent cage-like polysiloxane residue, and a combination of a monovalent cyclic polysiloxane residue or a monovalent cage-like polysiloxane residue and a divalent hydrocarbon group.

Preferred aspects of the alkyl group, T¹, M¹, the monovalent cyclic polysiloxane residue, and the monovalent cage-like polysiloxane residue are the same as the preferred aspects of the alkyl group, T¹, M¹, the monovalent cyclic polysiloxane residue, and the monovalent cage-like polysiloxane residue in T¹¹ described above.

Among these, T¹² and T¹³ are preferably a group in which M¹ is Si in T¹₃M¹-, an alkyl group, a monovalent cyclic polysiloxane residue, a monovalent cage-like polysiloxane residue, and a group in which M¹ is Si and at least one of the three T¹s is substituted with a hydroxy group in T¹₃M¹-, more preferably a group in which M¹ is Si in T¹₃M¹-, and a group in which M¹ is Si and one of the three T¹s is substituted with a hydroxy group in T¹₃M¹-, still more preferably a group in which M¹ is Si and T¹ is an alkyl group or a trialkylsilyloxy group in T¹₃M¹-, and a group in which M¹ is Si, T¹ is an alkyl group or a trialkylsilyloxy group, and one of the three T¹s is substituted with a hydroxy group in T¹₃M¹-, and particularly preferably a group in which M¹ is Si and T¹ is a methyl group or a trimethylsilyloxy group in T¹₃M¹-, and a group in which M¹ is Si, T¹ is a methyl group or a trimethylsilyloxy group, and one of the three T¹s is substituted with a hydroxy group in T¹₃M¹-.

T¹² and T¹³ may be the same or different from each other. From the viewpoint of ease of production of the compound, T¹² and T¹³ are preferably the same.

When the composition of the disclosure contains the compound represented by Formula (C) as the first compound and the compound represented by Formula (F) as the second compound, T¹¹ in Formula (C) and T¹² and T¹³ in Formula (F) may be the same or different.

R³⁴ is the same as R³ in Formula (C) and R⁴ in Formula (D).

k2 is the same as k1 in Formula (C) and Formula (D).

When the composition of the disclosure contains the compound represented by Formula (C) or (D) as the first compound and the compound represented by Formula (F) as the second compound, R³ in Formula (C) or R⁴ in Formula (D) and R³⁴ in Formula (F) may be the same or different.

When the composition of the disclosure contains the compound represented by Formula (C) or (D) as the first compound and the compound represented by Formula (F) as the second compound, k1 in Formula (C) or Formula (D) and k2 in Formula (F) may be the same or different.

Specific examples of the second compound include the following compounds. In the following formulae, each k2 has the same meaning as k2 in Formula (F).

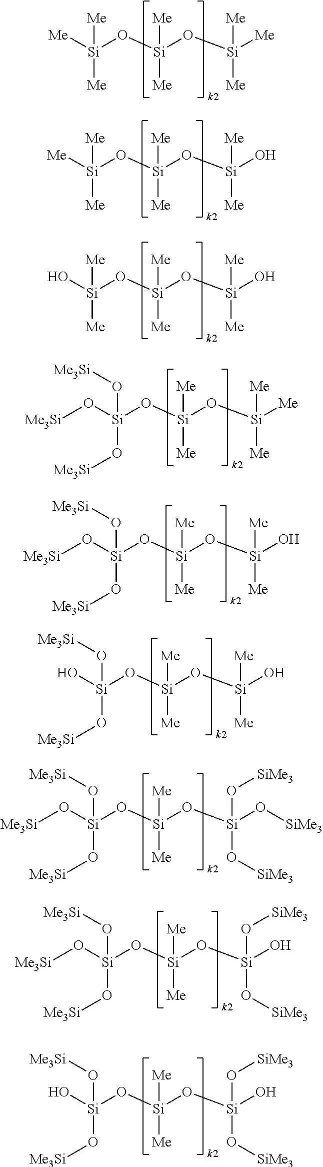

The number average molecular weight of the second compound is preferably from 150 to 16,000, more preferably from 500 to 8,000, and still more preferably from 1,000 to 3.000. The number average molecular weight of the second compound is preferably from 0.02 to 10 times, more preferably from 0.05 to 5 times, and still more preferably from 0.1 to 2 times the number average molecular weight of the first compound.

From the viewpoint of obtaining a surface treatment layer having particularly excellent wear resistance, the content of the second compound is preferably from 1 to 1000 mass %, more preferably from 1 to 500 mass %, still more preferably from 1 to 200 mass %, particularly preferably from 3 to 100 mass %, and extremely preferably from 5 to 50 mass % with respect to the first compound.

The content of the second compound is preferably from 0.2 to 91 mass %, more preferably from 0.2 to 83 mass %, still more preferably from 0.2 to 67 mass %, particularly preferably from 0.6 to 50 mass %, and extremely preferably from 1 to 33 mass % with respect to the total amount of the composition of the disclosure. In the case of the composition of the disclosure used in a wet coating method, the content of the second compound may be from 0.2 to 18 mass %, from 0.2 to 17 mass %, from 0.2 to 13 mass %, from 0.6 to 10 mass %, or from 1 to 7 mass % with respect to the total amount of the composition of the disclosure.

### <Other Components>

The composition of the disclosure may contain other components in addition to the compound of the disclosure, the second compound, and the liquid medium as long as the effects of the disclosure are not impaired.

Examples of other components include known additives such as an acid catalyst and a basic catalyst that promote hydrolysis and a condensation reaction of the reactive silyl group.

As the catalyst, any appropriate acid or base, a transition metal (for example, Ti, Ni, Sn, Zr, Al, B, or the like), a sulfur-containing compound having an unshared electron pair in the molecular structure, a nitrogen-containing compound (for example, a sulfoxide compound, an aliphatic amine compound, an aromatic amine compound, a phosphoric acid amide compound, an amide compound, or a urea compound), or the like can be used.

Examples of the acid catalyst include acetic acid, formic acid, trifluoroacetic acid, hydrochloric acid, nitric acid, sulfuric acid, phosphoric acid, sulfonic acid, methanesulfonic acid, and p-toluenesulfonic acid.

Examples of the base catalyst include ammonia, sodium hydroxide, potassium hydroxide; and an organic amine such as triethylamine or diethylamine.

Examples of other components also include a metal compound having a hydrolyzable group (hereinafter, a metal compound having a hydrolyzable group is also referred to as “specific metal compound”). When the composition of the disclosure contains a specific metal compound, the slipperiness and antifouling property of the surface treatment layer can be further improved. Examples of the specific metal compound include Formulae (M1) to (M3) below.

M(X^{b1})ₘ₁₁(X^{b2})ₘ₁₂(X^{b3})ₘ₁₃ (M1)

Si(X^{b4})(X^{b5})₃ (M2)

(X^{b6})₃Si—(Y^{b1})—Si(X^{b7})₃ (M3)

In Formula (M1),

M represents a trivalent or tetravalent metal atom.

Each X^{b1} independently represents a hydrolyzable group.

Each X^{b2} independently represents a siloxane backbone-containing group.

Each X^{b3} independently represents a hydrocarbon chain-containing group.
m11 is an integer from 2 to 4,
each of m12 and m13 is independently an integer from 0 to 2,
when M is a trivalent metal atom, m11+m12+m13 is 3, and when M is a tetravalent metal atom, m11+m12+m13 is 4.

In Formula (M2),
X^{b4} represents a hydrolyzable silane oligomer residue.

Each X^{b3} independently represents a hydrolyzable group or an alkyl group having from 1 to 4 carbon atoms.

In Formula (M3),
each X^{b6} and X^{b7} independently represents a hydrolyzable group or a hydroxy group.

Y^{b1} represents a divalent organic group.

Examples of the metal represented by M in Formula (M1) also include metalloids such as Si and Ge. M is preferably a trivalent metal or a tetravalent metal, more preferably Al, Fe, In, Hf, Si, Ti, Sn, and Zr, still more preferably Al, Si, Ti, and Zr, and particularly preferably Si.

Examples of the hydrolyzable group represented by X^{b1} in Formula (M1) include those the same as the hydrolyzable group represented by L in [—Si(R²)ₙL₃₋ₙ] in the reactive silyl group.

The siloxane backbone-containing group represented by X^{b2} has a siloxane unit (—Si—O—), and may be linear or branched. The siloxane unit is preferably a dialkylsilyloxy group, and examples thereof include a dimethylsilyloxy group and a diethylsilyloxy group. The number of repetitions of the siloxane unit in the siloxane backbone-containing group is 1 or more, preferably from 1 to 5, more preferably from 1 to 4, and still more preferably from 1 to 3.

The siloxane backbone-containing group may contain a divalent hydrocarbon group in part of the siloxane backbone. Specifically, some oxygen atoms of the siloxane backbone may be replaced by divalent hydrocarbon groups. Examples of the divalent hydrocarbon group include alkylene groups such as a methylene group, an ethylene group, a propylene group, and a butylene group.

A hydrolyzable group, a hydrocarbon group (preferably an alkyl group) or the like may be bonded to a silicon atom at a terminal of the siloxane backbone-containing group.

The number of atoms of the siloxane backbone-containing group is preferably 100 or less, more preferably 50 or less, and still more preferably 30 or less. The number of atoms is preferably 10 or more.

The siloxane backbone-containing group is preferably a group represented by *—(O—Si(CH₃)₂)ₙCH₃, in which n is an integer from 1 to 5, and * represents a bonding site to an adjacent atom.

The hydrocarbon chain-containing group represented by X^{b3} may be a group formed only of a hydrocarbon chain, or may be a group having an ether oxygen atom between carbon atoms in a hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms in the hydrocarbon chain-containing group is preferably from 1 to 3, more preferably from 1 to 2, and still more preferably 1. The hydrocarbon chain-containing group is preferably an alkyl group, and more preferably a methyl group, an ethyl group, or a propyl group.

m1 is preferably 3 or 4.

As the compound represented by Formula (M1), compounds represented by the following Formulae (M1-1) to (M1-5) in which M is Si are preferable, and a compound represented by Formula (M1-1) is more preferable. The compound represented by Formula (M1-1) is preferably tetraethoxysilane, tetramethoxysilane, or triethoxymethylsilane.

Si(X^{b1})₄ (M1-1)

CH₃—Si(X^{b1})₃ (M1-2)

C₂H₅—Si(X^{b1})₃ (M1-3)

n-C₃H₇—Si(X^{b1})₃ (M1-4)

(CH₃)₂CH—Si(X^{b1})₃ (M1-5)

In Formula (M2), the number of silicon atoms contained in the hydrolyzable silane oligomer residue represented by X^{b4} is preferably 3 or more, more preferably 5 or more, and still more preferably 7 or more. The number of silicon atoms is preferably 15 or less, more preferably 13 or less, and still more preferably 10 or less.

The hydrolyzable silane oligomer residue may have an alkoxy group bonded to a silicon atom. Examples of the alkoxy group include a methoxy group, an ethoxy group, a propoxy group, and a butoxy group, and a methoxy group and an ethoxy group are preferable. The hydrolyzable silane oligomer residue may have one kind or two or more kinds of these alkoxy groups, and preferably has one kind.

Examples of the hydrolyzable silane oligomer residue include (C₂H₅O)₃Si—(OSi(OC₂H₅)₂)₄O—*. Here, * represents a bonding site to an adjacent atom.

Examples of the hydrolyzable group represented by X^{b5} in Formula (M2) include those the same as the hydrolyzable group represented by L in [—Si(R²)ₙL₃₋ₙ] in the reactive silyl group, a cyano group, a hydrogen atom, and an allyl group, and an alkoxy group or an isocyanato group is preferable. The alkoxy group is preferably an alkoxy group having from 1 to 4 carbon atoms.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having reactive silyl groups at both terminals of a divalent organic group, that is, bis-silane. Examples of the hydrolyzable group represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom. An alkoxy group and an isocyanato group are preferable. As the alkoxy group, an alkoxy group having from 1 to 4 carbon atoms is preferable, and a methoxy group and an ethoxy group are more preferable.

In Formula (M3), X^{b6} and X^{b7} may be the same groups as each other or may be different groups from each other. From the viewpoint of availability, X^{b6} and X^{b7} are preferably the same groups as each other.

In Formula (M3), Y^{b1} is a divalent organic group that links reactive silyl groups at both terminals. The number of carbon atoms in Y^{b1} of the divalent organic group is preferably from 1 to 8, and more preferably from 1 to 3.

Examples of Y^{b1} include an alkylene group, a phenylene group, and an alkylene group having an ether oxygen atom between carbon atoms. Examples thereof include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂CH₂CH(CH)—, and —C₆H₄—.

Examples of the compound represented by Formula (M3) include (CH₃O)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂M)Si(OC₂H₅)₃.

The content amount of other components that may be contained in the composition of the disclosure is preferably 10 mass % or less, and more preferably 1 mass % or less with respect to the total amount of the composition of the disclosure. When the composition of the disclosure contains a specific metal compound, the content amount of the specific metal compound is preferably from 0.01 to 30 mass %, more preferably from 0.01 to 10 mass %, and still more preferably from 0.05 to 5 mass % with respect to the total amount of the composition of the disclosure.

The total content of the specific silane compound and other components (hereinafter also referred to as “solid content concentration”) is preferably from 0.001 to 50 mass %, more preferably from 0.01 to 20 mass %, and still more preferably from 0.1 to 10 mass % with respect to the total amount of the composition of the disclosure. The solid content concentration of the composition of the disclosure is a value calculated from the mass before heating and the mass after heating in a convection dryer at 120 °C for 4 hours.

When the composition of the disclosure contains a liquid medium, the composition of the disclosure is useful as a coating application and can be used as a coating liquid.

### [Surface Treatment Agent]

In one aspect, the surface treatment agent of the disclosure contains the compound of the disclosure. The surface treatment agent of the disclosure may contain the compound of the disclosure and a liquid medium. The surface treatment agent of the disclosure may be one containing the first compound, which is the compound of the disclosure, and the second compound, or may be one containing the first compound, the second compound, and a liquid medium.

The surface treatment agent of the disclosure may be formed of the composition of the disclosure described above. The surface treatment agent of the disclosure is applied to a surface of a substrate and used for forming a surface treatment layer. Details of each component contained in the surface treatment agent are the same as the details of each component contained in the composition.

In one aspect, the surface treatment agent of the disclosure is preferably used for forming an antifouling layer. In one aspect, the surface treatment agent of the disclosure is preferably used for forming an antifouling layer formed on an outermost surface of an article.

The compound of the disclosure has a chain group and a reactive silyl group, and the number average molecular weight and the low molecular weight component proportion are in the above ranges. Therefore, when the surface treatment agent containing the compound of the disclosure is used, a surface treatment layer having excellent wear resistance can be formed.

### [Article]

In one aspect, an article of the disclosure includes a substrate and a surface treatment layer disposed on the substrate and surface-treated with the surface treatment agent of the disclosure. In one aspect, the surface treatment layer is preferably an antifouling layer. In one aspect, the surface treatment layer is preferably an antifouling layer formed on an outermost surface of an article.

The surface treatment layer may be formed on part of the surface of the substrate, or may be formed on the entire surface of the substrate. The surface treatment layer may spread in a film shape on the surface of the substrate, or may be dispersed in a dot-like pattern.

In the surface treatment layer, the compound of the disclosure is contained in a state in which hydrolysis of some or all of the reactive silyl groups has progressed and a dehydration condensation reaction of a silanol group has progressed.

The thickness of the surface treatment layer is preferably from 1 to 100 nm, and more preferably from 1 to 50 nm. When the thickness of the surface treatment layer is 1 nm or more, the effect of the surface treatment is sufficiently obtained easily. When the thickness of the surface treatment layer is 100 nm or less, utilization efficiency is high. The thickness of the surface treatment layer can be calculated from the oscillation period of an interference pattern by obtaining the interference pattern of reflected X-rays by an X-ray reflectivity method using an X-ray diffractometer for thin film analysis (product name “ATX-G”, manufactured by Rigaku Corporation).

The kind of the substrate is not particularly limited, and examples thereof include a substrate required to be imparted with water repellency. Examples of the substrate include a substrate that may be used by bringing another article (for example, a stylus) or a human finger into contact therewith; a substrate that may be held with a human finger during an operation; and a substrate that may be placed on another article (for example, a mounting table).

Examples of the material of the substrate include a metal, a resin, glass, sapphire, a ceramic, a semiconductor, stone, fiber, a nonwoven fabric, paper, wood, fur, natural leather, artificial leather, ceramic ware, and composite materials thereof. The glass may be chemically strengthened.

Examples of the substrate include a building material, a decorative building material, an interior good, transportation equipment (for example, an automobile), a signboard, a bulletin board, a drinking vessel, tableware, a water tank, an ornamental instrument (for example, a frame or a box), a laboratory instrument, furniture, a textile product, or a packaging container; glass or a resin used for art, sports, or games; or glass or a resin used for an exterior part (excluding a display portion) of a device such as a mobile phone (for example, a smartphone), a portable information terminal, a game console, or a remote controller. The shape of the substrate may be a plate shape or a film shape.

As the substrate, a substrate for a touch panel, a substrate for a display, and a spectacle lens are suitable, and a substrate for a touch panel is particularly suitable. The material of the substrate for a touch panel is preferably glass or a transparent resin.

The substrate may be a substrate having one surface or both surfaces subjected to a surface treatment such as a corona discharge treatment, a plasma treatment, or a plasma graft polymerization treatment. The substrate subjected to a surface treatment has more excellent adhesion to the surface treatment layer, and the wear resistance of the surface treatment layer is further improved. Therefore, it is preferable to subject the surface of the substrate on the side in contact with the surface treatment layer to a surface treatment. When an underlying layer described later is provided, the substrate subjected to a surface treatment has more excellent adhesion to the underlying layer, and the wear resistance of the surface treatment layer is further improved. Therefore, when the underlying layer is provided, it is preferable to subject the surface of the substrate on the side in contact with the underlying layer to a surface treatment.

The surface treatment layer may be provided directly on the surface of the substrate, or an underlying layer may be provided between the substrate and the surface treatment layer. From the viewpoint of further improving the water repellency and wear resistance of the surface treatment layer, the article of the disclosure preferably includes a substrate, an underlying layer disposed on the substrate, and a surface treatment layer disposed on the underlying layer and formed by a surface treatment using the surface treatment agent of the disclosure.

The underlying layer is preferably a layer containing an oxide containing silicon and at least one specific element selected from the group consisting of a group 1 element, a group 2 element, a group 4 element, a group 5 element, a group 13 element, and a group 15 element in the periodic table.

The group 1 element in the periodic table (hereinafter also referred to as “group I element”) means lithium, sodium, potassium, rubidium, and cesium. As the group 1 element, lithium, sodium, and potassium are preferable, and sodium and potassium are more preferable from the viewpoint that the surface treatment layer can be more uniformly formed on the underlying layer without defects, or the variation in the composition of the underlying layer among samples is further suppressed. The underlying layer may contain two or more kinds of group I elements.

The group 2 element in the periodic table (hereinafter also referred to as “group 2 element”) means beryllium, magnesium, calcium, strontium, and barium. As the group 2 element, magnesium, calcium, and barium are preferable, and magnesium and calcium are more preferable from the viewpoint that the surface treatment layer can be more uniformly formed on the underlying layer without defects, or the variation in the composition of the underlying layer among samples is further suppressed. The underlying layer may contain two or more kinds of group 2 elements.

The group 4 element in the periodic table (hereinafter also referred to as “group 4 element”) means titanium, zirconium, and hafnium. As the group 4 element, titanium and zirconium are preferable, and titanium is more preferable from the viewpoint that the surface treatment layer can be more uniformly formed on the underlying layer without defects, or the variation in the composition of the underlying layer among samples is further suppressed. The underlying layer may contain two or more kinds of group 4 elements.

The group 5 element in the periodic table (hereinafter also referred to as “group 5 element”) means vanadium, niobium, and tantalum. As the group 5 element, vanadium is particularly preferable from the viewpoint that the surface treatment layer has more excellent wear resistance. The underlying layer may contain two or more kinds of group 5 elements.

The group 13 element in the periodic table (hereinafter also referred to as “group 13 element”) means boron, aluminum, gallium, and indium. As the group 13 element, boron, aluminum, and gallium are preferable, and boron and aluminum are more preferable from the viewpoint that the surface treatment layer can be more uniformly formed on the underlying layer without defects, or the variation in the composition of the underlying layer among samples is further suppressed. The underlying layer may contain two or more kinds of group 13 elements.

The group 15 element in the periodic table (hereinafter also referred to as “group 15 element”) means nitrogen, phosphorus, arsenic, antimony, and bismuth. As the group 15 element, phosphorus, antimony, and bismuth are preferable, and phosphorus and bismuth are more preferable from the viewpoint that the surface treatment layer can be more uniformly formed on the underlying layer without defects, or the variation in the composition of the underlying layer among samples is further suppressed. The underlying layer may contain two or more kinds of group 15 elements.

As the specific element contained in the underlying layer, a group 1 element, a group 2 element, and a group 13 element are preferable because the surface treatment layer has more excellent wear resistance, a group 1 element and a group 2 element are more preferable, and a group I element is still more preferable.

As the specific element, only one kind of element may be contained, or two or more kinds of elements may be contained.

The oxide contained in the underlying layer may be a mixture of oxides of the above elements (silicon and specific elements) alone (for example, a mixture of silicon oxide and an oxide of a specific element), a composite oxide containing two or more kinds of the above elements, or a mixture of an oxide of the above elements alone and a composite oxide.

The ratio of the total molar concentration of the specific element in the underlying layer to the molar concentration of silicon in the underlying layer (specific element/silicon) is preferably from 0.02 to 2.90, more preferably from 0.10 to 2.00, and still more preferably from 0.20 to 1.80 from the viewpoint that the surface treatment layer has more excellent wear resistance.

The molar concentration (mol %) of each element in the underlying layer can be measured, for example, by depth direction analysis using X-ray photoelectron spectroscopy (XPS) with ion sputtering.

The underlying layer may be a single layer or a multilayer. The underlying layer may have irregularities on the surface.

The thickness of the underlying layer is preferably from 1 to 100 rim, more preferably from 1 to 50 nm, and still more preferably from 2 to 20 nm. When the thickness of the underlying layer is the above lower limit value or more, the adhesion of the surface treatment layer due to the underlying layer is further improved, and the surface treatment layer has more excellent wear resistance. When the thickness of the underlying layer is the above upper limit value or less, the underlying layer itself has excellent wear resistance.

The thickness of the underlying layer is measured through cross-sectional observation of the underlying layer with a transmission electron microscope (TEM).

The underlying layer can be formed, for example, by a vapor deposition method using a vapor deposition material or a wet coating method.

The vapor deposition material used in the vapor deposition method preferably contains an oxide containing silicon and a specific element.

Specific examples of the form of the vapor deposition material include a powder, a molten body, a sintered body, a granulated body, and a crushed body, and from the viewpoint of handleability, a molten body, a sintered body, and a granulated body are preferable.

Here, the molten body means a solid obtained by melting a powder of a vapor deposition material at a high temperature, followed by cooling and solidification. The sintered body means a solid obtained by firing a powder of a vapor deposition material, and instead of a powder of a vapor deposition material, a molded body obtained by press-forming the powder may be used if necessary. The granulated body means a solid obtained by kneading a powder of a vapor deposition material and a liquid medium (for example, water or an organic solvent) to obtain particles and then drying the particles.

The vapor deposition material can be produced, for example, by the following method.
A method in which a powder of silicon oxide and a powder of an oxide of a specific element are mixed to obtain a powder of a vapor deposition material.
A method in which the powder of a vapor deposition material and water are kneaded to obtain particles, and then the particles are dried to obtain a granulated body of a vapor deposition material.
A method in which a mixture obtained by mixing a powder containing silicon (for example, a powder made of silicon oxide, silica sand, or silica gel), a powder containing a specific element (for example, a powder of an oxide of a specific element, a carbonate, a sulfate, a nitrate, an oxalate, or a hydroxide), and water is dried, and then firing the dried mixture or a molded body obtained by press-molding this to obtain a sintered body.
A method in which a powder containing silicon (for example, a powder made of silicon oxide, silica sand, or silica gel), a powder containing a specific element (for example, a powder of an oxide of a specific element, a carbonate, a sulfate, a nitrate, an oxalate, or a hydroxide) are melted at a high temperature, and then the melt is cooled and solidified to obtain a molten body.

Specific examples of the vapor deposition method using the vapor deposition material include a vacuum deposition method. The vacuum deposition method is a method in which the vapor deposition material is evaporated in a vacuum chamber and attached to a surface of a substrate.

The temperature (for example, when a vacuum deposition apparatus is used, the temperature of a boat on which the vapor deposition material is disposed) during vapor deposition is preferably from 100 to 3,000 °C, and more preferably from 500 to 3,000 °C.

The pressure (for example, when a vacuum deposition apparatus is used, the pressure in the chamber in which the vapor deposition material is disposed) during vapor deposition is preferably 1 Pa or less, and more preferably 0.1 Pa or less.

When the underlying layer is formed using the vapor deposition material, one vapor deposition material may be used, or two or more vapor deposition materials containing different elements may be used.

Specific examples of the method of evaporating the vapor deposition material include a resistance heating method in which the vapor deposition material is melted and evaporated on a resistance heating boat made of a high melting point metal, and an electron gun method in which the vapor deposition material is irradiated with an electron beam and directly heated to melt and evaporate the surface. As a method of evaporating the vapor deposition material, an electron gun method is preferable from the viewpoint that a high melting point substance can also be evaporated because local heating is possible, and from the viewpoint that there is no risk of reaction with a container or contamination with impurities because a portion not hit by an electron beam is at a low temperature.

In the method of evaporating the vapor deposition material, a plurality of boats may be used, or all vapor deposition materials may be placed in a single boat and used. The vapor deposition method may be co-vapor deposition, alternate vapor deposition, or the like. Specifically, examples include a case where silica and a specific source are mixed in the same boat and used, a case where silica and a specific element source are placed in separate boats and co-deposited, and a case where silica and a specific element source are placed in separate boats similarly and alternately deposited. Conditions, order, and the like of vapor deposition are selected as appropriate according to the configuration of the underlying layer.

In the wet coating method, it is preferable to form an underlying layer on a substrate by a wet coating method using a coating liquid containing a compound containing silicon, a compound containing a specific element, and a liquid medium.

Specific examples of the silicon compound include silicon oxide, silicic acid, a partial condensate of silicic acid, alkoxysilane, and a partial hydrolysis condensate of alkoxysilane.

Specific examples of the compound containing a specific element include an oxide of a specific element, an alkoxide of a specific element, a carbonate of a specific element, a sulfate of a specific element, a nitrate of a specific element, an oxalate of a specific element, and a hydroxide of a specific element.

Examples of the liquid medium include those the same as the liquid medium that may be contained in the composition of the disclosure.

The content amount of the liquid medium is preferably from 80 to 99.99 mass %, and more preferably from 90 to 99.9 mass % with respect to the total amount of the coating liquid used for forming the underlying layer.

Specific examples of the wet coating method for forming the underlying layer include a spin coating method, a wipe coating method, a spray coating method, a squeegee coating method, a dip coating method, a die coating method, an inkjet method, a flow coating method, a roll coating method, a casting method, a Langmuir-Blodgett method, or a gravure coating method.

It is preferable to dry the coating film after wet coating with the coating liquid. The drying temperature of the coating film is preferably from 20 to 200 °C, and more preferably from 80 to 160 °C.

The article of the disclosure may be an optical material having a surface treatment layer as the outermost layer.

Preferred examples of the optical material include optical materials related to displays and the like as well as a wide variety of other optical materials.

Examples of the optical material include a display such as a cathode ray tube (CRT, for example, a personal computer monitor), a liquid crystal display, a plasma display, an organic EL display, an inorganic thin film EL dot matrix display, a rear projection-type display, a fluorescent display tube (VFD), or a field emission display (FED), a protective plate for the display, and one having a surface subjected to an antireflection film treatment.

The article of the disclosure is preferably an optical member. Examples of the optical member include an automotive navigation system, a mobile phone, a smartphone, a digital camera, a digital video camera, a PDA, a portable audio player, a car audio, a game console, a spectacle lens, a camera lens, a lens filter, sunglasses, a medical instrument such as a stomach camera, a copying machine, a PC, a display (for example, a liquid crystal display, an organic EL display, a plasma display, or a touch panel display), a touch panel, a protective film, and an antireflection film.

Examples of the optical member include a front protective plate, an antireflection plate, a polarizing plate, and an anti-glare plate of a display such as a PDP or an LCD; a disc surface of an optical disk such as a Blu-ray (registered trademark) disc, a DVD disc, CD-R, or MO; an optical fiber; and a display surface of a watch.

In particular, the article of the disclosure is preferably a display or a touch panel.

The article of the disclosure may be a medical device or a medical material. The article of the disclosure may be an automobile interior or exterior member. Examples of the exterior material include a window, a light cover, or an exterior camera cover. Examples of the interior material include an instrument panel cover, a navigation system touch panel, or a decorative interior material.

When the article of the disclosure is an optical member, the material forming the surface of the substrate is a material for an optical member, for example, glass or transparent plastic. When the article of the disclosure is an optical member, a functional layer such as a hard coat layer or an antireflection layer may be formed on the surface (outermost layer) of the substrate. The antireflection layer may be either a single-layer antireflection layer or a multilayer antireflection layer.

Examples of an inorganic substance that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used singly, or in combination of two or more kinds thereof (for example, as a mixture). In the case of a multilayer antireflection layer, it is preferable to use SiO₂ and/or SiO as the outermost layer. When the article of the disclosure is an optical glass component for a touch panel, a transparent electrode, for example, a thin film in which indium tin oxide (ITO), indium zinc oxide, or the like is used may be provided on part of the surface of the substrate (glass). In addition, the substrate may have an insulating layer, an adhesive layer, a protective layer, a decorative frame layer (I—CON), an atomized film layer, a hard coating film layer, a polarizing film, a phase difference film, a liquid crystal display module, or the like according to the specific specification thereof or the like.

### [Method of Producing Article]

The method of producing an article of the disclosure is, for example, a method in which a substrate is subjected to a surface treatment using the surface treatment agent of the disclosure to produce an article having a surface treatment layer formed on the substrate. Examples of the surface treatment include a dry coating method and a wet coating method.

Examples of the dry coating method include methods such as vacuum deposition, CVD, or sputtering. As the dry coating method, a vacuum deposition method is preferable from the viewpoint of suppressing decomposition of the compound and simplicity of the apparatus. At the time of vacuum deposition, a pellet-like substance obtained by impregnating a metal porous body of iron, steel, or the like with the compound of the disclosure may be used. A pellet-like substance impregnated with the compound of the disclosure obtained by impregnating a metal porous body of iron, steel, or the like with a composition containing the compound of the disclosure and a liquid medium and drying the liquid medium may be used.

Examples of the wet coating method include a spin coating method, a wipe coating method, a spray coating method, a squeegee coating method, a dip coating method, a die coating method, an inkjet method, a flow coating method, a roll coating method, a casting method, a Langmuir-Blodgett method, or a gravure coating method.

In order to improve the wear resistance of the surface treatment layer, an operation for promoting a reaction between the compound of the disclosure and the substrate may be performed if necessary. Examples of the operation include heating, humidification, and light irradiation.

For example, the substrate on which the surface treatment layer is formed can be heated in the atmosphere with moisture to promote a reaction such as a hydrolysis reaction of a hydrolyzable group, a reaction between a hydroxy group or the like on the surface of the substrate and a silanol group, or generation of a siloxane bond by a condensation reaction of a silanol group.

After the surface treatment, a compound, which is in the surface treatment layer, and is not chemically bonded to another compound or the substrate, may be removed if necessary. Examples of the removal method include a method of pouring a solvent on the surface treatment layer and a method of wiping with a cloth soaked with a solvent.

### Examples

Next, the embodiments of the disclosure will be specifically described with reference to examples, but the embodiments of the disclosure are not limited to the examples. Examples 1 to 2 and 5 to 9 are examples, and Examples 3 to 4 and 10 to 13 are comparative examples.

### [Synthesis of Compound (A3)]

### <Synthesis of Compound (A1)>

Under a nitrogen atmosphere, trimethylsilanol (0.15 g) and tetrahydrofuran (THF) (10 mL) were added to a three-necked flask and stirred. The mixture was cooled to 0 °C, and a hexane solution of n-BuLi (1.6 M, 0.95 mL) was added dropwise thereto. A THF solution of hexamethylcyclotrisiloxane (1.0 M, 11 mL) was added dropwise thereto, followed by stirring at 25 °C for 18 hours. To the resulting reaction solution, pentafluorophenyl 11-(chlorodimethylsilyl)undecanoate (1.5 g) was added, followed by stirring at 25 °C for 6 hours. The resulting reaction solution was diluted with hexane, and water was added thereto. The organic phase was separated and the aqueous phase was extracted with hexane. The combined organic phase was washed with water and saturated saline, dried over magnesium sulfate, and then the solvent and volatiles were distilled off under reduced pressure. The obtained residue was purified by flash column chromatography (developing solvent: hexane/ethyl acetate) using silica gel to obtain 1.4 g of a compound (A1). The structure of the compound (A1) was identified based on the following NMR data. The average value of k1 in the formula was 19 as calculated from the NMR spectrum. In the formula. Me represents a methyl group. The same applies hereinafter.

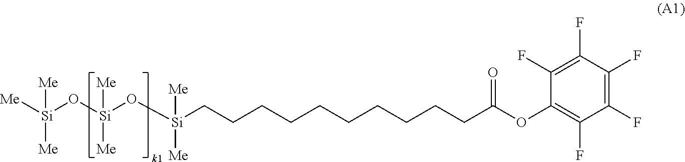

¹H-NMR (400 MHz, CDCl₃) δ 2.58 (t, J=7.4 Hz, 2H), 1.70 (p, J=7.4 Hz, 2H), 1.41-1.07 (m, 14H), 0.45 (t, J=7.4 Hz, 2H), 0.10 (s, 129H).

### <Synthesis of Compound (A2)>

To a THF (10 mL) solution of the compound (A1) (1.4 g) and triethylamine (2.8 mL), 2,2-diallylpent-4-en-1-amine (0.13 g) was added, followed by stirring at 25 °C for 24 hours. The resulting reaction solution was diluted with hexane, and water was added thereto. The organic phase was separated and the aqueous phase was extracted with hexane. The combined organic phase was washed with water and saturated saline, dried over magnesium sulfate, and then the solvent and volatiles were distilled off under reduced pressure to obtain 1.4 g of a compound (A2). The structure of the compound (A2) was identified based on the following NMR data. The average value of k1 in the formula was 19 as calculated from the NMR spectrum.

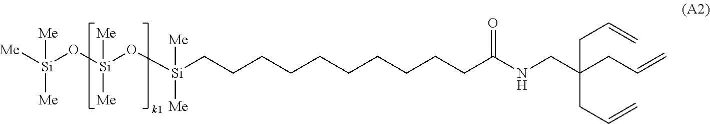

¹H-NMR (400 MHz, CDCl₃) δ 5.80 (ddt, J=16.9, 10.2, 6.7 Hz, 3H), 5.65 (s, 1H), 5.15-4.90 (m, 6H), 3.11 (t, J=5.8 Hz, 2H), 2.10 (t, J=7.6 Hz, 2H), 1.97 (q, J=6.9 Hz, 6H), 1.69-0.97 (m, 16H), 0.45 (t, J=7.6 Hz, 2H), 0.07 (s, 129H).

### <Synthesis of Compound (A3)>

Dichloromethane (40 mL), the compound (A2) (0.4 g), a toluene solution of a platinum/1,3-divinyl-1,1,3,3-tetramethyldisiloxane complex (platinum content amount: 3 mass %, 25 mg), aniline (8.0 mg), and trimethoxysilane (0.1 mL) were stirred at 40 °C for 2 hours, and then the solvent was distilled off under reduced pressure to obtain 0.5 g of a compound (A3). The structure of the compound (A3) was identified based on the following NMR data. The average value of k1 in the formula was 19 as calculated from the NMR spectrum.

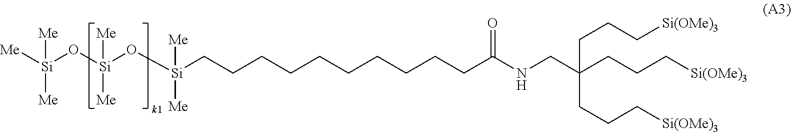

¹H-NMR (400 MHz, CDCl₃) δ 5.66 (d, J=6.4 Hz, 1H), 3.46 (s, 27H), 3.12 (d, J=6.3 Hz, 2H), 2.12 (t, J=7.5 Hz, 2H), 1.61-1.42 (m, 2H), 1.32-1.02 (m, 26H), 0.53 (t, J=7.7 Hz, 6H), 0.45 (t, J=7.0 Hz, 2H), 0.22-−0.24 (m, 129H).

### [Synthesis of Compound (B3)]

### <Synthesis of Compound (B1)>

Under a nitrogen atmosphere, tris(trimethylsiloxy)silanol (0.15 g) and THF (10 mL) were added to a three-necked flask and stirred. The mixture was cooled to 0 °C, and a hexane solution of n-BuLi (1.6 M, 0.95 mL) was added dropwise thereto. A THF solution of hexamethylcyclotrisiloxane (1.0 M, 11 mL) was added dropwise thereto, followed by stirring at 25 °C for 18 hours. To the resulting reaction solution, pentafluorophenyl 11-(chlorodimethylsilyl)undecanoate (1.5 g) was added, followed by stirring at 25 °C for 6 hours. The resulting reaction solution was diluted with hexane, and water was added thereto. The organic phase was separated and the aqueous phase was extracted with hexane. The combined organic phase was washed with water and saturated saline, dried over magnesium sulfate, and then the solvent and volatiles were distilled off under reduced pressure. The obtained residue was purified by flash column chromatography (developing solvent: hexane/ethyl acetate) using silica gel to obtain 1.4 g of a compound (B1). The structure of the compound (B1) was identified based on the NMR data. The average value of k1 in the formula was 19 as calculated from the NMR spectrum.

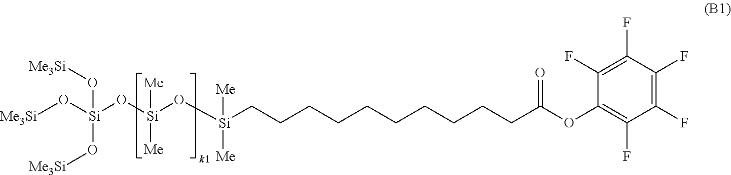

¹H-NMR (400 MHz, CDCl₃) δ 2.58 (t, J=7.4 Hz, 2H), 1.70 (p, J=7.4 Hz, 2H), 1.41-1.07 (m, 14H), 0.45 (t, J=7.4 Hz, 2H), 0.10 (s, 147H).

<Synthesis of Compound (B2)>

To a THF (10 mL) solution of the compound (B1) (1.4 g) and triethylamine (2.8 mL), 2-(undec-10-en-1-yl)tridec-12-en-1-amine (0.28 g) was added, followed by stirring at 25 °C for 24 hours. The resulting reaction solution was diluted with hexane, and water was added thereto. The organic phase was separated and the aqueous phase was extracted with hexane. The combined organic phase was washed with water and saturated saline, dried over magnesium sulfate, and then the solvent and volatiles were distilled off under reduced pressure to obtain 1.5 g of a compound (B2). The structure of the compound (B2) was identified based on the NMR data. The average value of k1 in the formula was 19 as calculated from the NMR spectrum.

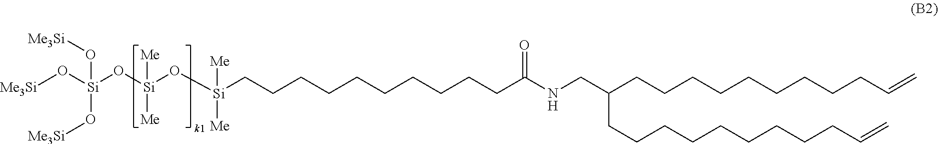

¹H-NMR (400 MHz, CDCl₃) δ 5.71 (ddt, J=16.9, 10.2, 6.7 Hz, 2H), 5.24 (t, J=5.7 Hz, 1H), 4.95-4.78 (m, 4H), 3.08 (t, J=5.9 Hz, 2H), 2.06 (t, J=7.6 Hz, 2H), 1.94 (q, J=6.9 Hz, 4H), 1.46-0.98 (m, 49H), 0.42 (t, J=7.6 Hz, 2H), −0.06 (s, 141H).

### <Synthesis of Compound (B3)>

Dichloromethane (40 mL), the compound (B2) (0.4 g), a toluene solution of a platinum/1,3-divinyl-1,1,3,3-tetramethyldisiloxane complex (platinum content amount: 3 mass %, 25 mg), aniline (8.0 mg), and trimethoxysilane (0.08 mL) were stirred at 40 °C for 2 hours, and then the solvent was distilled off under reduced pressure to obtain 0.4 g of a compound (B3). The structure of the compound (B3) was identified based on the NMR data. The average value of k1 in the formula was 19 as calculated from the NMR spectrum.

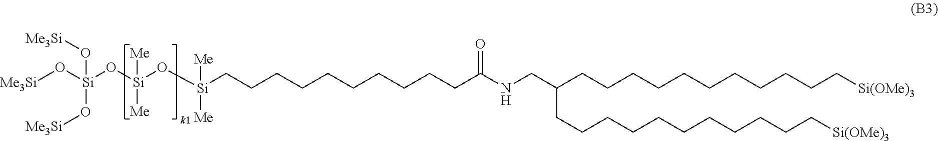

¹H-NMR (400 MHz, CDCl₃) δ 5.26-5.17 (m, 1H), 3.47 (s, 18H), 3.08 (t, J=6.0 Hz, 2H), 2.12-1.98 (m, 2H), 1.46-0.98 (m, 57H), 0.63-0.46 (m, 4H), 0.45 (t, J=7.6 Hz, 2H), −0.06 (s, 141H).

### [Synthesis of Compound (C5)]

### <Synthesis of Compound (C1)>

Dichloromethane (100 g) and trichloroisocyanuric acid (14 g) were added to 1,1,1,3,5,5,5-heptamethyltrisiloxane (10 g), followed by stirring at 25 °C for 3 hours. Subsequently, the reaction liquid was filtered to remove insoluble matters, and then the filtrate was distilled off to remove volatiles. Water (20 g), THF (40 g) and triethylamine (10 g) were added to the obtained crude liquid, followed by stirring at 25 °C for 2 hours. Hexane and water were added for extraction, and volatiles were removed by distillation. The obtained crude liquid was purified by flash column chromatography (developing solvent: hexane/ethyl acetate) using silica gel to obtain 8.3 g of a compound (C1). The structure of the compound (C1) was identified based on the NMR data.

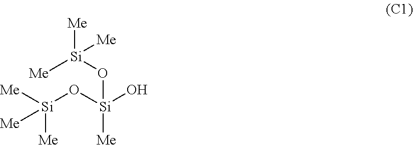 [SMILES: C[Si](C)(C)O[Si](C)(O)O[Si](C)(C)C]

¹H-NMR (400 MHz, CDCl₃) δ 2.41 (q, J=7.2 Hz, 1H), 0.20-0.21 (m, 21H).

### <Synthesis of Compound (C2)>

THF (20 g) was added to the compound (C1) (2.0 g), and the mixture was cooled to 0 °C, and then a methyl lithium solution (3.1 M in diethoxymethane)(2.7 mL) was added thereto, followed by stirring at 25 °C for 10 minutes. A solution obtained by dissolving hexamethylcyclotrisiloxane (5.6 g) in THF (20 g) was then added thereto, followed by stirring at 25 °C for 4 hours. Then, chlorodimethylsilane (2.0 g) was added thereto, followed by stirring at 25 °C for 1 hour. Hexane and water were added for extraction, and then volatiles were removed by distillation. The obtained crude liquid was purified by flash column chromatography (developing solvent: hexane/dichloromethane) using silica gel to obtain 4.3 g of a compound (C2). The structure of the compound (C2) was identified based on the NMR data. The average value of k1 in the formula was 18 as calculated from the NMR spectrum.

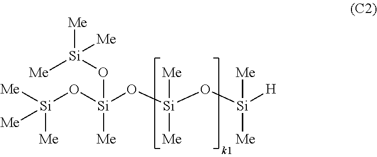

¹H-NMR (400 MHz, CDCl₃) δ 4.63 (p, J=2.8 Hz, 1H), 0.11 (d, J=2.8 Hz, 6H), 0.09-0.12 (m, 150H).

### <Synthesis of Compound (C3)>

Dichloromethane (20 g) and 18-bromo-1-octadecene (0.75 g) were added to the compound (C2) (2.3 g), followed by stirring until uniform. Subsequently, a toluene solution of a platinum/1,3-divinyl-1,1,3,3-tetramethyldisiloxane complex (platinum content amount: 3 mass %, 4.1 mg) was added thereto, followed by stirring at 25 °C for 2 hours. The volatiles were distilled off under reduced pressure, followed by purification by flash column chromatography (developing solvent: hexane/dichloromethane) using silica gel to obtain 1.8 g of a compound (C3). The structure of the compound (C3) was identified based on the NMR data. The average value of k1 in the formula was 18 as calculated from the NMR spectrum.

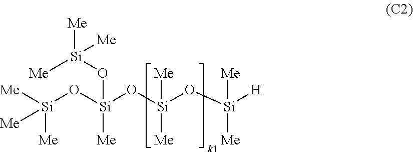

¹H-NMR (400 MHz, CDCl₃) δ 3.33 (t, J=6.9 Hz, 2H), 1.78 (dt, J=14.5, 7.0 Hz, 2H), 1.42-1.08 (m, 30H), 0.45 (t, J=7.7 Hz, 2H), 0.09-0.12 (m, 162H).

### <Synthesis of Compound (C4)>

THF (20 g), an allylmagnesium chloride solution (2.0 M in THF) (20 mL) and copper(II) chloride (0.02 g) were added to the compound (C3) (1.8 g), followed by stirring at 50 °C for 2 hours. Hydrochloric acid and hexane were added for extraction, and the volatiles were distilled off under reduced pressure, followed by purification by flash column chromatography (developing solvent: hexane/dichloromethane) using silica gel to obtain 1.5 g of a compound (C4). The structure of the compound (C4) was identified based on the NMR data. The average value of k1 in the formula was 18 as calculated from the NMR spectrum.

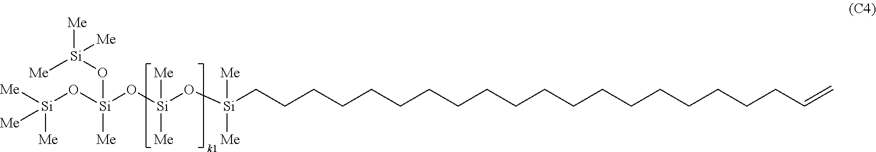

¹H-NMR (400 MHz, CDCl₃) δ 5.74 (ddt, J=17.0, 10.2, 6.7 Hz, 1H), 5.01-4.76 (m, 2H), 2.07-1.87 (m, 2H), 1.41-0.97 (m, 34H), 0.45 (dd, J=9.5, 5.9 Hz, 2H), 0.09-0.12 (m, 162H).

### <Synthesis of Compound (C5)>

To the compound (C4)(1.5 g), dichloromethane (10 g) was added and dissolved. Then, a toluene solution of a platinum/1,3-divinyl-1,1,3,3-tetramethyldisiloxane complex (platinum content amount: 3 mass %, 4.1 mg), aniline (2.6 mg), and trimethoxysilane (0.60 g) were added thereto, followed by stirring at 50 °C for 2 hours. The solvent was distilled off under reduced pressure to obtain 1.6 g of a compound (C). The structure of the compound (C) was identified based on the NMR data. The average value of k1 in the formula was 18 as calculated from the NMR spectrum.

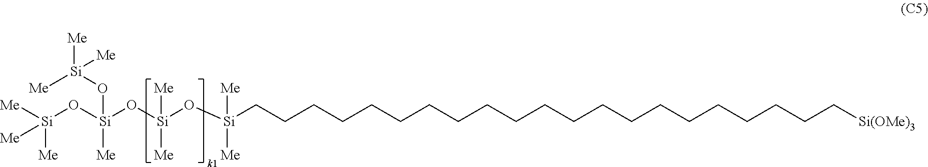

¹H-NMR (400 MHz, CDCl₃) δ 3.49 (s, 9H), 1.81-0.97 (m, 38H), 0.65-0.51 (m, 2H), 0.45 (dd, J=9.8, 5.3 Hz, 2H), 0.09-0.12 (m, 162H).

### [Preparation of Compound (X¹)]

A compound (X¹) (0.2 g) was obtained in the same manner as in the synthesis of the compound (A3) except that the compound (A2) (0.4 g) was washed with methanol and concentrated, and the obtained residue was purified by flash column chromatography (developing solvent: hexane/ethyl acetate) using silica gel to collect a fraction in which k1 in the formula was 19, and the fraction was used in place of the compound (A2). The average value of k1 in the formula was 19 as calculated from the NMR spectrum. As determined by the method described above, the number average molecular weight of the compound (X¹) was 2,260, and the low molecular weight component proportion was 5 mass %.

### [Preparation of Compound (X²)]

A compound (X²) (0.2 g) was obtained in the same manner as in the synthesis of the compound (A3) except that the compound (A2) (0.3 g) was washed with methanol and concentrated, and the obtained residue was purified by flash column chromatography (developing solvent: hexane/ethyl acetate) using silica gel to collect all fractions containing the compound (A2) as the target compound, and the fractions were used in place of the compound (A2). The average value of k1 in the formula was 24 as calculated from the NMR spectrum. As determined by the method described above, the number average molecular weight of the compound (X²) was 2,630, and the low molecular weight component proportion was 8 mass %.

### [Preparation of Compound (X³)]

A compound (X³) (0.3 g) was obtained in the same manner as in the synthesis of the compound (A3) except that the compound (A2) (0.3 g) was purified by flash column chromatography (developing solvent: hexane/ethyl acetate) using silica gel without washing with methanol to collect a fraction in which k1 in the formula was 19, and the fraction was used in place of the compound (A2). The average value of k1 in the formula was 19 as calculated from the NMR spectrum. As determined by the method described above, the number average molecular weight of the compound (X³) was 2,260, and the low molecular weight component proportion was 9 mass %.

### [Preparation of Compound (X⁴)]

A compound (X⁴) (0.2 g) was obtained in the same manner as in the synthesis of the compound (B3) except that the compound (B2) (0.4 g) was washed with methanol and concentrated, and the obtained residue was purified by flash column chromatography (developing solvent: hexane/ethyl acetate) using silica gel to collect a fraction in which k1 in the formula was 19, and the fraction was used in place of the compound (B2). The average value of k1 in the formula was 19 as calculated from the NMR spectrum. As determined by the method described above, the number average molecular weight of the compound (X⁴) was 2,540, and the low molecular weight component proportion was 3 mass %.

### [Preparation of Compound (X⁵)]

A compound (X⁵) (0.2 g) was obtained in the same manner as in the synthesis of the compound (B3) except that the compound (B2) (0.3 g) was washed with methanol and concentrated, and the obtained residue was purified by flash column chromatography (developing solvent: hexane/ethyl acetate) using silica gel to collect all fractions containing the compound (B2) as the target compound, and the fractions were used in place of the compound (B2). The average value of k1 in the formula was 22 as calculated from the NMR spectrum. As determined by the method described above, the number average molecular weight of the compound (X⁵) was 2,760, and the low molecular weight component proportion was 14 mass %.

### [Preparation of Compound (X⁶)]

A compound (X⁶) (0.3 g) was obtained in the same manner as in the synthesis of the compound (B3) except that the compound (B2) (0.3 g) was purified by flash column chromatography (developing solvent: hexane/ethyl acetate) using silica gel without washing with methanol to collect a fraction in which k1 in the formula was 19, and the fraction was used in place of the compound (B2). The average value of k1 in the formula was 19 as calculated from the NMR spectrum. As determined by the method described above, the number average molecular weight of the compound (X⁶) was 2,540, and the low molecular weight component proportion was 7 mass %.

### [Preparation of Compound (X⁷)]

A compound (X⁷) was obtained by mixing 13 parts by mass of the obtained compound (X²) and 13 parts by mass of the obtained compound (X⁵). As determined by the method described above, the number average molecular weight of the compound (X⁷) was 2,680, and the low molecular weight component proportion was 11 mass %.

### [Preparation of Compound (X⁸)]

A compound (X⁸) was obtained by mixing 13 parts by mass of the obtained compound (X¹) and 13 parts by mass of the obtained compound (X⁶). As determined by the method described above, the number average molecular weight of the compound (X⁸) was 2,590, and the low molecular weight component proportion was 6 mass %.

### [Preparation of Compound (X⁹)]

A compound (X⁹) was obtained by mixing 22 parts by mass of the obtained compound (X¹) and 4 parts by mass of the obtained compound (X⁶). As determined by the method described above, the number average molecular weight of the compound (X⁹) was 2,600, and the low molecular weight component proportion was 6 mass %.

### [Preparation of Compound (X¹⁰)]

A compound (X¹⁰) (0.2 g) was obtained in the same manner as in the synthesis of the compound (C5) except that the compound (C4) (0.4 g) was washed with methanol and concentrated, and the obtained residue was purified by flash column chromatography (developing solvent: hexane/ethyl acetate) using silica gel to collect a fraction in which k1 in the formula was 18, and the fraction was used in place of the compound (C4). The average value of k1 in the formula was 18 as calculated from the NMR spectrum. As determined by the method described above, the number average molecular weight of the compound (X¹⁰) was 2,110, and the low molecular weight component proportion was 3 mass %.

### [Preparation of Second Compound]

As the second compound, the following compounds F1 to F5 were prepared. The average value of k2 in the formula, as calculated from the NMR spectrum, was 21 for the compound F1, 21 for the compound F2, 19 for the compound F3, 16 for the compound F4, and 19 for the compound F5.

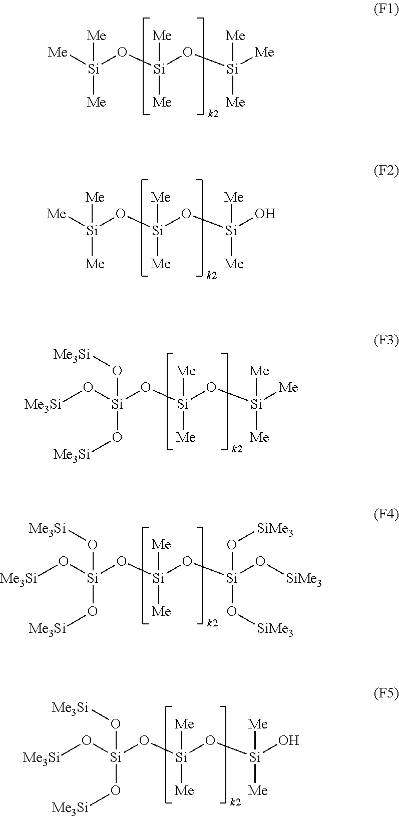

### [Preparation of Surface Treatment Agent]

Heptane was used as a liquid medium, and each compound described in Table 1 was added to the liquid medium in the addition amount (parts by mass) described in Table 1 and mixed to obtain a surface treatment agent having a solid content concentration of 0.2 mass %. In the table, “-” means that the compound is not used.

### [Production of Article]

As a vapor deposition source, 30 g of silicon oxide was disposed on a copper hearth in a vacuum deposition apparatus (VTR-350M manufactured by ULVAC KIKO, Inc.). A glass substrate was disposed in a vacuum deposition apparatus, and the inside of the vacuum deposition apparatus was evacuated until the pressure reached 5×10⁻³ Pa or less. The hearth was heated to about 2,000 °C, and silicon oxide was vacuum-deposited on the surface of the substrate to prepare a substrate with a silicon oxide layer having a silicon oxide layer with a thickness of about 20 nm.

The substrate with a silicon oxide layer was placed on a sample stage of a spray coater (API-90RS manufactured by Apiros Co., Ltd.) with the silicon oxide layer facing upward. Next, 13 g of the surface treatment agent obtained in each example was charged into a syringe in the spray coater, and applied by spraying at an atomization pressure of 130 kPa, a nozzle-to-sample surface distance of 50 mm, and a scanning speed of 300 mm/sec (wet coating method). Thereafter, the substrate with a silicon oxide layer, in which the surface treatment agent was applied on the surface, was subjected to a heat treatment at 140 °C for 30 minutes to obtain an article as an evaluation sample in which the substrate, the silicon oxide layer, and the surface treatment layer were layered in this order.

### [Evaluation]

### <Water Repellency>

About 2 μL of distilled water was placed on the surface treatment layer of the article, and the initial water contact angle was measured using a contact angle measuring device (product name “DM-500”, manufactured by Kyowa Interface Science Co., Ltd.). Measurement was performed at five locations on the surface treatment layer, an average value was calculated, and the water repellency of the surface treatment layer was evaluated based on the following criteria. In the calculation of the water contact angle, the 20 method was used. The results are shown in Table 1.
A: The average value of the water contact angles is more than 1050
B: The average value of the water contact angles is from 100 to 1050
C: The average value of the water contact angles is less than 1000

### <Wear Resistance>

The surface treatment layer of the article was subjected to 10.000 reciprocations with steel wool Bonstar (#0000) at a pressure of 98.07 kPa and a speed of 320 cm/min using a reciprocating traverse tester (manufactured by KNT Co., Ltd.) in accordance with JIS L 0849:2013 (corresponding ISO: 105-X^{12:2001}), and then the water contact angle after the friction test was measured. The measurement of the water contact angle was performed in the same manner as the measurement of the initial water contact angle in the evaluation of water repellency described above.

The wear resistance was evaluated based on the degree of decrease in water contact angle due to the friction test. The smaller the degree of decrease in water contact angle is, the more excellent the wear resistance is.

The evaluation criteria are as follows. A and B are practically acceptable levels. The results are shown in Table 1.

Degree of decrease in water contact angle=(initial water contact angle)−(water contact angle after friction test)
A: The degree of decrease in water contact angle was 5° or less.
B: The degree of decrease in water contact angle was more than 5° and 10° or less.
C: The degree of decrease in water contact angle was more than 10°.

### <Light Resistance>

A uniform light irradiation unit (manufactured by USHIO INC.) was attached to a mercury lamp (SP-9 250DB, manufactured by USHIO INC.), and a sample was placed at a distance of 17.5 cm from the lens. The light intensity from 200 to 800 nm was measured using an intensity meter (VEGA, manufactured by OPHIR) and found to be 200 mW/cm². The spectral irradiance of the mercury lamp had an emission line in a wavelength region of 300 nm or less.

Under an atmospheric atmosphere at a temperature of from 20 to 40 °C and a humidity of from 30 to 75%, the surface treatment layer of the article as a sample was irradiated with light from the mercury lamp for 6 hours, and the water contact angle after the light irradiation test was measured. The measurement of the water contact angle was performed in the same manner as the measurement of the initial water contact angle in the evaluation of water repellency described above.

The light resistance was evaluated based on the degree of decrease in water contact angle due to the light irradiation test. The smaller the degree of decrease in water contact angle is, the more excellent the light resistance is.

The evaluation criteria are as follows. A and B are practically acceptable levels. The results are shown in Table 1.

Degree of decrease in water contact angle=(initial water contact angle)−(water contact angle after light irradiation test)
A: The degree of decrease in water contact angle was 5° or less.
B: The degree of decrease in water contact angle was more than 5° and 100 or less.
C: The degree of decrease in water contact angle was more than 10°.

TABLE 1

| | First compound | | | | Second compound | | Evaluation | | |
|---|---|---|---|---|---|---|---|---|---|
| | | Addition amount | Number average | Wear | | Addition amount | Water | Wear | Light |
| Example | Kind | (parts by mass) | molecular weight | resistance | Kind | (parts by mass) | repellency | resistance | resistance |
| 1 | (X1) | 26 | 2,260 | B | — | — | B | B | B |
| 2 | (X4) | 26 | 2,540 | A | — | — | A | A | A |
| 3 | (X7) | 26 | 2,680 | C | — | — | C | C | C |
| 4 | (X8) | 26 | 2,590 | C | — | — | C | C | C |
| 5 | (X1) | 20 | 2,260 | B | F1 | 6 | B | B | B |
| 6 | (X1) | 20 | 2,260 | B | F2 | 6 | B | B | B |
| 7 | (X4) | 20 | 2,540 | A | F3 | 6 | A | A | A |
| 8 | (X4) | 20 | 2,540 | A | F4 | 6 | A | A | A |
| 9 | (X4) | 20 | 2,540 | A | F5 | 6 | A | A | A |
| 10 | (X5) | 26 | 2,760 | C | — | — | C | C | C |
| 11 | (X3) | 26 | 2,260 | C | — | — | C | C | C |
| 12 | (X6) | 26 | 2,540 | C | — | — | C | C | C |
| 13 | (X9) | 26 | 2,600 | C | — | — | B | C | C |
| 14 | (X10) | 26 | 2,100 | A | — | — | A | A | A |

As shown in Table 1, it was found that in Examples 1 to 2, 5 to 9, and 14, a surface treatment layer having favorable wear resistance and light resistance as compared with those of Examples 3 to 4 and 10 to 13 can be formed.

The compound of the disclosure is useful as a surface treatment agent.

The composition and the surface treatment agent of the disclosure can be used, for example, for a substrate in a display device such as a touch panel display, an optical element, a semiconductor element, a building material, an automobile component, a nanoimprint technology, or the like. The composition and the surface treatment agent can also be used for bodies, window glasses (windshield, side glass, and rear glass), mirrors, bumpers, and the like in transportation equipment such as trains, automobiles, ships, or aircraft. The composition and the surface treatment agent can also be used for outdoor articles such as building outer walls, tents, solar power generation modules, sound insulating plates, or concrete; fishing nets, insect trap nets, and water tanks. The composition and the surface treatment agent can also be used for a kitchen, a bathroom, a wash basin, a mirror, a toilet peripheral component, chandelier, ceramic ware such as tile, artificial marble, and various indoor facilities such as an air conditioner. The composition and the surface treatment agent can also be used for an antifouling treatment for jigs, inner walls, pipes, and the like in a factory. The composition and the surface treatment agent can also be used for goggles, glasses, helmets, pachinko, fibers, umbrellas, playground equipment, and soccer balls. The composition and the surface treatment agent can also be used as an adhesion inhibitor for various packaging materials such as food packaging materials or cosmetic packaging materials, and the inside of a pot. The composition and the surface treatment agent can also be used for an automotive navigation system, a mobile phone, a smartphone, a digital camera, a digital video camera, a PDA, a portable audio player, a car audio, a game console, a spectacle lens, a camera lens, a lens filter, sunglasses, a medical instrument such as a stomach camera, a copying machine, a PC, a display (for example, a liquid crystal display, an organic EL display, a plasma display, or a touch panel display), a touch panel, a protective film, and an optical member such as an antireflection film.

### Supplementary Note

The disclosure includes the following aspects.

<1>

A compound, having a chain organo(poly)siloxane residue and a reactive silyl group, in which the compound has a number average molecular weight of from 1,600 to 10,000, and has a proportion of a component having a molecular weight of 1,500 or less of 5 mass % or less.

<2>

The compound according to <1>, in which the reactive silyl group is represented by the following Formula (S1):

—Si(R²)ₙL₃₋ₙ (S1)
in which, in Formula (S1):
each R² is independently a hydrocarbon group,
each L is independently a hydrolyzable group, a group having a hydrolyzable group, or a hydroxy group, and
n is an integer from 0 to 2.
   <3>

The compound according to <1> or <2>, in which the chain organo(poly)siloxane residue is represented by the following Formula (B1) or (B2):

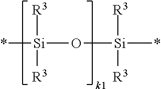

in which, in Formula (B1):
each R³ is independently a hydrocarbon group,
k1 is a number of 1 or more, and
* is a bonding site to an adjacent atom,

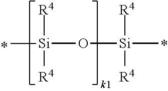

in which, in Formula (B2),
each R⁴ is independently a hydrocarbon group or T¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more, and
* is a bonding site to an adjacent atom.

<4>

The compound according to <3>, in which k1 in Formula (B1) is a number from 1 to 500.

<5>

The compound according to any one of <1> to <4>, represented by the following Formula (C) or Formula (D):

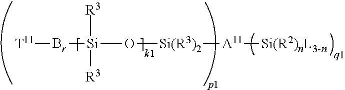

in which, in Formula (C):
T¹¹ is a monovalent group that does not contain a reactive silyl group,
each B is independently —O— or —C(═O)—,
each r is independently 0 or 1,
each R³ is independently a hydrocarbon group,
each k1 is independently a number of 1 or more,
p1 is an integer of 1 or more,
A¹¹ is a (p1+q1)-valent linking group,
q1 is an integer of 1 or more,
each R² is independently a hydrocarbon group,
each L is independently a hydrolyzable group, a group having a hydrolyzable group, or a hydroxy group, and
each n is independently an integer from 0 to 2,

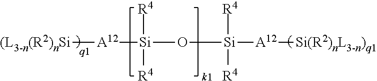

in which, in Formula (D):
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more,
each A² is independently a (q1+1)-valent linking group,
each q1 is independently an integer of 1 or more,
each R² is independently a hydrocarbon group,
each L is independently a hydrolyzable group, a group having a hydrolyzable group, or a hydroxy group, and
each n is independently an integer from 0 to 2,

<6>

The compound according to <5>, in which k1 in Formula (C) and Formula (D) is a number from 1 to 500.

<7>

The compound according to <5> or <6>, in which in Formula (C), q1 is an integer from 1 to 4, and
in Formula (D), each q1 is independently an integer from 1 to 4.

<8>

A composition, containing the compound according to any one of <1> to <7> and a liquid medium.

<9>

A composition, containing a first compound which is the compound according to any one of <1> to <7> and a second compound which has an organopolysiloxane residue but does not have a reactive silyl group.

<10>

The composition according to <9>, further containing a liquid medium.

<11>

The composition according to <9> or <10>, in which the second compound is represented by the following Formula (F):

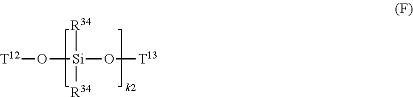

in which, in Formula (F),
each of T¹² and T¹³ is independently a monovalent group,
each R³⁴ is independently a hydrocarbon group, and
k2 is a number of 1 or more.

<12>

A surface treatment agent containing the compound according to any one of <1> to <7>.

<13>

A surface treatment agent containing the compound according to any one of <1> to <7> and a liquid medium.

<14>

A method of producing an article, the method including subjecting a substrate to a surface treatment using the surface treatment agent according to <12> or <13> to produce an article having a surface treatment layer formed on the substrate.

<15>

An article including a substrate and a surface treatment layer disposed on the substrate and formed by a surface treatment using the surface treatment agent according to <12> or <13>.

<16>

The article according to <15>, which is an optical member.

<17>

The article according to <15>, which is a display or a touch panel.

The disclosure of Japanese Patent Application No. 2023-199197 filed on Nov. 24, 2023 is incorporated herein by reference in its entirety. All documents, patent applications, and technical standards described in this description are incorporated herein by reference to the same extent as if each individual document, patent application, and technical standard were specifically and individually indicated to be incorporated by reference.

1. A compound, having a chain group and a reactive silyl group, wherein the compound has a number average molecular weight of from 1,600 to 10,000, and has a proportion of a component having a molecular weight of 1,500 or less of 5 mass % or less.

2. The compound according to claim 1, wherein the compound has a chain organo(poly)siloxane residue and a reactive silyl group.

3. The compound according to claim 1, wherein the reactive silyl group is represented by the following Formula (S1):
—Si(R²)ₙL₃₋ₙ (S1)
wherein, in Formula (S1):
each R² is independently a hydrocarbon group,
each L is independently a hydrolyzable group, a group having a hydrolyzable group, or a hydroxy group, and
n is an integer from 0 to 2.

4. The compound according to claim 2, wherein the chain organo(poly)siloxane residue is represented by the following Formula (B1) or (B2): 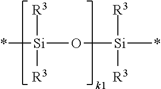
wherein, in Formula (B1):
each R² is independently a hydrocarbon group,
k1 is a number of 1 or more, and
* is a bonding site to an adjacent atom: 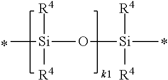
wherein, in Formula (B2):
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more, and
* is a bonding site to an adjacent atom.

5. The compound according to claim 4, wherein k1 in Formulae (B1) and (B2) is a number from 1 to 500.

6. The compound according to claim 1, represented by the following Formula (C), (C2), (D), (D2), (E), or (E2): 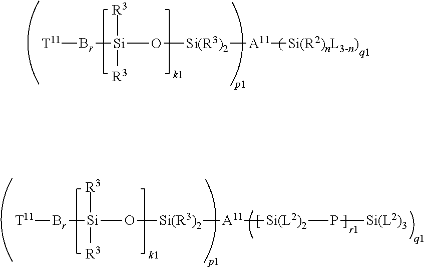
wherein, in Formula (C):
T¹¹ is a monovalent group that does not contain a reactive silyl group,
each B is independently —O— or —C(═O)—,
each r is independently 0 or 1,
each R³ is independently a hydrocarbon group,
each k1 is independently a number of 1 or more,
p1 is an integer of 1 or more,
A¹¹ is a (p1+q1)-valent linking group,
q1 is an integer of 1 or more,
each R² is independently a hydrocarbon group,
each L is independently a hydrolyzable group, a group having a hydrolyzable group, or a hydroxy group, and
each n is independently an integer from 0 to 2,
wherein, in Formula (C2):
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
r1 is an integer from 1 to 3, and
the definitions of T¹¹, B, r, R³, k1, p1, A¹¹, and q1 are the same as the definitions for Formula (C): 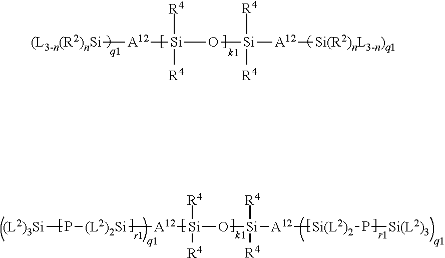
wherein, in Formula (D):
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more,
each A¹² is independently a (q1+1)-valent linking group,
each q1 is independently an integer of 1 or more,
each R² is independently a hydrocarbon group,
each L is independently a hydrolyzable group, a group having a hydrolyzable group, or a hydroxy group, and
each n is independently an integer from 0 to 2,
wherein, in Formula (D2):
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
each r1 is independently an integer from 1 to 3, and
the definitions of R⁴, k1, A¹², and q1 are the same as the definitions for Formula (D): 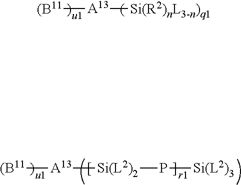
wherein, in Formula (E):
B¹¹ is a monovalent group containing at least one selected from the group consisting of Si, Ge, and Sn, to each of which a hydroxy group or a hydrolyzable group is not directly bonded, or a monovalent group containing a branched alkyl group,
u1 is an integer of 1 or more,
A¹¹ is a (q1+u1)-valent linking group,
q1 is an integer of 1 or more,
each R² is independently a hydrocarbon group,
each L is independently a hydrolyzable group, a group having a hydrolyzable group, or a hydroxy group, and
each n is independently an integer from 0 to 2,
wherein, in Formula (E2):
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
each r1 is independently an integer from 1 to 3, and
the definitions of B¹¹, u1, A¹¹, and q1 are the same as the definitions for Formula (E).

7. The compound according to claim 6, wherein each k1 in Formulae (C), (C2), (D), and (D2) is independently a number from 1 to 500.

8. The compound according to claim 6, wherein in Formulae (C), (C2), (E), and (E2), q1 is an integer from 1 to 4, and in Formulae (D) and (D2), each q1 is independently an integer from 1 to 4.

9. A composition, comprising the compound according to claim 1 and a liquid medium.

10. A composition, comprising a first compound which is the compound according to claim 2 and a second compound which has an organopolysiloxane residue but does not have a reactive silyl group.

11. The composition according to claim 10, further comprising a liquid medium.

12. The composition according to claim 10, wherein the second compound is represented by the following Formula (F): 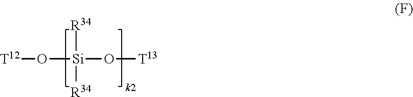
wherein, in Formula (F):
each of T¹¹ and T¹³ is independently a monovalent group,
each R³⁴ is independently a hydrocarbon group, and
k2 is a number of 1 or more.

13. A surface treatment agent, comprising the compound according to claim 1.

14. The surface treatment agent according to claim 13, further comprising a liquid medium.

15. A method of producing an article, the method comprising subjecting a substrate to a surface treatment using the surface treatment agent according to claim 13 to produce an article having a surface treatment layer formed on the substrate.

16. An article comprising a substrate and a surface treatment layer disposed on the substrate and formed by a surface treatment using the surface treatment agent according to claim 13.

17. The article according to claim 16, which is an optical member.

18. The article according to claim 16, which is a display or a touch panel.

19. A surface treatment agent, comprising the compound according to claim 2.

20. An article, comprising a substrate and a surface treatment layer disposed on the substrate and formed by a surface treatment using the surface treatment agent according to claim 19.
